(19) United States
(12) Patent Application Publication
(10) Pub. No.: US 2016/0125412 A1
(43) Pub. Date: May 5, 2016

(54) METHOD AND SYSTEM FOR PREVENTING IDENTITY THEFT AND INCREASING SECURITY ON ALL SYSTEMS

(71) Applicant: Royce E. Cannon, Roseville, MN (US)

(72) Inventor: Royce E. Cannon, Roseville, MN (US)

(21) Appl. No.: 14/582,112

(22) Filed: Dec. 23, 2014

Related U.S. Application Data
(60) Provisional application No. 62/075,278, filed on Nov. 5, 2014.
(60) Provisional application No. 62/094,890, filed on Dec. 19, 2014.

(51) Int. Cl. G06Q 20/40; G06Q 50/26

(52) U.S. Cl. CPC G06Q 20/4014; G06Q 50/265

(57) ABSTRACT

The present invention provides a method and system for preventing identity theft and increasing security on systems. Some embodiments include receiving, into a computer system, a request to perform an electronic transaction for an identified human user at a remote location; accessing, by the system, a set of authentication criteria of the identified user; retrieving, into the system, a plurality of real-time authentication parameters relevant to the user and to the transaction; and comparing, by the system, the plurality authentication criteria to the accessed set of authentication parameters of the user and either authorizing an action to complete the electronic transaction or not. Some embodiments include displaying, on a first personal electronic device of the user, an indication of the real-time alert of the request to perform the electronic transaction; and eliciting and receiving a real-time authorization indication from the user using the first personal electronic device of the user.

### CROSS-REFERENCE TO RELATED APPLICATION

This application claims priority benefit, under 35 U.S.C. §119(e), of U.S. Provisional Patent Application No. 62/094,890, filed Dec. 19, 2014 by Royce E. Cannon, titled “METHOD AND SYSTEM FOR PREVENTING IDENTITY THEFT AND INCREASING SECURITY ON SYSTEMS,” and U.S. Provisional Patent Application No. 62/075,278, filed Nov. 5, 2014 by Royce E. Cannon, titled “A Method and System for Preventing Identity Theft and Increasing Security on all Systems,” each of which is incorporated herein by reference in its entirety.

### FIELD OF THE INVENTION

This invention relates to the field of computer and transaction security and, more particularly, to identity theft protection and a system and method for protection against theft of personally identifiable information (PII) when conducting both online and offline purchase transactions and other non-purchase operations, such as filing tax returns, applying for credit and other identity-authentication procedures.

### BACKGROUND OF THE INVENTION

Identity theft has been running rampant over the last several years, causing severe emotional pain and suffering along with astounding financial losses. The present invention provides a solution with a method and apparatus to make that problem a thing of the past.

Identity Theft and other computer system and transaction compromises are severe problems that have a financial impact of hundreds of billions, if not trillions, of dollars stolen per year worldwide. Conventional solutions to combat identity theft are limited. They oftentimes focus on a single Point-of-Entry (POE), or type, of fraud. These “solutions” focus way too much on forcing training, policies and procedures on people to secure their data.

People are conditioned to think that a credit-card number is sensitive and should not be shared. That is, until they need to use their credit card. For example, people think that it is perfectly fine to call up the corner pizza shop and place an order, giving their sensitive credit card number information over the telephone to whomever answers the call. If the pizza shop is a small business, the employees may not know how they should handle the information properly to keep it secure.

The same holds true for Social Security Numbers (SSNs) and other National ID Numbers (NINs). People think these numbers are sensitive, but they need to hand them out on a regular basis, for example, in order to obtain a loan. All it takes is one poorly secured system, or a person with malicious intent, and the sensitive number is compromised. It is clear that the system itself is broken. SSNs, credit-card numbers and other sensitive account information will always remain merely semi-private because of the simple fact that people hand out these numbers in order to complete many modern transactions. People have been taught for years to never give a password to anyone, but they will readily hand over a much-more-important numbers (such as an SSN, credit-card number and/or other sensitive account information) to any vendor who says they need it. Unlike an SSN or credit-card number, which is not easily changed after each transaction, a password can be easily changed in order to stop further use of the old password. Fraudsters will always take the path of least resistance so any individual increase in security will only cause the fraudster to move on to the next easiest path. The only way to have a significant impact on the fraud problem is by creating resistance on all attempts, across-the-board.

Current conventional security-breach mitigation techniques are like trying to plug holes in a failing dam. At some point, the dam needs to be replaced.

To highlight that point, the EMV (Europay, MasterCard® and Visa®) standard can be used as an example. EMV uses a chip-and-PIN (electronic security chip and personal-identification number) system that can be used to prevent credit-card skimming at the in-store Point of Entry (POE) for purchase-card data entry (which is often a scanner that reads data from the magnetic stripe on a conventional purchase card (e.g., a credit or debit card)). EMV can also help protect the account numbers from being stolen as a result of a compromise of the merchant's systems. Unfortunately, EMV provides no benefit for other points of entry (POEs) such as online, voice or mail-order transactions. It also does not provide protection when a card is handed to someone and taken out of sight. Additionally, EMV requires the installation of new card readers and expensive cards. This is why the EMV standard has taken nearly twenty (20) years to catch on. EMV is very expensive to implement and use.

NFC (near-field communications) solutions that add security chips and cryptographic systems, such as ApplePay™, also require new hardware and will not solve the problem. Unless every card transaction is protected by a NFC based technology or something as secure, none of them are. The technology will require years and billions of dollars invested to even have a fraction of the credit-card terminals and they will only result in fraudsters taking a small step in any direction and continuing on with their work.

The use of a Card Security Code or card verification value-2 (CSC or CVV2) is another solution targeted at curbing credit-card fraud. CSC or CVV2 have been largely targeted at online credit-card fraud. CVV2 is the three or four-digit code printed on the back of the card that one enters when making an online purchase. While that may help somewhat during online purchases, it does not prevent fraud caused when the CSC or CVV2 number itself has also been stolen or copied. The use of CSC or CVV2 also does not prevent an individual with malicious intent from printing out a forged counterfeit card and using that in a retail location. The use of counterfeit cards that are missing the CSC or CVV2 is possible because most retailers do not require entry of the CVV2 code and they are not required to do so for most transactions.

If one's SSN is compromised in the United States, one can apply for another one, or perhaps put a freeze on one's credit. This is somewhat effective but highly burdensome and reactive. People typically do not do things like this unless their identity has already been compromised.

In the case of a credit freeze, a person may be charged a fee when they need to allow a credit check, and they are forced to use a process that is difficult and costly.

In addition to technologies used to mitigate identity theft, people rely too much on processes and procedures, analytics and other reactive measures to curb fraud. The United States Internal Revenue Service (IRS) alone employs over 3,000 people to investigate fraudulent tax returns—fraudulent returns that should have been prevented, not just investigated.

The majority of police departments do not even investigate credit-card fraud. They simply do not have the manpower necessary to effectively combat the problem. Society spends countless dollars training people on how to handle sensitive information. All of the training in the world will not prevent someone who intends to steal and misuse sensitive information from doing so.

The current system forces individuals, businesses, and other entities to be security experts. This is because people are expected to protect the information instead of using a system that can protect the information for them. People have to remember all the things they should and should not do. Businesses and other entities are sometimes forced to develop systems to protect the information. When an information-protection system is not their core competency or a product they sell, it will not be prioritized. Information protection will only get the minimum amount of attention to get by. Often times, different solutions are implemented for each company, which requires significant investment. What is needed is a solution that is simple and does not require everyone to be experts. The system should not rely on everyone to carefully follow policies and procedures and never make a mistake. The system should not rely on complete honesty of all who are authorized to have access.

Finally, if one's information is stolen, criminals can use that stolen information for days or months, if not years, before the victim finds out. There is very little visibility without the use of a monitoring service for which one typically has to pay a fee. It is clear that current processes and technologies used to prevent identity theft and increase security are not adequate.

U.S. Patent Publication 2014/0304157 by Bachenheimer et al. is titled “Identity theft and fraud protection system and method”, and is incorporated herein by reference. Publication 2014/0304157 describes a system and method that protects users against theft of personally identifiable information during both online and offline purchase transactions, registration transactions and identity authentication transactions. The system initially obtains a user's personally identifiable information as storable computer data, establishes an anonymous e-mail address on behalf of the subscribing user, provides the anonymous e-mail address to an e-mail recipient when the subscribing user sends an e-mail to the recipient, receives e-mail communications from the recipient at the anonymous e-mail address, stores the routing information from the e-mail communications, scrubs the e-mail communications for electronic viruses, forwards the e-mail communications received from the recipient at the anonymous e-mail address to the subscribing user, and forwards e-mail communications to the recipient that are sent from the subscribing user to the anonymous e-mail address by matching the stored routing information without ever revealing the subscribing user's real e-mail address to the recipient.

U.S. Pat. No. 6,839,692 to Carrott et al. issued Jan. 4, 2005 with the title “Method and apparatus to provide secure purchase transactions over a computer network”, and is incorporated herein by reference. U.S. Pat. No. 6,839,692 describes a method and structure for providing secure credit facility transactions for purchasing goods and services over a computer network such as the Internet that stores user's privileged information and other transactional data on the user's own computer. The method includes encryption of all information before or during its storage to the user's hard drive. The method and system includes the ability for the user to complete electronic commerce (e-commerce) transactions without revealing certain of the encrypted information, such as credit-card numbers, to the merchant. The method and system creates and controls sub-accounts on a single credit facility, such as a credit card, with unique user reporting and corresponding password identifiers. The method and system sets and control sub-accounts spending amounts and replenishment periods. The method enables the user to create and control recurring debit accounts on a single credit facility, such as a credit card, over varying transactional periods.

U.S. Pat. No. 8,566,918 by Radhakrishnan issued Oct. 22, 2013 with the title “Method and apparatus for token-based container chaining”, and is incorporated herein by reference. U.S. Pat. No. 8,566,918 describes an apparatus may intercept a request to access a resource represented by a resource token. The apparatus may receive a hard token representing identification information of a device. The apparatus may determine, based at least in part upon the hard token and the resource token, at least one token-based rule specifying compliance criteria required to consume the resource. The apparatus may receive at least one token representing compliance information of the device in response to a request for compliance information of the device. The apparatus may then compare the compliance information against the compliance criteria to determine that the device is capable of consuming the resource. The apparatus may then generate a compliance token representing the determination that the device is capable of consuming the resource, and communicate the compliance token to facilitate the provisioning of a container to the device.

U.S. Pat. No. 6,760,843 by Carter issued Jul. 6, 2004 with the title “Maintaining a soft-token private key store in a distributed environment”, and is incorporated herein by reference. U.S. Pat. No. 6,760,843 describes methods, systems, and devices for securely updating private keys, key pairs, passwords, and other confidential information in a distributed environment. A transaction is created including appropriate encrypted soft-token content, and then transmitted to a new location. Comparisons are made to determine whether the new soft-token content should be recognized as authentic and entered at the new location. Updates are accomplished without ever sending the plain text form of a key or a password across the wire between the distributed locations.

United States Patent Publication 2010/0156624 by Hounsell was published Jun. 24, 2010 with the title “Radio Proximity Monitoring”, and is incorporated herein by reference. Publication 2010/0156624 describes a tag that is attachable to items such as a briefcase or a laptop and communicates via Bluetooth™ with a mobile (cell) phone. In use, a user carries their mobile phone on their person and the proximity of one or more of the tags is monitored. When a tag goes out of range then alarms are triggered. The transmitter device (tag or mobile phone) transmits radio signals with a plurality of set transmission powers, each corresponding to a respective set proximity, with Bluetooth power adaption turned off. The proximity is monitored by using a correlation between the Received-Signal-Strength Indication (RSSI) signal strength and Bit Error Rate (BER) link-quality measurements. The proximity may be monitored by using a delay count measurement, including a measure of the time to successfully transfer data to a buffer. The signal strength, link quality and delay count measurements are combined into a confidence measure to monitor proximity.

There is a need in the art for an improved method and apparatus for combating illicit transactions and identity theft, while permitting valid transactions.

### SUMMARY OF THE INVENTION

The present invention provides a solution: In some embodiments, the present invention provides a dynamic, rotating trust ticket. In some embodiments, the dynamic, rotating trust ticket is a changing-over-time encrypted number that is generated within a user's personal electronic device (such as a smartphone, smartwatch, laptop computer or the like) by an application. The user just looks at their device running the application (“app”) of the present invention, and uses the encrypted number for online purchases, in-person purchases, credit checks and applications for loans, submissions of tax returns to the Internal Revenue Service (IRS), etc.

In some embodiments, trust tickets can be destroyed by an action of the user, or issued in a form that expires such that it is no longer usable after a certain time or a certain number or dollar-value of uses. As an example, a trust ticket for the IRS could be made usable for as many times as one wants. For credit checks, a trust ticket that expires, and/or is limited as to the amount of money that can be transacted, is a better idea.

In some embodiments, the present invention provides a computerized method for enhanced authentication. This method includes eliciting and receiving, into a computer system, personal identification information of an identified human user and authentication-criteria-customization information from the human user; customizing, in a database of the computer system, a user account for the human user, wherein the user account includes a set of authentication criteria of the identified human user for each one of a plurality of transaction types based on the received authentication-criteria-customization information from the human user; receiving, into the computer system, a request to perform an electronic transaction for the identified human user at a location remote from the computer system; accessing, by the computer system, the set of authentication criteria of the identified human user from the database based on a type of the transaction; retrieving, into the computer system, a plurality of real-time authentication parameters relevant to the human user and to the transaction; and comparing, by the computer system, the plurality of retrieved real-time authentication parameters to the accessed set of authentication criteria of the identified human user and, based on the comparing of the real-time authentication parameters, either authorizing an action to complete the electronic transaction or withholding the authorization.

In some embodiments, the present invention provides a computerized apparatus for enhanced authentication. This apparatus includes: an interface that elicits and receives, into a computer system, personal identification information of an identified human user and authentication-criteria-customization information from the human user; a user-account customization module that customizes, in a database of the computer system, a user account for the human user, wherein the user account includes a set of authentication criteria of the identified human user for each one of a plurality of transaction types based on the received authentication-criteria-customization information from the human user; a telecommunications interface operatively configured to receive, into the computer system, a request to perform an electronic transaction for the identified human user at a location remote from the computer system; an access interface in the computer system operatively configured to access the set of authentication criteria of the identified human user from the database, based on a type of the transaction; a retriever unit in the computer system operatively configured to retrieve a plurality of real-time authentication parameters relevant to the human user and to the transaction; and a comparator in the computer system to compare the plurality of retrieved real-time authentication parameters to the accessed set of authentication criteria of the identified human user and, based on the comparison of the real-time authentication parameters, to either authorize an action to complete the electronic transaction or to withhold the authorization.

In some embodiments, the present invention provides a non-transitory computer-readable medium having stored thereon instructions that cause a suitably programmed computer system to perform a method that includes: eliciting and receiving, into a computer system, personal identification information of an identified human user and authentication-criteria-customization information from the human user; customizing, in a database of the computer system, a user account for the human user, wherein the user account includes a set of authentication criteria of the identified human user for each one of a plurality of transaction types based on the received authentication-criteria-customization information from the human user; receiving, into the computer system, a request to perform an electronic transaction for the identified human user at a location remote from the computer system; accessing, by the computer system, the set of authentication criteria of the identified human user from the database based on a type of the transaction; retrieving, into the computer system, a plurality of real-time authentication parameters relevant to the human user and to the transaction; and comparing, by the computer system, the plurality of retrieved real-time authentication parameters to the accessed set of authentication criteria of the identified human user and, based on the comparing of the real-time authentication parameters, either authorizing an action to complete the electronic transaction or withholding the authorization.

### BRIEF DESCRIPTION OF THE DRAWINGS

FIG. 1A is a schematic block diagram of a system 101 that provides a user-authorization service 120, according to some embodiments of the present invention.

FIG. 1B is a block diagram of a system 102 that includes a user-authorization service 120 in both a public-service computer system and a private-service computer system, according to some embodiments of the present invention.

FIG. 1C is a block diagram of a system 103 that includes a user-authorization service 120 in a hybrid system including a plurality of public-service computer systems and one or more private-service computer systems, according to some embodiments of the present invention.

FIG. 2A is a high-level block diagram of a process 201 to create a user's account, according to some embodiments of the present invention.

FIG. 2B is a high-level block diagram of a trust-loop process 202 used to complete a secured transaction, according to some embodiments of the present invention.

FIG. 2C is a high-level block diagram of a trust-loop process 203 used to complete a secured transaction, according to some embodiments of the present invention.

FIG. 3A is a block diagram of authorization-policy-service data 300 used to protect a secured transaction, according to some embodiments of the present invention.

FIG. 3B is a block diagram of an authentication and authorization process 302 used to protect a secured transaction, according to some embodiments of the present invention.

FIG. 4 is a high-level block diagram of a location-verification-service process 400 that verifies a user's location to help protect a secured transaction, according to some embodiments of the present invention.

FIG. 5 is a high-level block diagram of a logging-and-alerting-services process 500 that controls access to a user's records, according to some embodiments of the present invention.

FIG. 6 is a high-level block diagram of a mapping-service process 600 that uses multi-party approval to help protect a secured transaction, according to some embodiments of the present invention.

FIG. 7 is a high-level block diagram of a prior-art transaction process 700.

FIG. 8A is a high-level block diagram of an improved transaction authorization process 801 to complete a secured transaction, according to some embodiments of the present invention.

FIG. 8B is a high-level block diagram of a process 802 to authorize and request that providers make approval inquiries for any use of a user's PII.

FIG. 9 is a high-level block diagram of a prior-art payment-card-approval process 900.

FIG. 10 is a high-level block diagram of an improved payment-card-approval process 1000, according to some embodiments of the present invention.

FIG. 11 is a block diagram of a prior-art tax-return-submission process 1100.

FIG. 12 is a block diagram of an improved tax-return-submission process 1200, according to some embodiments of the present invention.

FIG. 13 is a block diagram of a prior-art credit-check process 1300.

FIG. 14 is a block diagram of an improved credit-check process 1400, according to some embodiments of the present invention.

FIG. 15 is a block diagram of an improved tax-return-submission process 1500, according to some embodiments of the present invention.

FIG. 16 is a block diagram of an improved credit-check process 1600, according to some embodiments of the present invention.

FIG. 17 is a block diagram of an improved credit-check process 1700 for a child's custodian, according to some embodiments of the present invention.

FIG. 18 is a block diagram of an improved credit-check process 1800 for a person who has delegated responsibility for the authorization interaction to an agent, according to some embodiments of the present invention.

FIG. 19 is a block diagram of an improved health-care-record-access process 1900, according to some embodiments of the present invention.

FIG. 20 is a block diagram of an improved prescription-medication-access process 2000, according to some embodiments of the present invention.

FIG. 21 is a block diagram of an improved health-care-advanced-directive process 2100, according to some embodiments of the present invention.

FIG. 22 is a block diagram of an improved payment-card-purchase process 2200, according to some embodiments of the present invention.

FIG. 23 is a block diagram of an improved payment-card-recurring-purchase process 2300, according to some embodiments of the present invention.

FIG. 24 is a block diagram of an improved payment-card-ATM-access process 2400, according to some embodiments of the present invention.

FIG. 25 is a block diagram of an improved payment-card-simple-purchase process 2500, according to some embodiments of the present invention.

FIG. 26 is a block diagram of an improved payment-card-purchase-limits process 2600, according to some embodiments of the present invention.

FIG. 27 is a block diagram of an improved payment-card-advanced-online-purchase process 2700, according to some embodiments of the present invention.

FIG. 28 is a block diagram of an improved payment-card-advanced-store-purchase process 2800, according to some embodiments of the present invention.

FIG. 29 is a block diagram of an improved payment-card-store-purchase-custodian-account process 2900, according to some embodiments of the present invention.

FIG. 30 is a block diagram of an improved gift-card-purchase process 3000, according to some embodiments of the present invention.

FIG. 31 is a block diagram of an improved bank-card-ATM-withdrawal process 3100, according to some embodiments of the present invention.

FIG. 32 is a block diagram of an improved payment-card-simple-gasoline-purchase process 3200, according to some embodiments of the present invention.

FIG. 33 is a block diagram of an improved payment-card-simple-food-purchase process 3300, according to some embodiments of the present invention.

FIG. 34 is a block diagram of an improved payment-card-advanced-gasoline-purchase process 3400, according to some embodiments of the present invention.

FIG. 35 is a block diagram of an improved payment-card-advanced-movie-rental process 3500, according to some embodiments of the present invention.

FIG. 36 is a block diagram of an improved authorization-account-setting-change process 3600, according to some embodiments of the present invention.

FIG. 37 is a block diagram of an improved authorization-account-setting-change-for-delegate-approver process 3700, according to some embodiments of the present invention.

FIG. 38A is a block diagram of an improved corporate-computer-login process 3801, according to some embodiments of the present invention.

FIG. 38B is a block diagram of an improved corporate-computer-login-proximity-detection process 3802, according to some embodiments of the present invention, which demonstrates an improved corporate system login using proximity detection.

FIG. 39 is a block diagram of an improved bank-vault-entry process 3900, according to some embodiments of the present invention.

FIG. 40 is a block diagram of an improved website-login process 4000, according to some embodiments of the present invention.

FIG. 41 is a block diagram of an improved bank-teller-compromised-workstation process 4100, according to some embodiments of the present invention.

FIG. 42 is a block diagram of an improved voter-electronic-signature-authentication process 4200, according to some embodiments of the present invention.

FIG. 43 is a block diagram of an improved website-account-password-reset process 4300, according to some embodiments of the present invention.

FIG. 44 is a block diagram of an improved in-bank-transaction process 4400, according to some embodiments of the present invention.

FIG. 45 is a block diagram of an improved bank-electronic-deposit process 4500, according to some embodiments of the present invention.

FIG. 46 is a block diagram of an improved bank-check-clearing process 4600, according to some embodiments of the present invention.

FIG. 47 is a block diagram of an improved bank-electronic-deposit process 4700, according to some embodiments of the present invention.

FIG. 48 is a block diagram of an improved impersonation-prevention-identity-verification process 4800, according to some embodiments of the present invention.

FIG. 49 is a block diagram of an improved entity-verification-for-telephone-calls process 4900, according to some embodiments of the present invention.

FIG. 50A is a block diagram of an improved entity-verification-for-e-mail process 5001, according to some embodiments of the present invention.

FIG. 50B is a block diagram of an improved entity-verification-certified-e-mail-digital-signature process 5002, according to some embodiments of the present invention.

FIG. 50C is a block diagram of an improved user-verification-certified-e-mail-using-message-id process 5003, according to some embodiments of the present invention.

FIG. 50D is a block diagram of an improved entity-verification-certified-e-mail-using-message-id process 5004, according to some embodiments of the present invention.

FIG. 50E is a block diagram of an improved entity-verification-certified-e-mail process 5005, according to some embodiments of the present invention.

FIG. 50F is a block diagram of an improved user-confirmation-phishing-and-virus-mitigation-e-mail process 5006, according to some embodiments of the present invention.

FIG. 50G is a block diagram of an improved website-account-creation-certified-email-address process 5007, according to some embodiments of the present invention, which demonstrates a user who creates an account using a name and social security number.

FIG. 51 is a block diagram of an improved entity-verification-for-certified-websites process 5100, according to some embodiments of the present invention.

FIG. 52 is a block diagram of an improved entity-verification-for-certified-internet-address process 5200, according to some embodiments of the present invention.

FIG. 53 is a block diagram of an improved client-verification-for-certified-client-device process 5300, according to some embodiments of the present invention.

FIG. 54 is a block diagram of an improved client-verification-for-certified-client-device-no-pas sword process 5400, according to some embodiments of the present invention.

FIG. 55 is a block diagram of an improved missile-launch-authentication process 5500, according to some embodiments of the present invention.

FIG. 56 is a block diagram of an improved website-content-filtering process 5600 according to some embodiments of the present invention.

FIG. 57 is a block diagram of an improved user-contact-appointment-reminder 5700 according to some embodiments of the present invention.

FIG. 58 is a block diagram of an improved automation-proximity-detection-location-signature 5800 according to some embodiments of the present invention.

### DESCRIPTION OF PREFERRED EMBODIMENTS

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

As used herein, personally identifiable information (PII) is any information regarding an individual that is electronically stored and controlled, such as a computer log-in userid (user identification name), account number, SSN, National ID, email address and the like.

The present invention provides an effective solution under which the owner of PII is asked to explicitly approve its use as a predicate to its use. This will render information that is normally considered sensitive to just be information that is much more difficult to misuse by other parties. Once the sensitivity of the information is removed, then identity theft and other compromises will be things of the past.

In some embodiments, the present invention provides a comprehensive way for approving actions initiated by a person or entity. This can be thought of as a digital wrapper around one's identity. People have accounts that are used to protect access to systems. Before the present invention, however, people did not have accounts that are used to protect their identity. Nor did they have accounts that had the primary responsibility of authorizing actions.

The following is a brief example and description of the use for one embodiment of the present invention.

To put it succinctly, some embodiments of the present invention provide a computerized system and method of finding a person who owns PII and the decisions around it. The present invention should be inserted in the approval process and used to actively approve requests before they are carried out. The user will have a set of tools used to manually or automatically approve requests before or during the process.

In some embodiments, the present invention provides an “approval framework” designed to seek approval from the rightful owner of PII when its use is requested.

The current approach to security is backwards. We secure access on the front-end and investigate compromises on the back-end with analytical software. While the present invention can still benefit from security at the front-end, it enables security that is nearly impenetrable at the back-end and investigates attempted compromises by using human intelligence (i.e., ask the user), not analytical software limited by level of investment, human capital and available compute cycles.

In some embodiments, the present invention includes a secure account owned by the user, a set of tools used to approve or reject requests for particular transactions, and a change in the process to ask the provider for approval in-line (i.e., between each request for a transaction and the approval of that request for the transaction). By using the present invention, visibility to transactions affecting the user will be greatly increased even if the present invention is not actively used to approve actions. This, alone, will result in reduced fraud. It is also very important to give users a choice of how they would like to approve actions. Current solutions are oftentimes only implemented if the vast majority of users are not bothered by the change. Even if a majority of users would not have a problem with a fraud-mitigation technique, it still may not be introduced if there is a chance that it will upset some users. Users who are more security conscious should be able to use any type or amount of authentication factors that can be made available to them. Also, everyone is different and giving people choices to secure their identity in whatever way preferred will greatly increase adoption rates (i.e., use of the identity-authentication process according to the present invention).

In some embodiments, the present invention is implemented as a stand-alone or private service. This use-case may fit well for businesses or other entities that would like to leverage it in order to better secure their systems. With that said, other embodiments directed more toward identity theft use a centralized model with a single account that protects multiple types of identity theft and prevents fraudulent transactions. By having a single account to protect an individual's identity, the present invention can provide certified parcel-delivery mailing addresses, e-mail addresses and telephone numbers. The system of the present invention thus protects and validates ones identity.

The system may also be implemented per country or region worldwide. By having a single account per individual, the greatest adoption and the greatest protection will be achieved. As an example, a person may want use the account in order to secure credit checks and if the person already has an account, the person will be more inclined to take the extra minute or two to prevent fraudulent tax returns being filed. Also, without a single account or digital identity, individuals cannot reliably prove who they are.

The solution should be inserted in the process at the broadest possible point. As an example, while the present invention can be used to reduce credit-card fraud by having the issuing bank request approval, the best implementation is to integrate at the cardholder networks. While it is possible to integrate at the issuing bank, it will be considerably more work for the protection and less effective. Also, if individual banks are relied upon to provide protection, there will be hundreds of different solutions. Even if one of the solutions is effective, it will not have a major impact unless the bank using that solution is responsible for all transactions. Attackers will simply take the path of least-resistance. In some embodiments, all paths must create resistance.

By having the combination of a broad implementation with a single account, adoption rates will be much higher than a solution that is targeted for a specific use-case or POE. A user may create an account to prevent fraud involving credit checks but then come to realize the user is a click or two away from preventing tax-return fraud. By having a common toolset and single account, there is a much greater chance at preventing identity theft from occurring.

In general, requests or transactions that involved the use of personally identifiable information (PII) are initiated by the owner of the information. As used herein, PII is defined to include any information that is used to identify an individual. This includes, but is not limited to, name, address, date of birth, Social Security Number (SSN), National Identification Number (NIN), username, e-mail address or any other information that validates identity. In some embodiments, the present invention is used to secure an individual's PII. In some embodiments, the present invention is also used to secure sensitive information owned by an entity such as an entity's Employer Identification Number (EIN). Additionally, in some embodiments, the present invention is used to secure access to computer systems.

A request may include any action that is initiated by an individual or entity or on behalf of the individual or entity. Examples include the following:

1) Initiating a purchase using a credit card including an account number, expiration date and customer name.

2) Initiating a credit check utilizing name, date of birth and an SSN or NIN.

3) Filing an individual or joint tax return using an SSN or NIN and other PII.

4) Filing a business tax return using an EIN.

5) Accessing health-care records using PII.

6) Approving health-care decisions using PII.

7) Applying for health-care accounts using PII

8) Doing business with a bank or other financial institution.

9) Withdrawing money from an ATM (Automated Teller Machine)

10) Accessing a system using a userid

11) Sending or receiving an e-mail.

12) Sending or receiving a text message.

13) Making or receiving phone call.

14) Proving one's identity.

15) Applying for government or insurance benefits.

16) Any other action requiring use of PII in order to be executed.

The majority of requests using PII that are not initiated by the owner are fraudulent. There of course are exceptions, like government entities or other authorized agencies making an inquiry concerning an individual's credit or banking history.

Since the owner of the information typically initiates requests involving PII, it makes sense that the individual should confirm or approve actions that they initiated. By creating a method to confirm actions, fraudulent attempts will become much more difficult.

Requirements of the present invention include a secure account owned by the user, a set of tools used to approve or reject requests, and a change in the process to include the user in-line.

A single secured account per identity is the best possible implementation because the account can then be used to certify identity. The account can then be used to provide a certified mailing address, e-mail address and telephone number.

While having multiple accounts or solutions can help curb fraud, the adoption rate will suffer and the learning curve will be higher. As an example, if one already has an account that one is using to protect against fraud involving credit checks, they will be more likely to use the solution to prevent false tax returns from being filed. One may not, however, be inclined to create an account just to stop a false tax return from being filed. In some embodiments, a provider is the entity who is using PII owned by a user or processing a request submitted on the owners behalf. In some embodiments, a provider will ask a user to approve the use of PII owned by the user. Examples of a provider include, but are not limited to, the following:

1) A credit bureau being asked to supply a credit report to a creditor.
2) A credit card network or issuing bank processing a received transaction request using a person's
name, credit card number and expiration date.
3) A bank or credit union processing a transaction using a person's checking information.
4) A corporation processing a login request from a user.
5) A website processing a login request from a user.
6) A healthcare provider asking for approval to view healthcare records.
7) A business providing physical access to a facility.
8) A healthcare provider asking for approval to proceed with treatment.
9) A government agency.
10) An email provider.

In some embodiments, a user will log in to the authorization account and add a provider. The authorization service will then let the provider know that the user would like the provider to ask them for approval of requests relating to the service they provide. As an example, a user may have a Visa Credit card. The user may indicate that they have the credit card within their authorization account and include information that may include, in some embodiments, the last four digits of the card number and the expiration date.

The authorization service, in some embodiments, will notify the provider of the user's intention to authorize requests to use the credit card. The authorization, in some embodiments, will then supply the provider with an account or reference number that it can use when authorizing transactions using the present invention. Since the request is initiated by the authorization account owned and secured by the user (true card holder), the provider can use the supplied account number or reference to authorize requests for the card holder. The best practice will be for the provider to not use an account reference to find the user unless the account reference is received from the authorization service. This will ensure that an attacker does not provide an account reference that a provider mistakenly uses to authorize actions.

In addition, a provider may be required to supply the authorization service the full name and last four of the credit card, social security or national id number if applicable when requesting authorization from the user. That will ensure that the correct account is determined. Since there will not be duplicates, the proper owner will always be found.

As used herein, the term database may refer to a database or other acceptable data storage platform or medium.

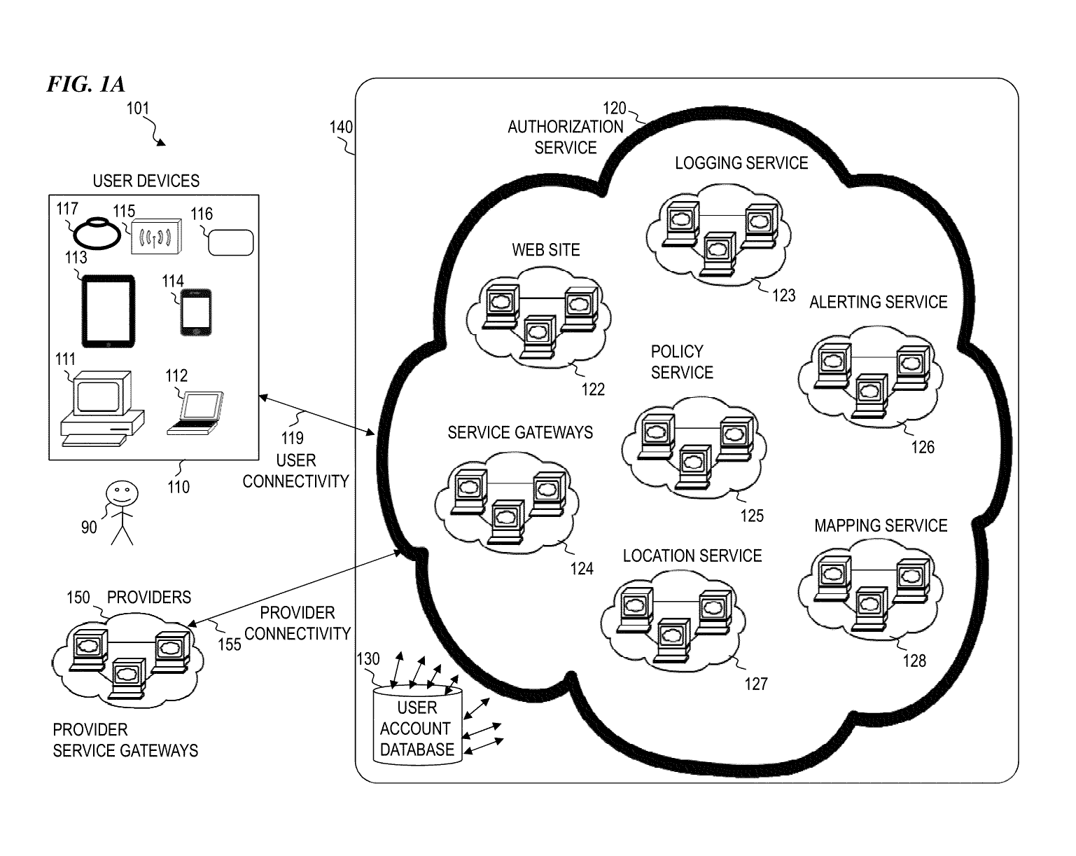

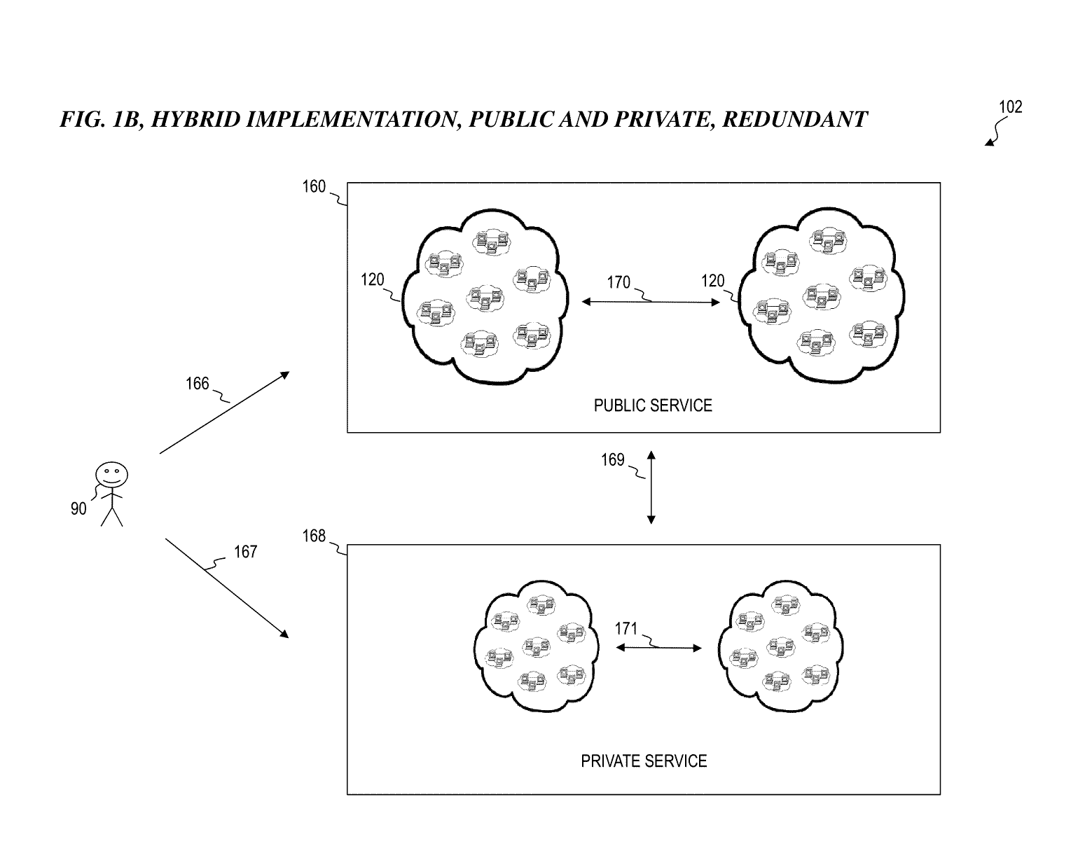

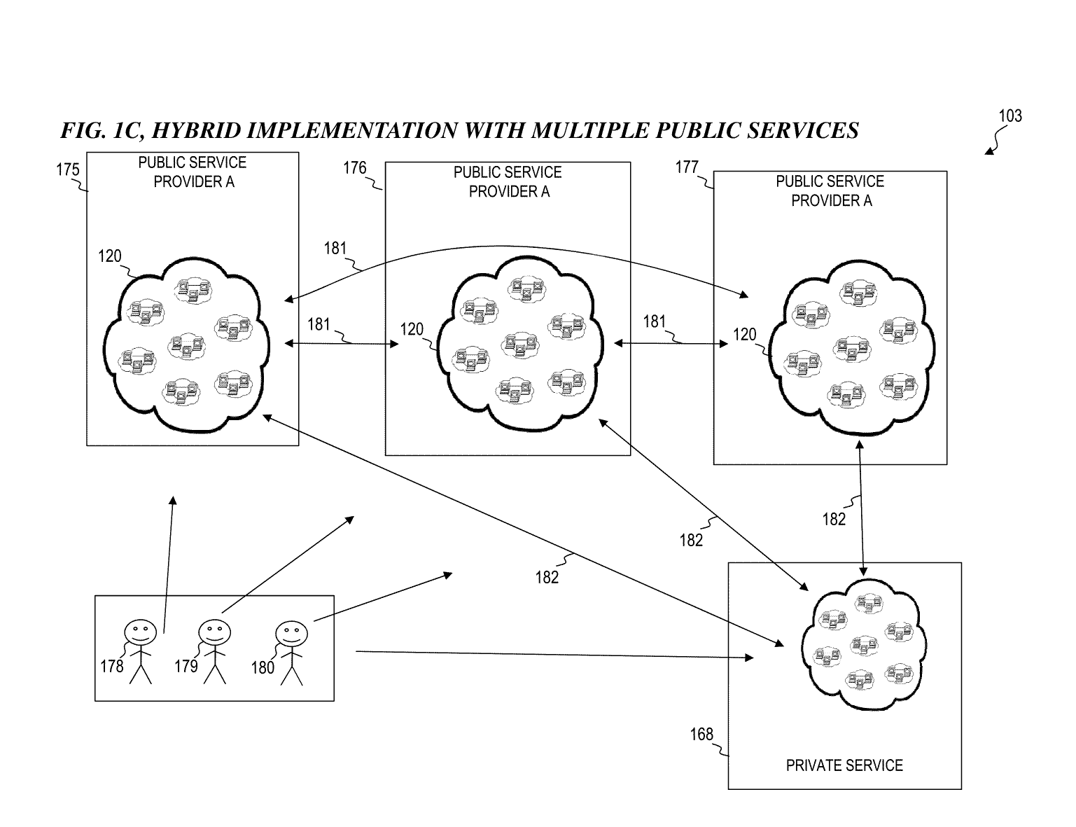

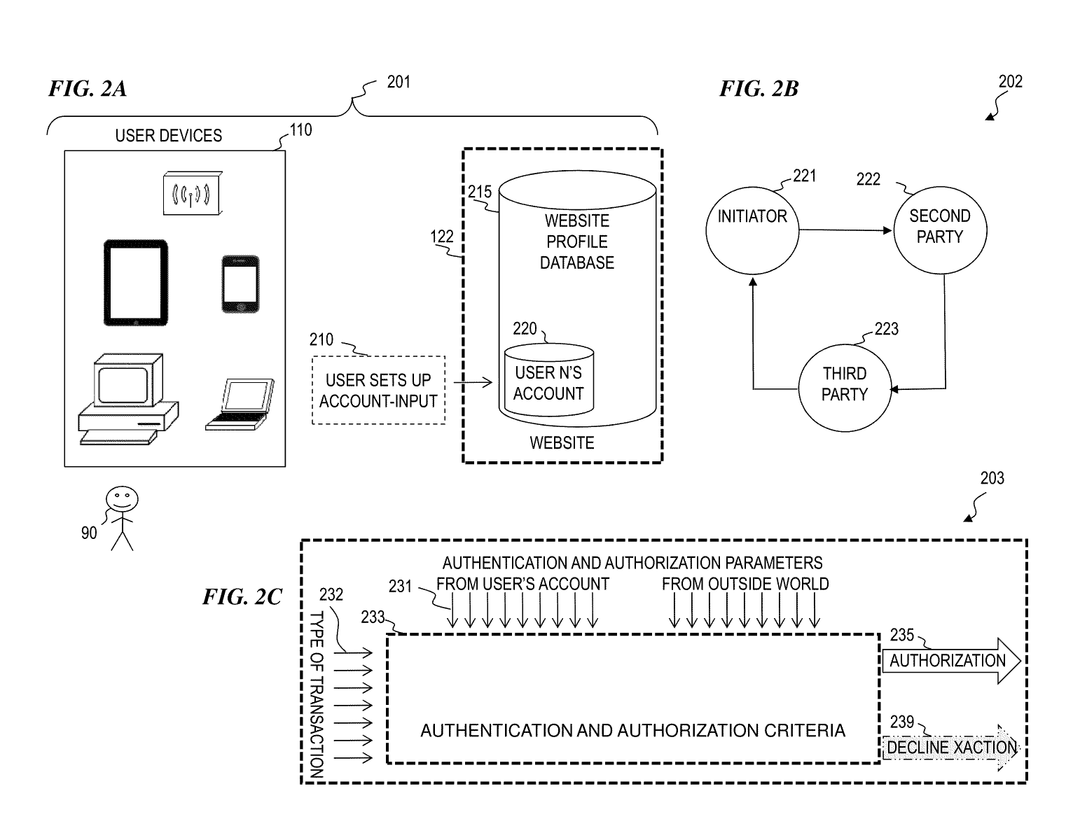

FIG. 1A is a schematic block diagram of a system 101 that provides a user-authorization service 120 (sometimes simply called the authorization service 120) according to some embodiments of the present invention. In some embodiments, system 101 includes a plurality of users 90, each having a plurality of user devices 110, and a plurality of provider-service gateways connected to an authorization process 140. In some embodiments, authorization process 140 includes a user-account database 130 and what is collectively known as the user-authorization service 120. In some embodiments, user-account database 130 is included in or distributed among the parts of authorization service 120. In some embodiments, user-account database 130 holds a plurality of secured accounts, each belonging to a particular user 90. Each account 220 (See FIG. 2A) is owned by an individual user 90, and is used to control access to the Social Security Number (SSN), Employer Identification Number (EIN), National ID number, Account, Payment Card, Gift Card, Charge Card, Checking Account, Healthcare account or any other service of this particular user 90. In some embodiments, the account controls decisions related to the individual's identity.

In some embodiments, the present invention utilizes one or more of the user devices 110 of each user 90, such as a desktop personal computer 111, laptop computer 112, tablet computer 113, smartphone 114, a position-sensing device 115 (which in some embodiments, is a stand-alone Global Positioning System (GPS) device (such as made by Garmin Ltd.) or in other embodiments, is part of a position-tracking system or another device such as a smartphone 114, payment card 116 or the like), and/or other devices such as wearable computers in clothing or smartwatches 117 or the like. In some embodiments, position-sensing device 115 (such as described in United States Patent Application Publication 2010/0156624 by Hounsell, which is incorporated herein by reference) is embodied as a tag, payment card, wristband, computer part of an automobile, or the like having a radio transceiver that communicates with the smartphone 114 of user 90 (e.g., by a Bluetooth™ or near-field communication (NFC) technology) that forms part of a multipart location-verification system that requires multiple parts (such as the payment card 116 or wallet, wristband 117 or wearable computer, and cell phone 114 of user 90) to all be within a small distance of each other at a particular location in order for location service 127 to verify that a specified location criterion is met.

In some embodiments, authorization process 140 of the present invention prevents illegitimate misuse of stolen individual one of the devices 110 of a user 90 by requiring additional verification criteria be met if not all devices of a specified set of devices 110 are within an allowable maximum distance of an attempted transaction. For example, for a particular user 90 in some embodiments, an automobile of user 90 has a GPS device that reports the location and speed of the automobile periodically to a vehicle-position-information-gathering service (such as the devices of OnStar™ Corporation), the payment card 116 includes a Bluetooth™ or NFC communication to the user's smartphone 114, and the user wears a smartwatch 117 or other wearable computing device (such as a FitBit™ device). When a purchase transaction is attempted at a given retail store, the authorization process 140 determines the geographical location of that given store, as well as the geographical location of the user's automobile and smartphone, and the physical proximity of the user's smartwatch 117 and payment card 116 to the user's smartphone at the time of the attempted transaction, and determines whether to approve the transaction based on all of these devices being physically in the appropriate proximity to each other and to the given store. This helps prevent a criminal from stealing some but not all of the devices. If the authorization process 140 determines not enough of the location criteria of the various devices and the given store are met, then authorization process 140 will require the user perform additional verification tasks such as responding to authorization requests sent to the smartphone 114 of the user 90. When the user 90 wishes to conduct a particular transaction but does not meet the location criteria for that user's devices 110, the user can use other technology (such as a public internet terminal 111 or telephone) to interact (such as across internet connectivity 119) with authorization process 140 to meet the additional criteria previously defined in the account 220 (see FIG. 2A and FIG. 2C) of that user 90 to allow a given transaction.

In some embodiments, the authorization service 120 is made up of an internet website 122, a policy service 125, a location service 127, a logging service 123, an alerting service 126, a mapping service 128 and service gateways 124. In some embodiments, the authorization service 120 is accessed by each user 90 and each provider 150. In some embodiments, the overall authorization process 140 uses authorization service 120 and database 130 to approve or deny approval for each of a plurality of different types of transactions. In some embodiments, authorization process 140 uses an authentication-and-authorization process 203 (see FIG. 2C) to select which primary criteria or alternative criteria must be met for the approval of each given transaction.

FIG. 1B is a block diagram of a system 102 that includes a user-authorization service 120 in both a public-service computer system and a private-service computer system, according to some embodiments of the present invention. In some embodiments, system 102 is an implementation of the present invention having a redundant configuration with public components and private components. In some embodiments, the best practice of such embodiments having both public and private components will replicate all required services and data between alternate data centers. In some embodiments, applications are designed with redundancy in mind and users should automatically connect to available data centers based on performance or availability. By having private service components that integrate with the public service components, providers can replicate appropriate data (if and as permitted by the user) necessary to run their service. In some embodiments, providers may only require a simple integration to communicate with the public service. In some embodiments, providers may choose the level of integration required based on their use-case. As an example, in some embodiments, a simple web services call using a restful or SOAP-based API for the purpose of validating identity or asking the question “do you approve” may be all that is needed. (Representational state transfer (REST) is an abstraction of the architecture of the World Wide Web, an architectural style including a coordinated set of architectural constraints applied to components, connectors, and data elements, within a distributed hypermedia system. SOAP, originally an acronym for Simple Object Access Protocol, is a protocol specification for exchanging structured information in the implementation of web services in computer networks.) In other cases, a provider may require a private implementation of some or all components included within the authorization services that can be used, in some embodiments, for the following reasons:

1) Continued availability during service disruptions of the public service 169 (fallback).
2) Increased security by allowing private network connectivity to the private service (MPLS or the like).
3) Customized authentication options such as back-end authentication using corporate or entity passwords, hard tokens, etc. (Some embodiments may require integration with an internal user directory using technologies such as LDAP (Lightweight Directory Access Protocol), Radius, TACACS+(Terminal Access Controller Access Control System Plus), Active Directory, and/or Security Assertion Markup Language (SAML).)
4) Increased performance by allowing direct connections from user's clients.
5) Local storage of policies, conditions, authentication factors of users (when approved by the user)
6) Configuration of provider policies and conditions to be replicated to public service.
7) Storage and configuration of information relevant to the entity such as content filtering policies, email filtering and the like. Infrastructure components leveraging such information can make local web services calls instead of making calls to the public infrastructure.
8) Mapping of local users to public (or hosted) authorization service 120 by using PII or account reference.
9) Public to private replication of relevant PINs, passwords or trust tickets. This may require federation and should be implemented securely.

In some embodiments, public service 160 and private service 168 are connected 169 by using the Internet or private connections such as MPLS (Multiprotocol Label Switching), a virtual private network (VPN) or the like. In some embodiments, users 90 connect 167 to private service 168 implementations using the Internet or private connections such as MPLS, VPN or the like.

FIG. 1C is a block diagram of a system 103 that includes a user-authorization service 120 in a hybrid system including a plurality of public-service computer systems and one or more private-service computer systems, according to some embodiments of the present invention. FIG. 1C shows an implementation of the present invention that includes a private service and multiple public services. In some embodiments of the present invention, there may be a need to provide separate public authorization services (e.g., as provided by public-service providers 175, 176 and 177, which communicate 181 among themselves) that are used by different individuals. This may be desired to reduce any impact of service disruptions, or may be required by law.

In the event that is the case, users will have the ability to use the authorization service 120 of their choice. For example, a user may sign up to use an authorization service 120 from service provider A 175. In this example, there are three public authorization service providers (A 175, B 176 and C 177). In some embodiments, providers that integrate with authorization service providers will have to integrate with all three. In this case, when a user signs up for the service, in some embodiments, there is a process 181 to check with the other service providers to make sure that the owner of the PII has not already registered with another service. In some embodiments, the two service providers not being used may create a profile with an account reference for the user to indicate that the user has decided to use a different authorization service 120 if determined necessary. That way, fraudulent users will not have an opportunity to create an account on an alternate service provider. Alternatively, the authorization services may query 181 other services during the account setup process to insure the identity is not already registered. In the event there are multiple authorization services, there will need to be a process to move an account between authorization service providers. In addition, some embodiments will require the authorization services to communicate in the event a request requires authorization from multiple users who are on different systems. In some embodiments, the best practice is for a provider to query authorization services directly when requesting approvals. In some embodiments, providers will implement mapping servers to keep track of authorization services used by its users. In some embodiments, the authorization service 120 may be allowed to forward a request to another provider for authorization or provide a redirect. This methodology could also be used within a single authorization service 120 to create “failure domains” used to minimize the impact of service disruptions.

In the event multiple public authorization services are implemented, the best-equipped service provider is one who is an innovative technology leader, well-versed in software development and infrastructure hosting. Only companies who are lead or controlled by technology visionaries should be considered as an authorization service provider.

FIG. 2A is a block diagram of a process 201 to create a user's account according to some embodiments of the present invention. In some embodiments, website 122 is provided in order for each user to create 210 a secured user account 220 in a website-profile database 215, manage profile and policy settings and access activity logs. In some embodiments, website 122 will be accessible from desktop computers and other mobile devices 110 that a user 90 may possess or control. In some embodiments, website 122 will be secured using normally accepted methods such as SSL (Secure Sockets Layer) encryption. In some embodiments, process 201 depicts the website and service infrastructure. In some embodiments, there is a customer-facing website available from the internet that provides an interface to the services of the present invention used to process requests.

In some embodiments, account 220 is created using PII of the particular individual user 90. The PII needed is enough to identify an individual. As an example, the account can be created using name, DOB (date of birth) and the last four (4) digits of an SSN. This is enough information to match an identity with the appropriate account or sensitive number. In some embodiments, in order to protect a credit-card number, the last four (4) digits of the card will need to be added to the profile. The same holds true for other accounts. If four digits are not enough, in some embodiments the website will have the ability to accept more or the full account number if needed.

In some embodiments, the full account, national ID, Passport or social security number may be utilized to validate identity but not stored within the present invention. The most secure use of the present invention is to only store the minimum amount of numbers to ensure that a duplicate account cannot be created. Doing so will avoid putting the present invention at risk of a widespread breach.

In some embodiments, it is important to ensure that the appropriate owner registers his/her own account. Because of this, in some embodiments, the account creation leverages additional security features. As an example, a code may be sent to the registered address of an individual to be used to create the account. In some embodiments, the address is validated using a credit inquiry or another source. In addition, the initial account set up or any disputes may be resolved with a physical verification at a location such as a police station or driver's license department. Other identity sources, such as driver's license number, passport number, national ID number and/or the like, are also used, in some embodiments, to validate identity. In the case of an account created for a business or entity, in some embodiments, the business's employer-identification number (EIN for taxes) is used to validate identity. In addition, in some embodiments, a certified officer of the business or entity would personally validate the identity of the entity.

Once the initial account 220 is created, it is used for authorizations on the behalf of the MI owner. At this point, it is not possible to create a fraudulent account that can authorize transactions on the PII owner's behalf without coercion of the PII owner.

In some embodiments, access to the account 220 is secured by typical methods such as username and password, mutual authentication, SSL encryption, and the like. In some embodiments, account 220 is further secured by the present invention.

In some embodiments, applications will be developed to integrate with authorization services. These applications can be deployed to user devices (see FIG. 2A). In some embodiments, the applications can be downloaded from a application store supported by the mobile device. In some embodiments, the application may be downloaded and installed from the authorization website or another website or service. In some embodiments, the applications will securely connect with the authorization service 120 using digital certificates. In some embodiments, users will be required to enter multiple authentication factors when enrolling the device including, but not limited to, account password, authorization password, last four of social security, last four of passport, last four of national ID.

In some embodiments, when the applications are deployed, they may check-in with the authorization service 120 to update the service with information that may include, GPS coordinates, IP addresses in use, device fingerprints etc.

In some embodiments, the applications will check-in with the user's authorization account to look for any pending approvals.

In some embodiments, mobile applications may modify their polling-intervals based on user activity levels or based on their location. As an example, if a user that allows location information to be used has recently driven to a store, the application may increase check-ins in anticipation of an upcoming mobile application approval.

In some embodiments, profile database 215 is used to store information such as PII. Additionally, in some embodiments, profile database 215 stores any preferences or settings.

At the core of some embodiments of the present invention is the policy service 125. In some embodiments, policy service 125 is used for setting policies on authorization requests. In some embodiments, policy service 125 contains the tools necessary to make the approval process as flexible and secure as required by the PII previously set up by or for the account holder, or interactively by account owner during the transaction.

In some embodiments, policy service 125 includes software running on servers and a database that stores policies, conditions and authentication factors.

FIG. 2B is a high-level block diagram of a trust-loop process 202 used to complete a secured transaction, according to some embodiments of the present invention. In some embodiments, trust-loop process 202 includes a user 90 initiating a transaction at an initiator 221 (such as a smartphone 221 accessing a website or brick-and-mortar store having items for purchase), which then transmits data regarding the requested transaction to a second party (or set of parties such as a credit-card company and a user's bank). In some embodiments of the present invention, a third party 223 of the present invention is included, wherein the third party performs authentication and authorization services, such as interactively verifying (such as by eliciting and receiving a positive response via the user's smartphone 221 or other suitable personal device) with the user-owner of the account that the particular user authorized the particular transaction, and/or by locating the GPS or cell-phone-tower location of the device 221 and/or any other suitable number and type of verification. While, in some embodiments, there are three parties, other embodiments use two parties or more than three parties.

FIG. 2C is a high-level block diagram of an authentication-and-authorization process 203 used to complete a secured transaction, according to some embodiments of the present invention. In some embodiments, process 203 receives an indication of the type(s) of transaction 232, receives indications of one or more authentication-and-authorization parameters 231 from the particular user's account 220 and/or from the outside world (such as from FIG. 1A's location service 127, mapping service 128, and the like). Table or database 233 holds authentication-and-authorization criteria for each type of transaction as to which authentication-and-authorization parameters from the user's account 220 or outside world will be used to determine whether or not to allow the transaction. If the criteria 233 are met, then an authorization 235 for the transaction to complete is transmitted, whereas if the criteria 233 are not met, then a “decline transaction” 239 indication is transmitted. In some embodiments, rather than transmitting a “decline transaction” 239 indication, no authorization 235 is sent within an allowed time period and this is interpreted as declining the transaction.

In some embodiments, the present invention provides a method and system for protecting against fraudulent IRS tax returns. For example, in some embodiments, an individual (customer) creates an authorization account. Next, a criminal steals the personally identifiable information (PII) of the customer, files a fraudulent tax return on behalf of the customer (in an effort to obtain the tax refund due to the customer), and attempts to guess the customer's trust ticket. The IRS approves the fraudulent return and sends a web services call to the verification service of the present invention with the (incorrect) trust ticket provided by the criminal. In some embodiments, the verification service matches the customer PII to the appropriate profile, and then the verification service looks for and discovers that the trust ticket is incorrect, which leads to the tax-refund transfer being denied. In some embodiments, both the customer and the IRS are then notified of the failed transfer.

In some embodiments, an individual (customer) creates an authorization account that includes trust tickets. Next, in some embodiments, the customer submits trust ticket 5556 along with the filing of their tax return. The IRS approves the return and sends a web services call to the verification service of the present invention with the trust ticket provided by the customer (i.e., trust ticket 5556). In some embodiments, the verification service matches the customer PII to the appropriate profile, and then the verification service looks for and discovers the correct trust ticket 5556, which leads to the tax-refund transfer being approved. In some embodiments, this verification activity is logged in the customer's account.

In some embodiments, the present invention provides a method and system for protecting a banking system that has been compromised. In some embodiments, a bank customer and a bank teller each create an Owner Authorization Account (OAA), and then a hacker installs a root kit into the bank teller's workstation. Next, in some embodiments, the teller uses the teller's OAA to authenticate a login to the workstation (e.g., in some embodiments, when the teller attempts to log into the workstation, the teller's OAA causes an alert to pop up on the teller's smartphone asking the teller to approve or decline the attempted login, and then the teller approves the login). Next, using the root kit and the bank's web application, the hacker initiates a fraudulent transaction from the customer's bank account, which, in some embodiments, triggers the customer's OAA to send an alert to the customer's smartphone. In some embodiments, the alert requests that the customer approves or declines the (fraudulent) transaction, and the transaction is stopped when the customer declines the transaction. In some embodiments, the present invention provides a method and system for protecting an OAA that has been compromised. For example, in some embodiments, a customer's OAA has been compromised by a criminal, and the criminal attempts to add a trust ticket to the customer's OAA. In some embodiments, the attempted trust ticket addition triggers the customer's OAA to send an alert to the customer's smartphone requesting that the customer approve or decline the additional trust ticket. In some embodiments, the customer declines the new trust ticket and the criminal's fraud is prevented.

In some embodiments, the present invention provides a method and system for protecting against a fraudulent credit check. For example, in some embodiments, an individual (customer) creates an Authorization Account (AA). Next, in some embodiments, a criminal steals the customer's personally identifiable information (PII), and attempts to use the customer's PII to rent an apartment. In some embodiments, as part of the criminal's rental application process, the landlord attempts to perform a credit check on the criminal using the customer's stolen PII. In some embodiments, the credit bureau then forwards a credit-check request to the customer's AA gateways for approval. In some embodiments, the credit-bureau request triggers the customer's AA to send an e-mail alert to the customer, who then declines the request and prevents the criminal from renting the apartment.

In some embodiments, the Authentication Account of the present invention includes a plurality of authentication factors that the customer can configure as desired. For example, in some embodiments, the customer has four different settings to consider for each authentication factor including (1) Allowed (i.e., allow this authentication factor to be used), (2) Required (i.e., require this authentication factor to be used), (3) Deselect (i.e., deselect this authentication factor from future use), and (4) Confirm (i.e., confirm the setting change made to this authentication factor).

In some embodiments, the present invention provides a method and system for controlling access to medical records. For example, in some embodiments, an individual (patient) creates an Authorization Account (AA). Next, in some embodiments, the individual is admitted to the hospital and registers with a nurse. In some embodiments, the nurse requests that the patient preauthorize access to the patient's medical records so that the doctor can view the patient's medical records. In some embodiments, the patient accesses their AA via a smartphone and authorizes the doctor to have access to the patient's medical records. In some embodiments, the patient also their AA to set the amount of time for which the doctor will have access to the medical records.

In some embodiments, the present invention provides a method and system for securely logging into a machine without using a password. For example, in some embodiments, a user walks to their work desk and uses a smartphone application to send a pre-authorization request to gain access to their work computer. In some embodiments, the user then enters and submits their ID into the work computer. In some embodiments, the ID submission triggers the computer to go to the company's corporate mapping database to identify the Authorization Account (AA) to be used with the submitted ID. In some embodiments, the mapping database includes the user's public AA (as opposed to the user's internal company AA). In other embodiments, the mapping database includes the user's internal company AA. In some embodiments, the computer then makes a request to the user's AA for approval. In some embodiments, the user's AA profile indicates that the user must be in the company's building to approve access to the work computer, and thus, upon receiving the approval request, the AA checks a location database to see whether the user is indeed in the building. In some embodiments, if the location database shows that the user is in the building, the preauthorization request is accepted and the AA sends authorization approval to the work computer such that the user can authenticate without a password. In other embodiments, if the location database shows that the user is not in the building, the pre-authorization request is denied.

In some embodiments, the present invention provides a method and system for securely accessing a building or room without a password and using multi-party approval. For example, in some embodiments, a security guard uses the present invention to open a bank vault. In some embodiments, the bank vault includes a keypad having only an “enter” key, and the security guard presses the “enter” key to initiate an access request. Next, in some embodiments, the system accesses the bank's mapping database, which identifies three (or any other suitable number) Authorization Account (AA) holders that are needed for access to the vault. In some embodiments, the bank's AA policy states that finger prints and PINs (personal identification numbers) are required from all three AA holders, the AA holder requesting access to the vault must be next to the vault, and the two non-requesting AA holders must verify the identity of the AA holder requesting access to the vault. In some embodiments, AA holder 1 and AA holder 2 are offsite and AA holder 3 is the security guard. In some such embodiments, a location database is used to determine if AA holder 3 is actually next to the vault, and a request is made to all three AA holders for approval by sending an authorization alert via a smartphone application. In some embodiments, AA holder 3 (i.e., the security guard) is granted access to the vault because the two offsite AA holders used closed-circuit television (CCTV) to verify AA holder 3's identity, the location database verified AA holder 3's location near the vault, and all three AA holders approved the access request by providing their fingerprints and PINs.

In some embodiments, the present invention provides a method and system for protecting payment-card processing. In some embodiments, a user makes a purchase request with a payment card (e.g., a credit card) at a merchant, the merchant then sends an authorization request to an acquirer/processor, and the acquirer/processor forwards the authorization request to the card network. In a conventional system, the card network would only forward the authorization request to the card issuer and the card issuer would then provide the authorization response back to the card network, but, in some embodiments of the present invention, the card network also sends an authorization request to the user's Authorization Account (AA), and the AA elicits authorization from the user (e.g., through a smartphone alert) before providing an authorization response back to the card network. In some embodiments, therefore, the card network will only send an authorized-purchase message to the acquirer/processor and then to the merchant if the card network receives authorization from both the card issuer and the AA. In some embodiments, if the merchant receives an authorized-purchase message, the transaction is completed and the purchase is approved. In other embodiments, if the merchant receives a declined-purchase message (e.g., if the AA and/or the card issuer does not authorize the purchase, the card network forwards on a declined-purchase message), the transaction is declined and the purchase is declined.

In some embodiments, the present invention provides a method and system that uses a customer-location database and a merchant-location database to secure a payment-card transaction. For example, in some embodiments, the customer enables a proximity service through an electronics device (e.g., a smartphone) that periodically reports the location information of the customer to a customer-location database. In some embodiments, the customer attempts to use their credit card at a store to make a purchase, the store sends the request to authorize the transaction, and the request is sent to both the payment card's issuing bank and the customer's Authorization Account (AA) for approval. In some embodiments, the issuing bank checks the account status of the customer and sends the appropriate authorization message forward (i.e., authorize or decline). In some embodiments, the AA queries a merchant-location database to provide the AA with the location of the terminal/store, and the AA determines the customer's location by accessing the customer-location database. In some embodiments, the AA then determines the proximity of the customer to the merchant by comparing the data from the merchant-location database and the customer-location database, and if this proximity satisfies the requirements of the AA, the AA will send authorization forward. In some embodiments, the store will receive authorization for the purchase only if both the issuing bank and the AA send authorization.

In some embodiments, the present invention provides a method and system for protecting against a fraudulent attempt to obtain a loan. In some embodiments, a criminal steals the personally identifiable information (PII) from a customer with an Authorization Account (AA). Next, in some embodiments, the criminal attempts to use the PII to apply for a loan. In some embodiments, a credit check request is then routed to the credit bureau, who verifies that the PII owner has an AA. In some embodiments, the credit bureau then requests authorization from the AA to perform the credit check. In some embodiments, the AA denies the request, notifies the customer, and prevents the attempt to apply for the loan.

In some embodiments, the present invention provides a method and system that uses proximity detection to securely purchase a car. For example, in some embodiments, an individual creates an Authorization Account (AA) using personally identifiable information (PII) to protect their credit. In some embodiments, the individual attempts to purchase and finance a vehicle, the car dealership performs a credit check, and the credit-check requests are required to include global-positioning system (GPS) coordinates. In some embodiments, the credit bureau forwards the dealership request to the individual's AA for approval. In some embodiments, the individual's AA is configured to attempt proximity authorization first, mobile (e.g., smartphone) authorization second, and desktop authorization third. In some embodiments, the individual's current vehicle GPS is integrated with the AA to provide location information such that the proximity authorization is approved and the credit check is automatically approved. In some embodiments, the AA activity regarding the vehicle-purchase credit check is logged and an e-mail is sent to the individual.

In some embodiments, the present invention provides a method and system for protecting online purchases. For example, in some embodiments, a customer visits a website and adds an item or items to a virtual shopping cart. In some embodiments, the customer then logs into their Authorization Account (AA) website, accesses a previously configured trust ticket for the transaction, and proceeds to checkout to complete the purchase.

In other embodiments, after adding items to the virtual shopping cart, the customer opens their mobile Authorization Account (AA) application, initiates checkout, and confirms the transaction via an alert that pops up on their mobile AA application, to complete the transaction.

In some embodiments, the present invention provides a method and system for securely performing a credit check for a minor (e.g., a child). In some embodiments, a child's custodian adds personally identifiable information (PII) of the child to the custodian's Authorization Account (AA) in order to protect the child's credit. In some embodiments, a criminal then attempts to obtain a loan using the child's stolen PII. Next, in some embodiments, a credit check is performed by the financial institution, and the credit bureau forwards the request to the custodian's AA for approval. In some embodiments, the custodian's AA does not permit the credit-check inquiry, and the criminal is prevented from obtaining the loan. In some embodiments, the custodian is notified of the failed attempt by the criminal.

In some embodiments, the present invention provides a method and system for using a location signature to reset an Authorization Account (AA) setting. In some embodiments, a user attempts to reset their AA password. In some embodiments, the user's AA requires the user to use a location signature (e.g., a path walked by the user) to reset the password. In some such embodiments, for example, upon a request for a password reset, the AA elicits a location signature from the user, the user then walks around the block taking a certain path, and the user's AA location database is queried to verify the path. In some embodiments, the user is allowed to reset the password if the path taken by the user is verified by the user's AA location database.

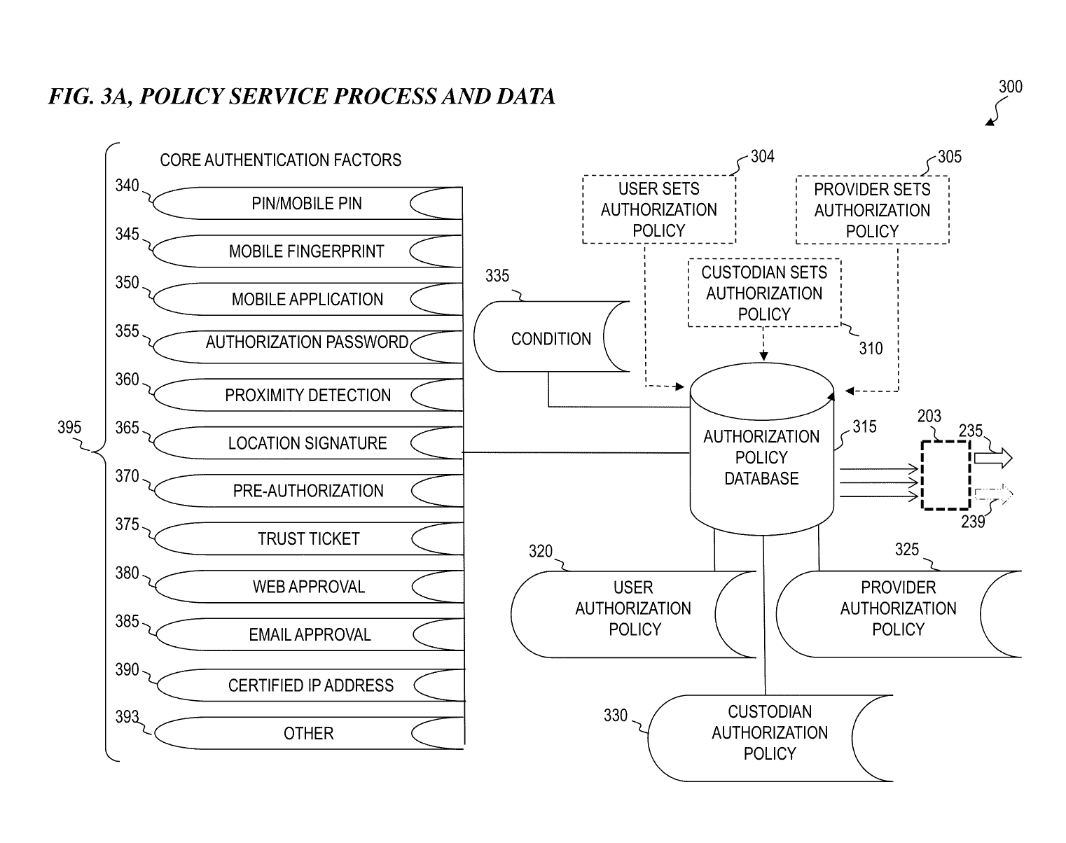

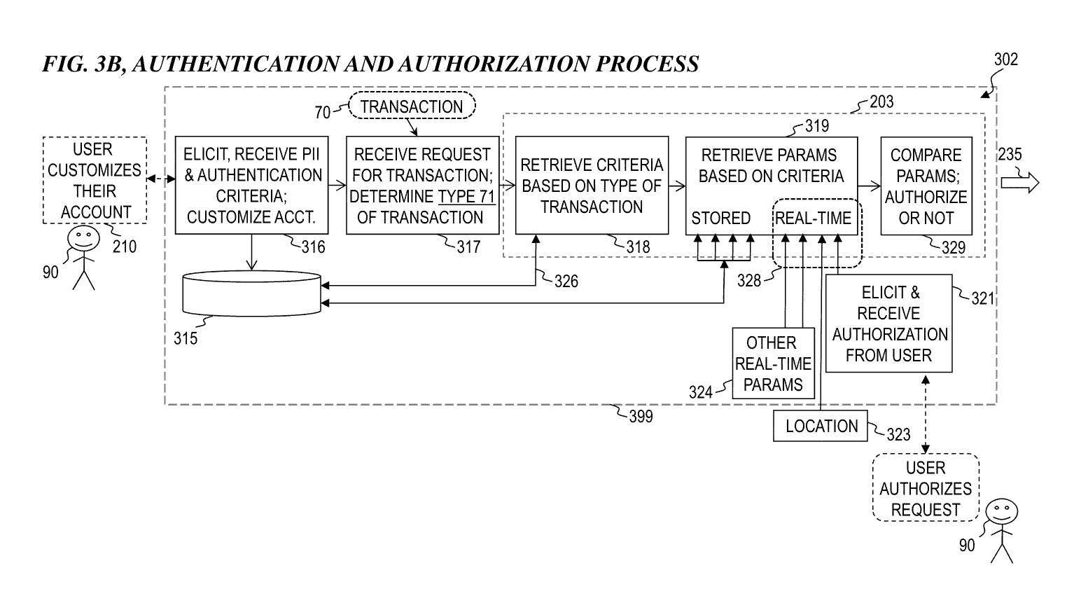

FIG. 3A is a high-level block diagram of an authorization-policy-service process and data 300 to protect a secured transaction, according to some embodiments of the present invention. In some embodiments, authentication factors are used to authenticate an individual's identity.

A condition 335 includes a set of special parameters that can be set by a user 90, provider 150, and/or custodian 92. A condition 335 is used to determine a set of criteria to be used for the approval of the request for the transaction (also sometimes simply called “the request”). In some embodiments, a user 90 may decide to only authorize a specific request for a predetermined period of time, or within a particular range of dollar amounts, or at a specific dollar amount. In some embodiments, a condition 335 defines how many times an authentication factor can be used before the value needs to be changed. In some embodiments, a condition 335 is used to specify which locations that the user 90 is allowed to do business in. A user 90 who is not traveling may choose to have a default condition that only allows in-store transactions to only be approved within their city or state. If the user leaves town, the user can choose to remove the restriction condition. In some embodiments, a condition 335 can be added by the user 90 or provider 150 to any authentication factor. A condition 335 provides a very powerful tool that, by itself, can significantly reduce the impact and scope of fraud.

In some embodiments, the present invention uses one or more of three different types of policies: a user-authorization policy 320, a provider-authorization policy 325 and a custodian-authorization policy 330. In some embodiments, a user authorization policy 320 and a provider authorization policy 325 are required, and custodian authorization policy 330 is optional.

In some embodiments, provider authorization policy 325 is used to set the minimum required authentication factors and conditions. As an example, if a user is attempting to withdraw money from an ATM using a bankcard, the provider (the bank) may require the user to enter a PIN. The provider may require the use of a PIN unless the user sets another factor that they deem to be more secure. Additionally, a provider may set conditions, such as if the user's withdrawal (or purchase, in the case of a store transaction) is over $1,000, then the user needs to add an additional authentication factor to the approval. In some embodiments, provider authorization policy 325 enforces minimum password security factors and/or PIN length.

In some embodiments, the user-authorization policy 320 is where the system stores what the user 90 decides as to which authentication factors or conditions they would like for a specific type of request. A user 90 may only want to be made aware of credit checks being run on them, while a very security-conscious user may stack multiple authentication factors to allow a credit check to take place.

In some embodiments, a custodian-authorization policy 330 is used to set policy for individuals or items for which the user is responsible. In some embodiments, custodian-authorization policy 330 is used to monitor or prevent credit checks on a minor. In some embodiments, custodian-authorization policy 330 is used to set limits and other conditions on a prepaid card or credit card given to another account owner.

In some embodiments, a plurality of core authentication factors 395 (individually marked as 340-390 and described below) are provided, such that one or more are used to authenticate a user and the transaction that is being attempted.

A mobile PIN 340 is numerical number that is stored in the authorization account. In some embodiments of the present invention, the PIN is used (optionally with other factors) to authorize an ATM withdrawal as it traditionally does today. In addition, a PIN may be used along with a mobile application that incorporates the present invention. This allows the use of a PIN without having to enter it at the POE. In some embodiments, the PIN is also added to other payment options, such as a credit-card transaction, if desired and supported by the provider 150. In some embodiments, traditional PINs continue to be supported, but moving the PINs to a user's authorization account provides greater flexibility and makes changing them much easier and more secure. Additionally, in some embodiments, a PIN that is entered through a mobile application is much more secure than one entered at the POE. Consider the example of a user 90 who has a condition 335 set that requires mobile PIN entry. Even if the ATM still requires the PIN be entered at the POE, that condition 335 requires that the user enter the PIN on the user's mobile application as well. That means that a fraudster would have to have access to the user's ATM card, the user's PIN, and the user's mobile phone in order to compromise the user's account. If that is not considered secure enough, the user can add a few more factors.

A mobile fingerprint 345 is the use of a fingerprint reader on a user's personal mobile device as an authentication factor. In some embodiments, the fingerprint parameter is stored and verified via the service 203; or, in other embodiments, the present invention simply relies upon the mobile device to perform the verification. In some embodiments, a mobile fingerprint operation is performed within the application connecting to the authorization service. Alternatively, in other embodiments, the act of unlocking a person's mobile device within a period of time (condition) during or before the request may be used to approve the transaction.

A mobile-application confirmation 350 is the use of a mobile application to confirm the request. While this method is very simple, it adds eliciting and receiving authorization from the user via the user's registered mobile device as another factor. That means that a fraudulent attempt would require access to the user's mobile device on top of stealing the user's PII. Like other authentication factors, mobile-application confirmation 350 can be combined with other factors. In some embodiments, the present invention also may require other factors based on conditions present. For instance, a transaction under a certain amount may only require a mobile confirmation, while a transaction involving a higher amount may require adding another factor such as a mobile PIN or password.

In some embodiments, a mobile application is able to connect to the user's authorization account only when a user has configured it with multiple authentication factors. For instance, after installing the mobile application, the user may be required to enter the account password, a second authentication factor such as an authorization password or PIN may be used. In some embodiments, a dedicated mobile enrollment password may be used as a second factor. In some embodiments, a digital certificate generated from the authorization account may be installed on the mobile device in order to validate that it is authorized to connect to the service. In some embodiments, a user may be required to enter at least one authentication factor when accessing the mobile application and not using an automatic screen lock.

In some embodiments, the mobile application will be used to collect device information that can be used as an authentication factor. For instance, an authorized mobile device may provide device fingerprint information that can be stored in the authorization account. When the device connects to the authorization service, the generated fingerprint or specific information that can be used to identify the unique device can be placed in the user's profile. A website or remote computer-system may use a similar process to generate a fingerprint when the mobile device is connecting to it. That website or system can check the authorization service 120 for a matching value which can, in turn, certify the identity of the individual.

In some embodiments, the authorization service 120 will record the IP address that the device is using to connect to it for use as an additional authentication factor.

In some embodiments, a similar application may be used on a desktop or laptop for the purpose of approving requests and validating identity.

An authorization password 355 is a password used as an authentication factor. An authorization password should remain confidential and only entered by the user. An authorization password is a not the same password that is used to log in to the authorization service account 220. Its specific purpose is to authorize requests. Like other authentication factors, providers may add conditions on an authorization password like password strength, how long it is valid, etc.

In some embodiments, proximity detection 360 is used to determine whether the PII owner is actually at the location where the request is taking place. The authentication factor works by tracking the GPS coordinates of the user and comparing it to GPS coordinates of the business, entity, terminal or device location. In some embodiments, the coordinates are manually input for static devices. In some embodiments, for mobile devices, the entity integrates with the service and periodically reports GPS coordinates. In some embodiments, any mobile device that can report location can be used. As an example, a mobile phone can collect the coordinates. An integration of the present invention with a vehicle's GPS service could provide coordinates of the user's vehicle location. Additionally, in some embodiments, a specialized device that is only used for the specific use case is used. In some embodiments, it is important that entity locations are accurate so there will be a robust process in place to input and verify entity locations. For example, the user may ask Merchant Banks to track and report their Merchant's payment-card terminal locations. The user may also choose to have a team dedicated to manually inputting entity location or specialized software used to track entity location and automatically input coordinates. There is no specific requirement for the location technology used. In some embodiments, location is determined via one or more methods from the group consisting of A-GPS, GPS, WIFI location tracking, tracking based on cellular networks, Bluetooth® technologies and/or IP addresses. Location can be determined with any product or service designed to determine a person or devices location. The service can be used with any technology that can report the location of a user or entity. In some embodiments, a social network “status update” or a manual update may be a great way to periodically report the user's location if the user is not comfortable with an automatic update.

In some embodiments, proximity detection 360 is completed entirely on the user's side. For instance, if a user is not comfortable enabling proximity detection 360 full-time or a merchant has not provided coordinates, a user could open the authorization application, allow the use of location data and pre-populate the merchant in as a preauthorization. The user could then authorize a transaction before they check-out by manually using location services and stacking it with preauthorization.

In some embodiments, proximity detection is used to validate a user's own device. For example, a user's tablet may report location coordinates to the authorization service. The user proceeds to log in to a website and after successfully entering a username and password, the site checks authorization services for coordinates. The user's device allows the website to use location information or directly provides coordinates. As long as the coordinates match or are within an allowed tolerance, they will pass authentication. This factor can also be used when a person is using multiple devices. For instance, if a user is providing location data from a cell phone and connecting to a website via a laptop, the laptop can report its location to the website. As long as the cell phone is close to the laptop, authentication will be successful.

A location signature 365 is data that tracks locations of the user along a predetermined path set by a user, which is used as an authentication factor. A location signature may be walking around the neighborhood in a specific way (along a path that has been defined by the user to serve as an authentication factor) or driving from one location to another along a specific route or path. In some embodiments, a location signature could be required to be combined with a condition 335, such as arriving at one or more of a series of predetermined locations, or completing the signature within a set period of time. A location signature may be recorded manually by entering in landmarks or coordinates. As an example, a user may create a location signature by inputting coordinates of three locations and indicate the order and time the user has to travel to all three locations. When verifying the signature as an authentication factor, the user may use an application that has access to a GPS device (or device capable of determining location) and drive to the predetermined locations in the allotted amount of time to pass the signature.

In some embodiments, the location signature may be used with a device that can detect more fine-grained motions. The series of motions can then also be recorded as a location signature. For example a user may record a signature of the user waving their hand in a certain pattern twenty (20) times. In order to play back the signature properly, they would need to recreate the gesture within a defined tolerance. The device could be something that the user is wearing or an external apparatus used to detect motion, a heat signature or analysis of a video of the user.

Pre-authorization 370 is approval of a request before it actually happens. In some embodiments, preauthorization is typically stacked with at least one other authentication factor. As an example, a request can be preauthorized by using a mobile confirmation or logging in to the website and authorizing a future request. As an example, the user may decide that they will be shopping for the next few hours and that all transactions should be approved. In another situation, the user may be applying for a mortgage and decide that for the next week, credit checks are permitted or they may decide to simply add the name of the creditor as preapproved to check a user's credit. In some embodiments, a user may be preparing to initiate a request that requires their approval and toggle an “authorize all” button on before they initiate the request. For instance, the user may be logging in to a website or initiating a credit-card purchase. The user would simply use a device, such as a laptop, desktop, tablet or mobile phone, that is registered to her authorization account and authorize the request. Once the transaction is complete or website is logged in, the user can simply toggle off the “authorize all” button.

In some embodiments, there may also be a need to specifically deny a transaction before it happens. For instance, if a person was working with a merchant to complete a purchase and provided credit-card information but decided that they were not going to go forward with the transaction, they could enter the payment or merchant details in as a negative pre-authorization to safeguard them from receiving improper charges. A negative pre-authorization can be used to specifically deny any request that the user has a reason to believe may be received but not welcome.

Like all other authentication factors, a preauthorization can be stacked with other authentication factors or conditions.

A trust ticket 375 is any value specified by or agreed upon by a provider and a user. A trust ticket is a semi-private value in that it should only be provided to those with a need to know. It is not like a password or PIN as those are values that should remain confidential. A trust ticket is typically provided at the POE of the request and used to automatically approve the request Like all other authentication factors, a trust ticket can be combined with a condition 335. The user may decide that a trust ticket can only be used for a period of time or specific number of uses, depending on what it was used for. In some embodiments, trust tickets can be either manually entered, or generated dynamically within the authorization account. A trust ticket can be derived at the provider. As an example, the tax authority may expect the amount of a tax refund to be input as a trust ticket. If the deposit matches, it goes through. Only the user, the tax authority and the user's tax professional should know the number. A trust ticket may also be derived from information about the transaction or request. A user may add a trust ticket with the amount of a purchase or name of a merchant or business submitting a request.

In some embodiments, the present invention can be used to mimic a CSC or CVV2 code. In order for this to work, the credit-card network would need to simply ask the user to validate the CVV2 code instead of verifying the original code generated when the card was produced. For backwards compatibility, the CVV2 could still be verified at the issuing bank unless the CVV2 value was added in the user's profile. The benefit here is that the user would be able to change the value without obtaining a new card. Existing credit-card terminals and websites would be able to take advantage of it without any modifications. Additionally, conditions can be applied to the CVV2 and the user could use multiple numbers. As an example, a user may choose to maintain the existing CVV2 code on the back of their card with a condition of a small purchase limit. The user may then add a second value with a higher dollar amount. Once the present invention is being used broadly, CVV2 may no longer be needed. In the mean-time the present invention can take advantage of it and significantly improve its value. In addition to providing the ability to verify a CVV2 number, the user could indicate their preference in its use. The cardholder network can notify the merchant of that preference allowing the merchant to require based on the account owners preference. Today, CVV2 checking is not required at all merchants because it may not be accepted by some users. If a user prefers that the merchant use CVV2, it will provide greater security to that user.

Web approval 380 is the action of logging in to the user's authorization account to approve a request. Like other authentication factors, conditions can be applied to the use of web approval 380. The user may decide that approval of a request using this method also requires the use of an authorization password or an out-of-band method such as mobile application confirmation. This ensures that if the user's authorization account itself is compromised, criminals cannot approve requests on the user's behalf.

Email approval 385 is an authentication factor involving the approval or rejection of a request via e-mail. A special link may be generated that a user follows, or an e-mail with keywords such as “approve” or “reject” can be sent to a specific e-mail. Since this type of approval can be more susceptible to fraud, in some embodiments it is used more sparingly or stacked with other authentication factors like mobile confirmation.

A certified IP address 390 is an IP address that is validated as being in-use by a user. An IP address logged from a mobile or desktop application that has been registered to a user's authorization account can, itself, be used as an authentication factor. When the mobile or desktop application connects to the authorization service, the service can log the source IP address being used by the application to connect. Since the application is using multiple factors to connect, it is verified as being owned by the user. In addition to logging the source IP address, the authorization account may also log the source port number. This may be necessary in the event that the user is connected to a private network that is using Source Network Address Translation (SNAT) to translate internal addresses to an external public IP address. If necessary, the source port can be used in conjunction with the IP address to validate identity. When connecting to an internet site, the user can log in to the site in the normal manner and the site may log the IP address being used and make a query to the authorization service 120 using the PII of the individual. The site can then provide the authorization service 120 with the IP address being used and validate that it is an address certified as recently being used by authorized devices. The website 122 and authorization service 120 may need to enable features on their load-balancers or web service such as an http x-forwarded-for header that is used to preserve source IP address information when SNAT is in use within the websites or authorization services network.

In some embodiments, dynamic entries of certified IP addresses may be used by network devices, including but not limited to, firewalls, load-balancers and routers. Additionally, they may be used by applications such as software based firewalls. Entities and individuals may authorize their devices to notify the authorization service 120 of IP addresses being used. Entities or individuals may also authorize other entities or individuals to check for valid IP addresses. As an example, an entity's load-balancer infrastructure may notify the entity's authorization account securely about IP addresses being used for a particular website. The IP addresses could be IPV4 or IPV6 and be static or dynamic IP addresses. Users or entities connecting to the website could verify that the IP address received via their DNS resolution is an IP address certified by the authorization service. The client or entity firewall could make an inquiry with the website name and resolved IP address and the authorization service 120 can confirm that the entity is certified and the IP address is correct. The firewall can be configured to block (or warn) access to entities that are not certified or to IP addresses that are not proven to be owned by the entity.

In some embodiments, one or more other authentication factors 393 are used with the service. Any suitable authentication factor in use or developed in the future can be added if deemed necessary or desirable. In some embodiments, there are special circumstances where other authentication factors such as facial recognition, iris recognition or other biometric devices are used. A user may decide that they want to use a rolling hard-token (a physical device such as a USB fob or dongle that generates a series of encrypted numbers that are unique as to a particular user at a particular time and that change from time-to-time (such as every minute, in some embodiments), and which are matched to a corresponding series of encrypted keys maintained in authorization policy service 127, such as described in U.S. Pat. No. 6,760,843 by Carter, which is incorporated herein by reference) as an authentication factor. A user may decide they want to respond to a text message to approve a request, as one of the authorization criteria.

In some embodiments, a device fingerprint that is generated and stored by an authorized device and stored in the authorization account profile may be used as an authentication factor. The second or third party may use a similar process to generate a device fingerprint and then check the authorization service 120 for a matching value that was initially reported by the same device having access to the authorization account.

The present invention can be used catch criminals when they are committing the crime. As used herein, this is called Active Crime Response (ACR). With ACR, active detection and reporting of fraud is possible, in contrast to current methods that are reactive and rely on analytics. As a result, the chance of catching a criminal will exponentially increase. Current systems that detect fraud rely on analytics to check for patterns and look for indicators of fraud. Unfortunately, they are very complex and not always effective. They often times cause accounts to be de-activated as a result of false-positives. They are also delayed to where they cannot stop an active crime. As an example, an individual may be called by their Credit Card issuing bank. The bank may state that they determined possible fraud on the account. If that person confirms, that it was fraud, it is too late to catch the criminal. By actively authorizing actions, the present invention can immediately report fraud without the need for complex analytic software. Authorities can then take immediate action.

Failed attempts can be actively used to stop crimes. As an example, if a user is asked to authorize a request to approve a credit-card transaction that they did not initiate, they could deny the request and explicitly indicate that it is fraud immediately. The service could report the physical store location that the transaction was at. Once the request is denied and confirmed to be fraudulent, the service could report the terminal GPS coordinates to authorities and store security for a response. This would significantly cut down on in-store fraud because any unauthorized attempt could result in immediate police or security action. As a result, users who do not leverage the authorization service 120 can still receive benefit from it as the chances of getting caught can deter criminals from committing a crime.

Any attempt to open up a fraudulent account could be immediately reported as fraudulent by the user. As a result, any confirmed fraudulent attempt can be met with police or security response.

Fraudulent tax returns can easily be stopped by the service. To take it a step further, the tax authority will be actively informed of the fraudulent attempt. They could then send an invalid check to the criminal and arrest them when they attempt to cash it. If the criminal was not observed entering a bank to cash the check, the check number could be used to trigger a silent alarm and police response.

In some embodiments, users are also be incented by the present invention to stop fraud. As an example, if a user agrees to provide feedback for denied transactions and their feedback results in an arrest, some embodiments of the present invention provide that that user would be compensated with a reward having value. In some embodiments, merchants or businesses decide whether to provide a gift card or other incentive for any fraud that was stopped using the present invention in their location. That will deter thieves from defrauding those merchants. In some embodiments, users may actively indicate that they would like to confirm their transactions in order to prevent fraudulent activities. In that case, when a transaction or request is denied automatically, a user may choose to still receive a pop-up message from authorization applications asking for confirmation that the attempted transaction was indeed fraudulent activity. The user can then confirm the attempted transaction was fraudulent activity. In some embodiments, the automatic denial of the transaction may be enough to confirm. In some embodiments and if allowed by law, the user may submit an authorization to prosecute (electronic signature). If permitted by law, this could prevent a user from having to file a police report before action is taken.

FIG. 3B is a block diagram of an authorization process 302 used to protect a secured transaction, according to some embodiments of the present invention. In some embodiments, authorization process 302 (using a system such as service 120 of FIG. 1A) includes eliciting and receiving 316, into a computer system 399, personal identification information of a human user 90 and authentication criteria customization information from the human user and customizing, in a database 315 of the computer system 99, a user account 220 (see FIG. 2A) for the human user 90 that includes a set of authentication criteria 233 (see FIG. 2C) of the identified human user 90 for each one of a plurality of transaction types 232 (see FIG. 2C) based on the received authentication criteria customization information from the human user 90; receiving 317, into the computer system 399, a request to perform an electronic transaction 70 for an identified human user 90 at a location remote from the computer system 399; accessing 326, by the computer system 399, the set of authentication criteria of the identified human user 90 from the database 315 based on a type 71 of the transaction 70; retrieving, into the computer system 399, a plurality of real-time authentication parameters 328 relevant to the human user 90 and to the type 71 of the transaction 70; and comparing 329, by the computer system, the plurality of retrieved real-time authentication parameters 328 to the accessed set of authentication criteria of the identified human user 90 and based on the comparing of the real-time authentication parameters, either authorizing 235 an action to complete the electronic transaction 70 or withholding the authorization.

In some embodiments, process 302 includes transmitting, to a first personal electronic device (e.g., one of devices 110 of FIG. 1) of the human user, a real-time alert of the request to perform the electronic transaction; displaying, on the first personal electronic device of the human user, an indication of the real-time alert of the request to perform the electronic transaction; and eliciting and receiving 321 a real-time authorization indication from the human user using the first personal electronic device of the human user, wherein the retrieving of the plurality of real-time authentication parameters relevant to the human user and to the transaction includes retrieving the real-time authorization indication from the human user.

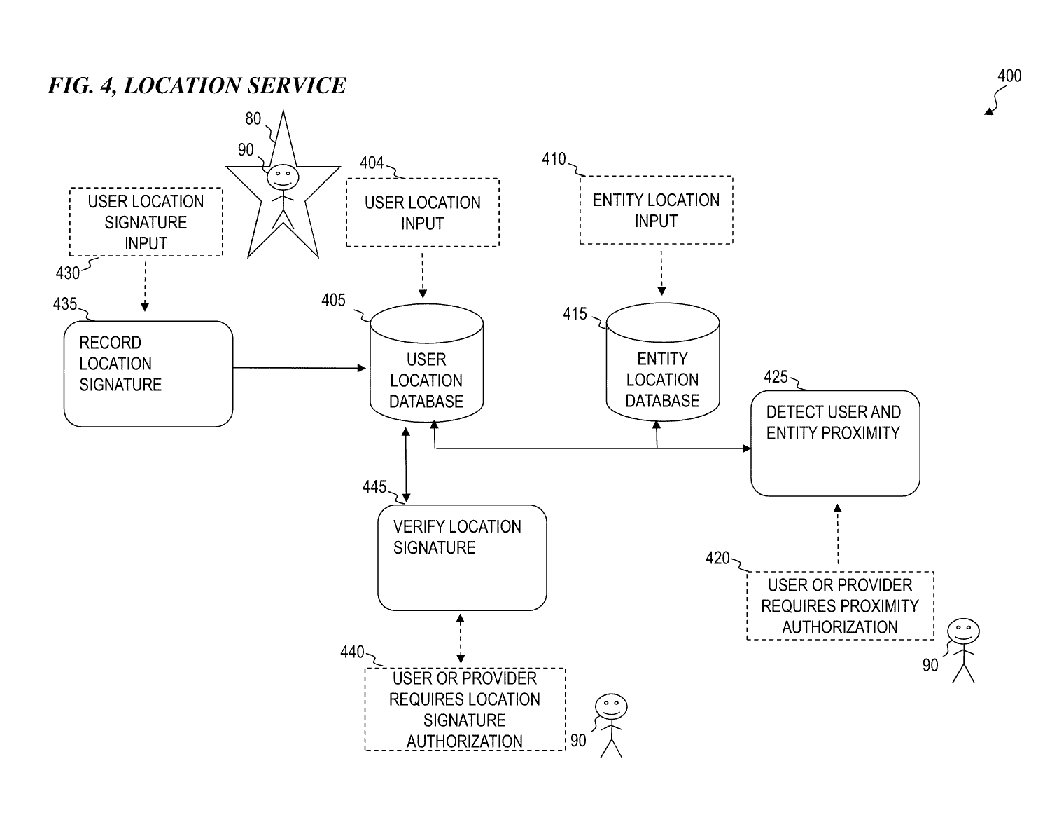

FIG. 4 is a high-level block diagram of a location-verification-service process 400 that verifies a user's location to help protect a secured transaction, according to some embodiments of the present invention. In some embodiments, location-verification-service process 400 is used to provide functionality to location service 127. In some embodiments, location-verification-service process 400 is a system that is dedicated to servicing requests related to location of users and entities. In some embodiments, location service 400 is responsible for tracking a user's physical geographical location 80. In some embodiments, location service 400 stores the information in a user-location database 405. Additionally, in some embodiments, the location service will be responsible for tracking an entity's location 410 and storing it in an entity location database 415. In some embodiments, the location service will be responsible for determining how close a user is to an entity 425 for the purpose of authorizing a request. The location service will be used to record a location signature 435 and verify a location signature 445. In some embodiments, a user's location is used to authenticate access to a system. In some embodiments, the location database stores only a last-known location. In some embodiments, a location database stores location history (i.e., a series of locations and/or times) when needed.

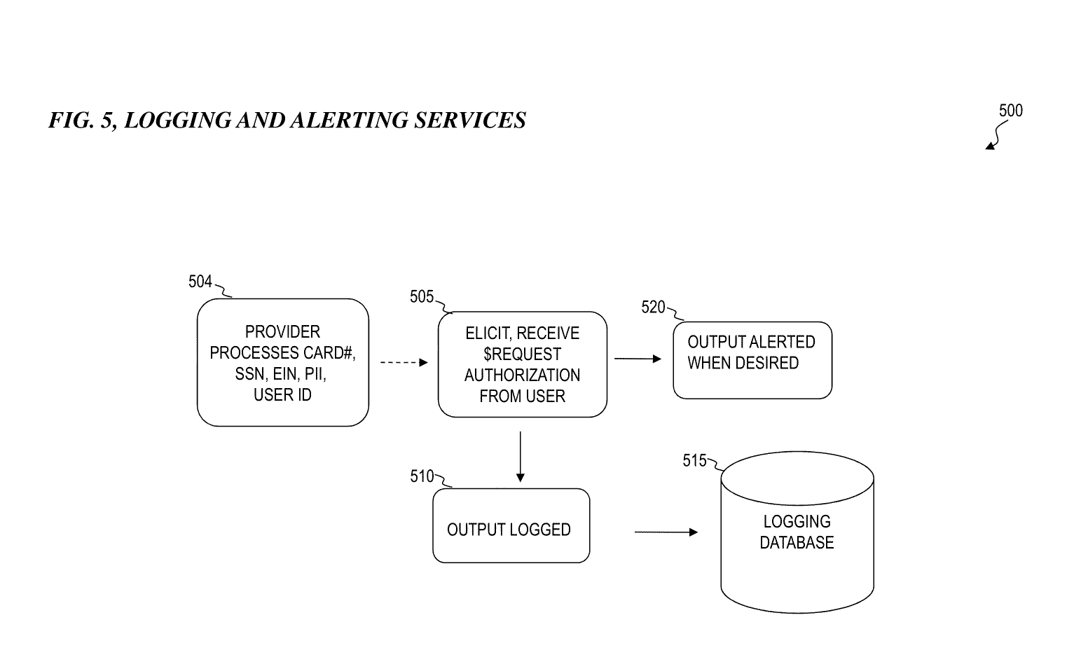

FIG. 5 is a high-level block diagram of a logging-and-alerting-services process 500 that controls access to a user's records, according to some embodiments of the present invention. In some embodiments, logging-and-alerting-services process 500 provides functionality for logging service 123 of FIG. 1. In some embodiments, logging service 123 is used to save authorization response and related activities. When requests are made, they will be logged 510 to a logging database 515. Logs may also be saved on a flat file system or an archive system or media. In some embodiments, visibility is key in mitigating identity theft and logging will help ensure that users know what requests are being made with their PII.

The alerting service 128 is used to provide increased visibility by notifying users immediately 520 when a request is approved or rejected. Alerting is optional and may include a mobile notification, an e-mail, a text or a mail notification. In some embodiments, alerting is used to increase visibility even for those who choose not to stack authentication factors.

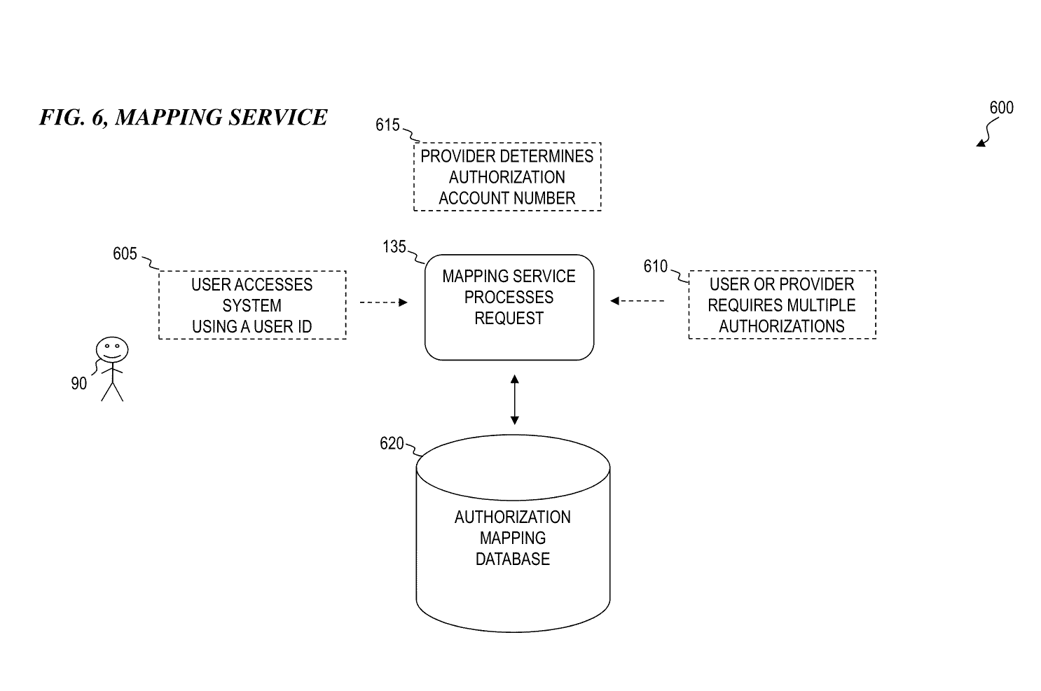

FIG. 6 is a high-level block diagram of a mapping-service process 600 that uses multi-party approval to help protect a secured transaction, according to some embodiments of the present invention. In some embodiments, process 600 is used for mapping service 128 of FIG. 1. In some embodiments, mapping service 128 is used to map a request or userid to an authorization account. A mapping service is also used to map a request to multiple authorization accounts. Finally, a mapping database is used to map a user to an authorization account number. The mapping service will store mappings in a database 620. In some embodiments, a mapping database is useful at a provider network and an authorization service provider. A provider may use a mapping database to map an enterprise userid to an authorization account number 605. A provider may also use a mapping database to map PII to an authorization account number 615. The reason why this is useful, in some embodiments, is that it improves processing speed of requests for some embodiments. As an example, a request being processed by the authorization service 120 using PII may take longer than a request referencing an account number. After the authorization service 120 correctly determines the PII owner's account, in some embodiments, an account number is given to the provider for subsequent requests.

A mapping service can also be used to map multiple userids to authorization accounts 610. This can be useful when multiple approvers are required.

In some embodiments, users connect to the authorization service 120 by using a desktop, laptop or any other suitable mobile device 110. These devices 110 are used to access the website 122. In addition, devices 110 are used to authorize requests. In some embodiments, devices 110 use the public Internet 119 to connect to the authorization service 120. In some embodiments, devices 110 also use generally accepted conventional security best practices such as transport encryption using Transport Layer Security (TLS) and/or public key infrastructure (PKI). Additionally, in some embodiments, mobile devices 114 have an enrollment process that ensures devices 114 are only able to connect to their owner's account. In some embodiments, the enrollment process makes use of a Mobile Device Management (MDM) platform. In some embodiments, the enrollment process also takes advantage of technologies such as client authentication using PKI and non-exportable certificates. Additionally, in some embodiments, other technologies such as device fingerprinting are used in order to ensure mobile devices are only allowed to access approved accounts 220 (see FIG. 2A).

In some embodiments, providers 150 connect to authorization services 120 for the purpose of approving requests, accessing location services and setting provider policies. In addition, in some embodiments, providers 150 retrieve user and provider policy and authentication settings that relate to their service. In some embodiments, providers 150 also retrieve account names that are registered with their service. By sharing this information, providers 150 can control performance and efficiency of requests. As an example, if providers 150 are able to import names that have signed up for an authorization account 220 and have added their service to the account profile, those providers 150 can limit requests to only be sent for known users. In addition, there may be “use cases” where the provider 150 may want to accept mobile device traffic directly and use authorization services 120 for logging and alerting. An example here would be a credit-card provider that would like to ensure the absolute best performance. They would import account information and policies for their customers and accept mobile authorizations directly on their gateways. They would then provide logging data (into logging service 123) and alerting data (into alerting service 126) directly back to the authorization service 120.

In some embodiments, service gateways 124 are used to service requests from providers 150 and user mobile devices 110. In some embodiments, service gateways 124 use the Internet (such as connection 155) or private networks or a combination of both to connect to providers 150. Service gateways may use general security best practices such as TLS encryption, PKI and mutual authentication using client-side certificates. In addition, in some embodiments, service gateways 124 use non-repudiation techniques such as digital message signing to verify and prove requests being made. For use cases that do not require real-time processing, service gateways 124 may use a batch process in order to deliver requests. In some embodiments, the present invention uses multiple accounts, multiple providers and multiple authentication factors together if desired or necessary, in order to ensure the best possible security when approving actions.

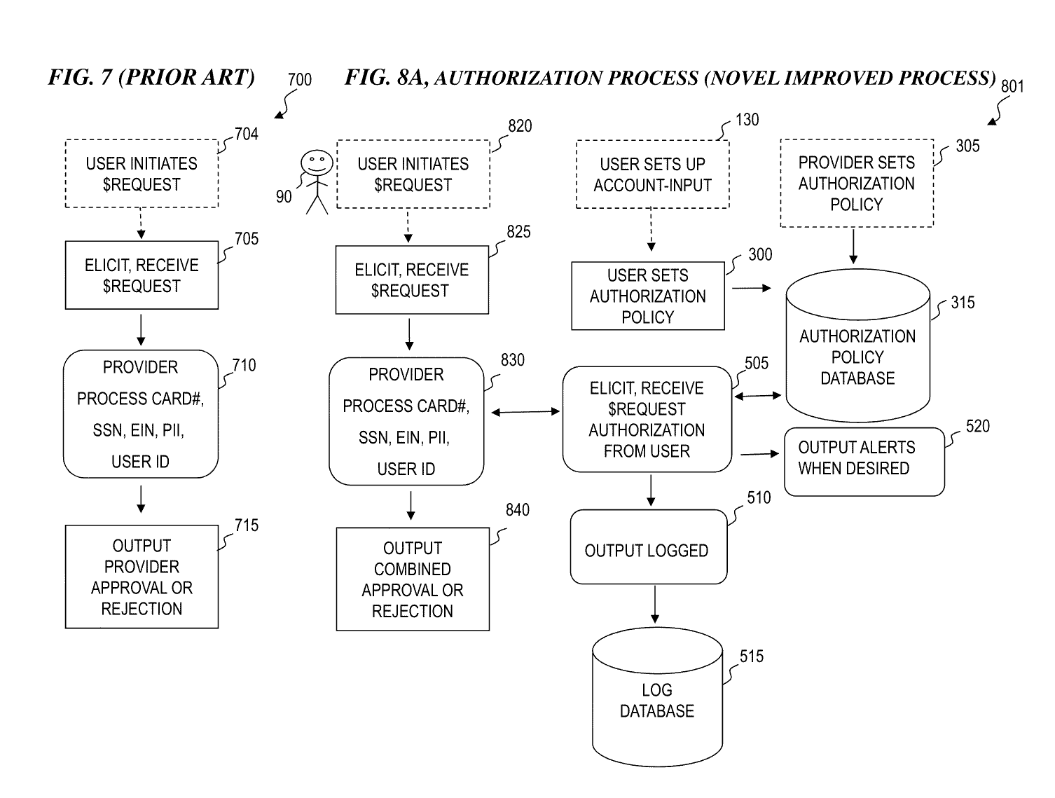

FIG. 7 is a block diagram of a software process 700, which is one example of a conventional prior-art process. A user 90 initiates a request 704. Examples of the requested transaction may include making a purchase at a merchant and swiping a credit card in a credit-card-reader device. A second example could be leasing an apartment that requires a credit check. A third example could be withdrawing money at a bank. In some embodiments, the request is received at block 705. In the first example, the credit-card-reader device at the merchant receives the request. In the second example, the landlord's computer receives the application. In the third example, the bank teller's computer terminal receives the request. The request is then processed 710 by the provider. In the three examples, the requests are processed by the credit-card network, the credit bureau and the bank respectively. In the first example, the PII used is name, credit-card number and expiration date. In the second example, the PII used is name, date of birth and social security number. In the third example, it is name and bank account number. In all cases, a response is received back at the computer system of the provider 150. In the first example, the credit-card transaction is approved or declined once the issuing bank checks whether the user's account contains the needed funds. In the second example, the credit bureaus may deliver a credit report to the landlord's computer that is used to determine whether or not the landlord should lease the apartment. In the third example, a bank will determine if funds are available for withdrawal and indicate that on the teller's computer terminal. The only example that has any substantial security today is the bank withdrawal. A bank will typically require a photo ID and PIN number before they release funds. A credit check and credit-card transaction are not secured, as all one needs is PII to carry out the request.

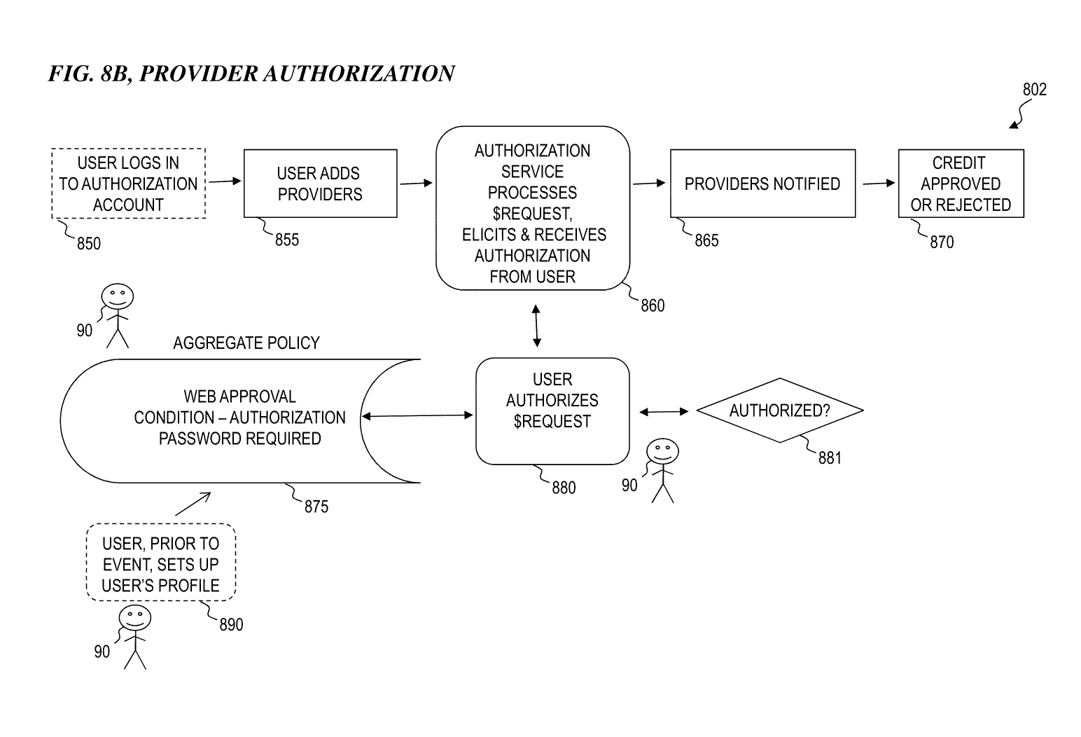

FIG. 8A is a block diagram of a software authorization process 801, according to some embodiments of the present invention. In some embodiments of process 801, a user initiates 820 the request in response to the software eliciting and receiving 825 the request (for example, in a checkout line at a retail store, the user would scan a plurality of purchases at a self-checkout line or have a store clerk do so, and the system that receives payment elicits (displays a message for the user to use a credit card or other form of payment) and receives (reads data from the user's credit card) the transaction request (i.e., the user's indication that they want to make the purchase using this form of payment). In some embodiments, process 801 starts in the same manner as in conventional process 700. The request is received 825 by the computer system and the request is processed 830. The major difference in process 801 is that when the request is processed, the provider's computer system adds a step (eliciting and receiving 505 of an authorization) to authorize the request directly with the user. As a first example embodiment, the credit-card network “asks” for approval from the user (e.g., by an app on the user's smart phone alerting the user of the pending transaction and eliciting a response from the user as to whether the user authorizes or does not authorize the transaction). As a second example, the credit bureau asks for approval from the user. As a third example, the user's bank asks the user for approval.

In addition to asking for a response, the authorization service 120 will log the request and may alert if the user would like.

FIG. 8B is a block diagram of an provider-authorization-process 802, according to some embodiments of the present invention. In some embodiments, process 802, is used by the authorization service 120 (see FIG. 1A and FIG. 3B) to approve requests initiated by the provider.

As a first example, a user 90 has previously setup 890 her profile 875 to require web or mobile approval when adding providers. The approval has a condition that requires the user to enter in the accounts authorization password. In some embodiments, the authorization service 120 acting as the provider for the service may set provider policy governing this action.

The user would like to add in 855 a few providers, for example: one credit card, a plurality of Credit Bureaus and the United States IRS.

The user logs in 850 to the authorization account using the account password. The user proceeds to add 855 a MasterCard® card within her profile. She clicks on the “add provider” button and selects Credit Card, MasterCard®. The First, Middle and Last name of the user prepopulate and the user 90 enters the last four digits on the card. The user 90 confirms whether the full middle name is printed on the card or just the middle initial. The user 90 confirms and is prompted to input her authorization password.

Once complete, the authorization service 860 (e.g., such as 120 of FIG. 1A) notifies 865 the MasterCard® organization of the user's intent to authorize credit card transactions. The service provides the name, last four and expiration date to MasterCard® along with an account reference that can be used when making requests to the authorization service. MasterCard® has done a special integration allowing it to replicate the card security code stored in the user's profile and any associated conditions so it can verify the code without making a request to the network.

As a second example, the user 90 also adds 855 the plurality of credit bureaus as providers within her profile. When adding credit verification, the authorization service 860 asks if the user would like to authorize the three credit bureaus to make requests to the service. The user confirms 880 and inputs her authorization password, allowing the authorization 881 based on profile information 875. The service notifies 865 the credit bureaus of the user's intention to authorize any applicable credit requests on her behalf. The service provides the credit bureaus with her name, DOB and last four of the SSN. The credit bureaus each create a record within their systems that notes the user would like to authorize requests. In some embodiments, approval-for-credit inquiries by the user will permit all three credit bureaus to respond to the same request with the credit approval 870.

As a third example, the user 90 would like to add 855 the IRS as a provider. Once selected, the authorization service 860 asks for the authorization password and informs the IRS of the user's preference to authorize requests. The IRS is provided 865 the full name, DOB and last four of the SSN.

In a fourth example, the user adds 855 her employer as a provider. In some embodiments, this will be used for multi-factor authentication at her employer as well as external verification of employment. The user adds the employer ID and authorizes the service to provide name, DOB and last four digits of social security number to the employer. The employer, using its entity authorization account, approves adding the employee as a user.

Often times, external accounts that are setup by employers do not always get disabled. When authorized by the employer as the entity user, they may query employment status occasionally. That way, when an employee is separated, access to external systems may be terminated without the need for the employer to explicitly remove access. The act of the employer withdrawing itself as a provider will be enough to do so.

In some embodiments, entities may authorize individuals to act on behalf of the entity. They may configure role-based access and assign users to be authorized to approve actions on behalf of the entity. Providers, in some embodiments, can request approval, and the authorization service 120 (private or public, in some embodiments) can route the request to the appropriate authority within the organization. In some embodiments, the public service will query the private service and the mapping database will indicate those responsible for the decision.

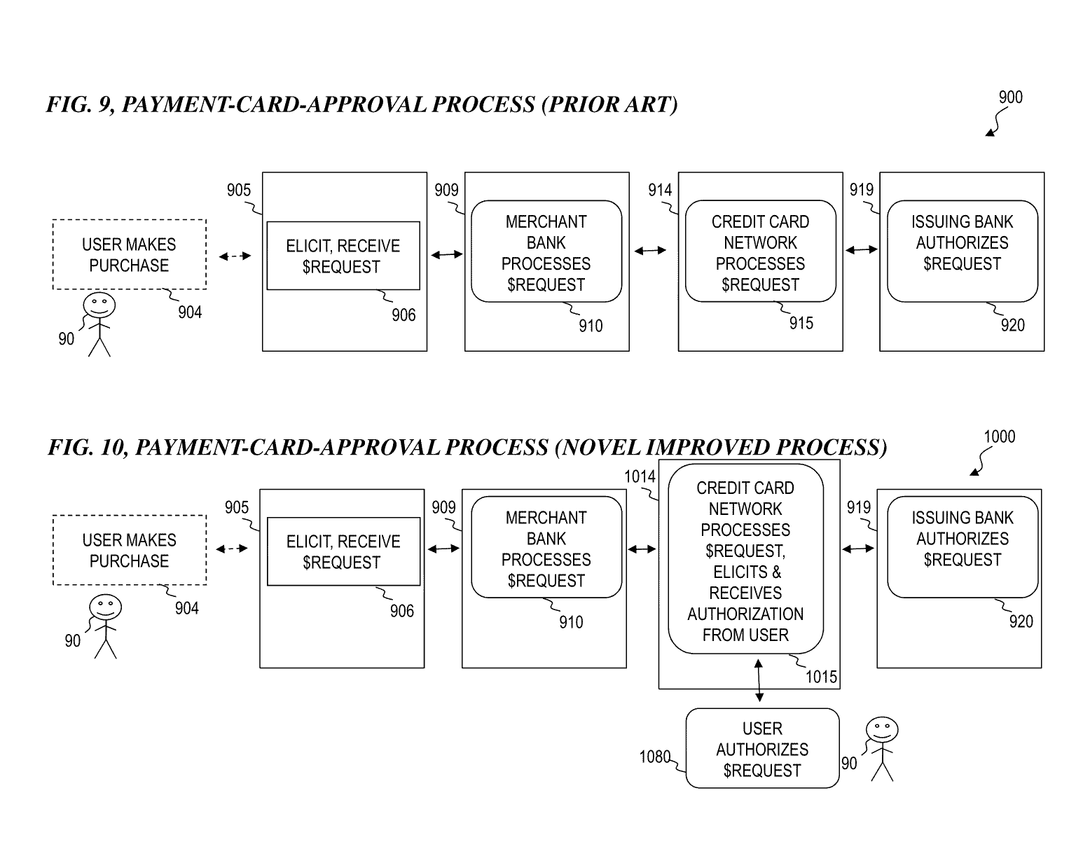

FIG. 9 is a block diagram of a conventional payment-card-approval process 900, used by some prior-art systems, which demonstrates a typical credit-card-approval process. In general, a user initiates a purchase 904. The merchant's computer system 905 elicits and receives 906 the request. The merchant's computer system 905 forwards the request to the merchant's bank's system 909, which processes 910 the request (the merchant's computer system 909 is also known as an acquirer). The merchant's bank's system 909 sends the request to the credit-card network 914, which processes 915 the request, and the credit-card network 914 sends the request on to the issuing bank's computer system 919 for approval 920. The issuing bank's computer system 919 checks the particular user's account to make sure it is active and has funds available. The issuing bank's computer system 919 either approves or declines the transaction, and this approval (or disapproval) is sent back across the same computer systems 914, 909 and 905 to the merchant to indicate whether the transaction went through OK.

The approval process is similar for an open-loop-card network like Visa® or MasterCard®, and a closed-loop provider like American Express® or Discover®. The primary difference is that in a closed-loop network, the cardholder network may fill the role of merchant bank, credit-card network and issuing bank.

One problem with the current system 900 is that the approval process is only concerned with whether the funds are available and whether the account is active. Typical security measures are targeted around keeping the credit-card and bank-account numbers and other information safe. Unfortunately, this will never provide complete protection without including the user in the approval process.

FIG. 10 is a block diagram of a software authorization process 1000, according to some embodiments of the present invention, which demonstrates the new credit-card approval process. In some embodiments, process 1000 starts in the same manner as in conventional process 900, but in process 1000 the card network 1014 adds the additional step of asking 1015 the user 90 for approval for the transaction. Once the user 90 authorizes the request 1080 and the issuing bank's computer system 919 approves 920, the transaction can go forward.

This process does not require new hardware to be implemented. It only requires integration from the existing credit-card network. In some embodiments, the integration could be completed elsewhere in the process as well, but often the most effective location is the credit-card network because it requires a single integration as opposed to hundreds or thousands.

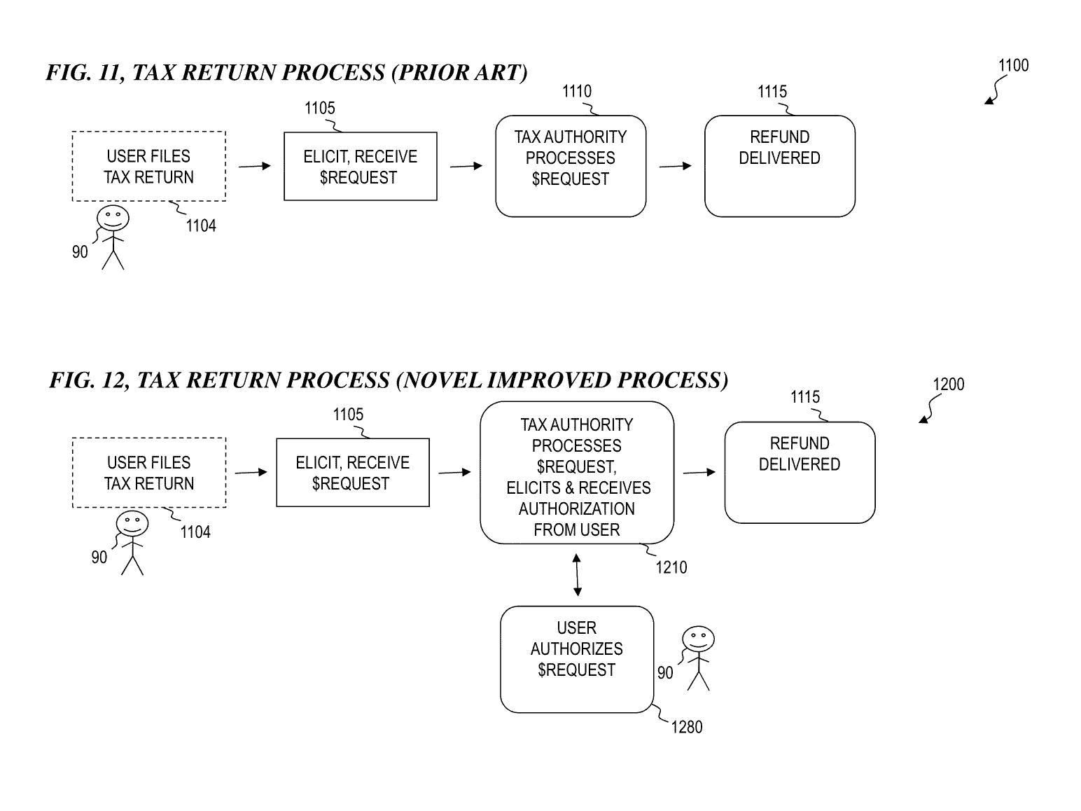

FIG. 11 is a block diagram of a prior-art tax-return-submission process 1100. FIG. 11 demonstrates a typical tax-return process. The user 90 or tax return professional files the return 1104. The return's request (e.g., for a refund of taxes overpaid) is received 1105 and then processed 1110 by the tax authority. Once the tax authority approves the request, it deposits 1115 funds in the account used.

The issue with this process is the same—that there is insufficient verification of the authenticity of the return. Merely the SSN or NIN is used to verify the identity of the individuals filing the return. It is easy to see that if that number is compromised, a person with malicious intent could use it to file for a fraudulent tax return before the true user has done so, and illegally obtain a refund payment.

FIG. 12 is a block diagram of an improved tax-return-submission process 1200, according to some embodiments of the present invention. In some embodiments, the tax return process will be largely the same, but process 1200 has an additional step of eliciting and receiving 1210 an indication authorizing the request 1280 from the user 90 or PII owners.

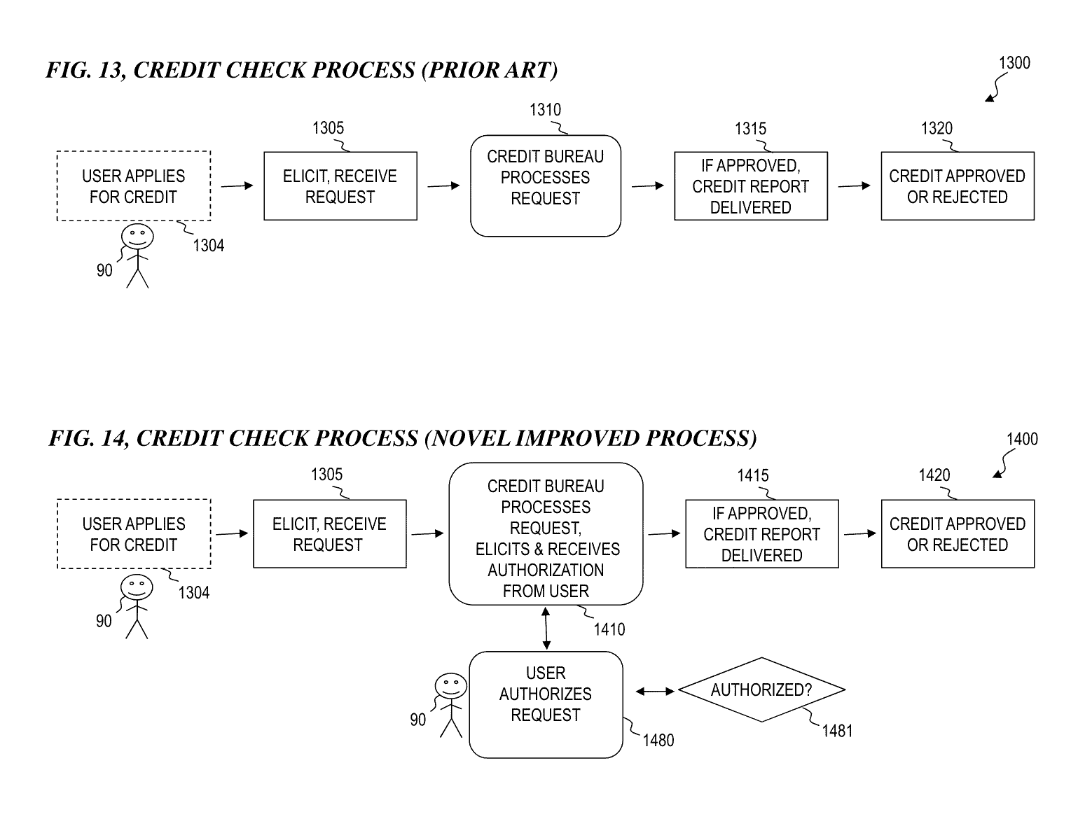

FIG. 13 is a block diagram of a prior-art credit-check process 1300. Typically, a user applies 1304 for credit and provides their PII; the process 1300 elicits and receives 1305 PII that may include a name, date of birth and SSN or EIN. The received credit request is sent to one or more credit bureaus for processing 1310. Once the credit reports are delivered 1315, their credit reports are reviewed and their request is either accepted or rejected 1320.

FIG. 14 is a block diagram of an improved credit-check process 1400, according to some embodiments of the present invention. In some embodiments, a user 90 applies for credit 1304; the request is elicited and received 1305 (typically by a secured internet-connected communication system) and sent to one or more credit bureaus for processing 1410. The credit bureaus will elicit and receive 1410 an authorization 1481 for the request from the PII owner 90, wherein one of the user's mobile devices 110 will indicate the request to the user 90 and elicit and receive 1480 an indication from the user (e.g., a press of a button or a voice response or the like) of approval or rejection. The credit bureaus will not be permitted to comply with delivery 1415 of credit reports (whether those reports approve or reject 1420 the credit) in response to requests that are not authorized by the user 90. In some embodiments, the credit bureaus will all be required to use the same controls in order to deliver a report.

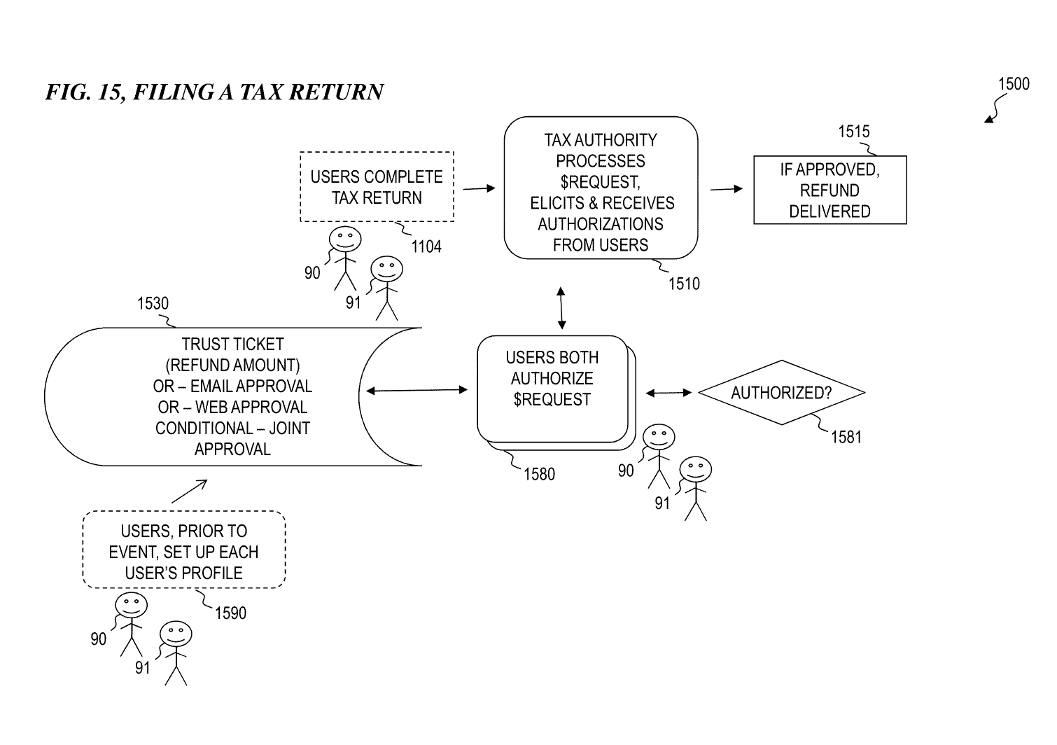

FIG. 15 is a block diagram of an improved tax-return-submission process 1500, according to some embodiments of the present invention, which demonstrates two individuals jointly filing 1104 a tax return who is using the authorization service 1510 (such as 120 of FIG. 1A). In this case, the tax authority has set a policy 1530 that requires, at a minimum, the use of a trust ticket with a condition that the trust ticket matches the refund amount on their return. The tax authority also requires approval from both users 90 and 91 who filed the return. The users have decided to add e-mail and web approval as options for this kind of request.

Once submitted, the tax authority processes 1210 the request. After the tax return is approved, the tax authority will request approval 1581 from the authorization service, which obtains it from processes 1580 running on the devices 110 of each of users 90 and 91. If the users 90 and 91 each entered a trust ticket matching the refund value in their authorization account 1530 (previously set up 1590 by the users 90 and 91), the return is automatically approved and the funds deposited 1515. Otherwise, they will receive an auto-generated e-mail to their registered e-mail account that they can use to approve. In addition, they can log in to the authorization website and approve. In some embodiments, the tax authority will submit the authorization request immediately upon receipt of the filed tax return. This will prevent the tax authority from having to process fraudulent requests.

To summarize the difference, a person filing a fraudulent tax return would have to not just compromise personal information, but also the authorization account. In this example, two of them. Making the assumption that a fraudster may target individual filers, it would still be extremely difficult to be successful here and a user could choose to add an out-of-band authentication factor such as a mobile confirmation making it virtually impossible to file a fraudulent return. Additionally, if a user's authorization account was compromised, they would still be aware of the fraudulent return and would be able to inform the tax authority that it was fraud very quickly. Users have the ability to add additional authentication factors as well that would make a compromise not only difficult, but nearly impossible, even when the authorization account password is compromised.

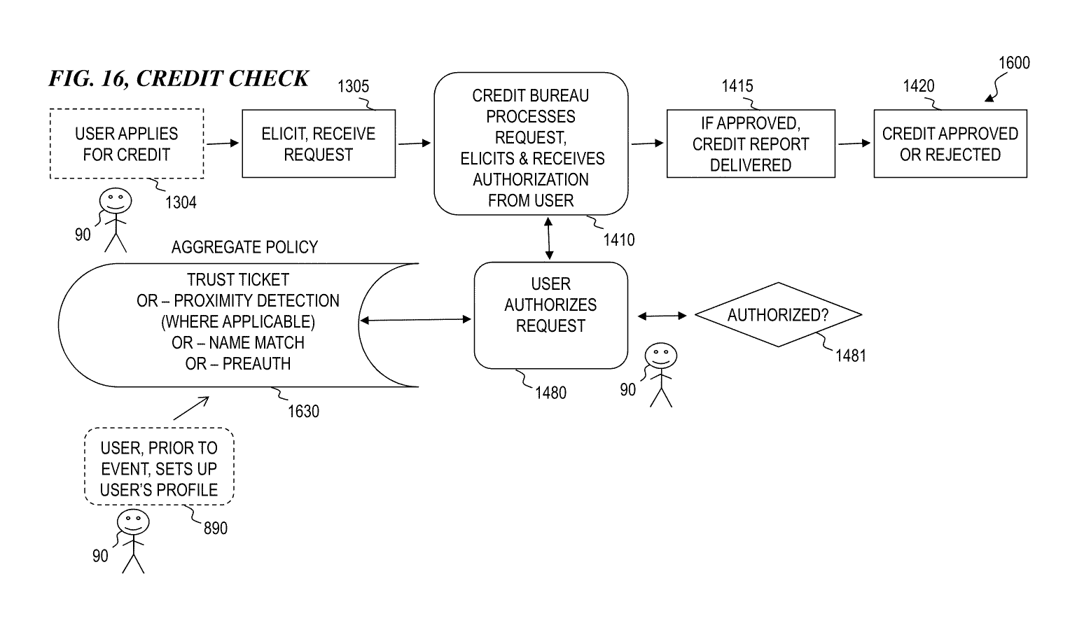

FIG. 16 is a block diagram of an improved credit-check process 1600, according to some embodiments of the present invention, which demonstrates a credit check using the authorization service. A user applies for credit. The request is received and eventually processed by one or multiple credit bureaus. The credit bureau's request authorization from the user. In this case, the user as enabled a trust ticket, proximity detection, name match or preauthorization as their authentication factors. In this case, only one of the authentication factors is required.

For Figures in the description and drawings having boxes that show reference numbers, like-numbered boxes in earlier figures having the same numbers perform the same function, and are not repeatedly described in order to make reading the present description easier and clearer. For Figures in the description and drawing having boxes that do not explicitly show reference numbers, like-described boxes in earlier figures having the same or similar labels perform the same function.

If a user 90 is applying for a car loan and the proximity service detects that they are at the dealership, the credit check is approved and logged in the account. Alternatively, they use a trust ticket that is either manually entered in or dynamically generated. The trust ticket is written on the form when applying. They may also decide to simply go in and preauthorize the next credit check or enter a name or partial name of the creditor who will be performing the credit check.

It is important to reiterate that the user will be able to use whatever method they are comfortable with and any one of them will make it nearly impossible to compromise their credit. Additionally, even if the user decides to log and alert only, they will be made aware of credit inquiries and be able to react before damage is done. In some embodiments, requests from multiple credit bureaus are allowed when the request is approved. As an example, if a user pre-approves a request for a specific creditor and three credit bureaus submit authorization requests, all three may be approved.

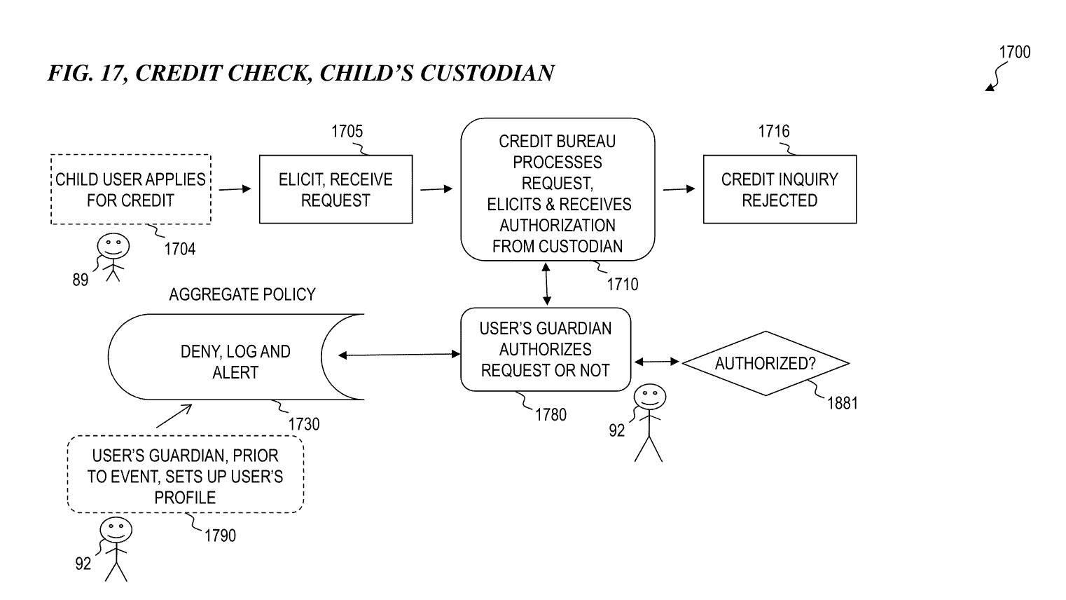

FIG. 17 is a block diagram of an improved credit-check process 1700 for a child's custodian 92, according to some embodiments of the present invention, which shows a credit check involving a child 89. Compromising a child's social security number and opening accounts often goes undetected for a long period of time. In this example, the fraudster applies for credit. The credit request is received 1705 and processed 1710 by the credit bureaus. The authorization service (such as 120 of FIG. 1A) elicits and receives 1710 a response from the child's guardian 92, and if the guardian 92 does not recognize and approve 1781, the credit bureau denies 1716 the credit report and optionally alerts the child-owner of the PII attempted breach. In this case, the parent 92 has assumed control of the child's authorization account 1730 until the child 89 is old enough to use it. The credit bureaus have denied all requests and prevented the child's identity from ever being compromised. In some embodiments, the credit bureaus could add an out-of-band approval such as a mobile confirmation from both parents (e.g., 92 and 91) in order to change the account policy. At a minimum, this would mean that the child's PII would have to be compromised along with both parents' accounts. The fraudster would also have to gain access to both patents' mobile devices in order to complete the fraud.

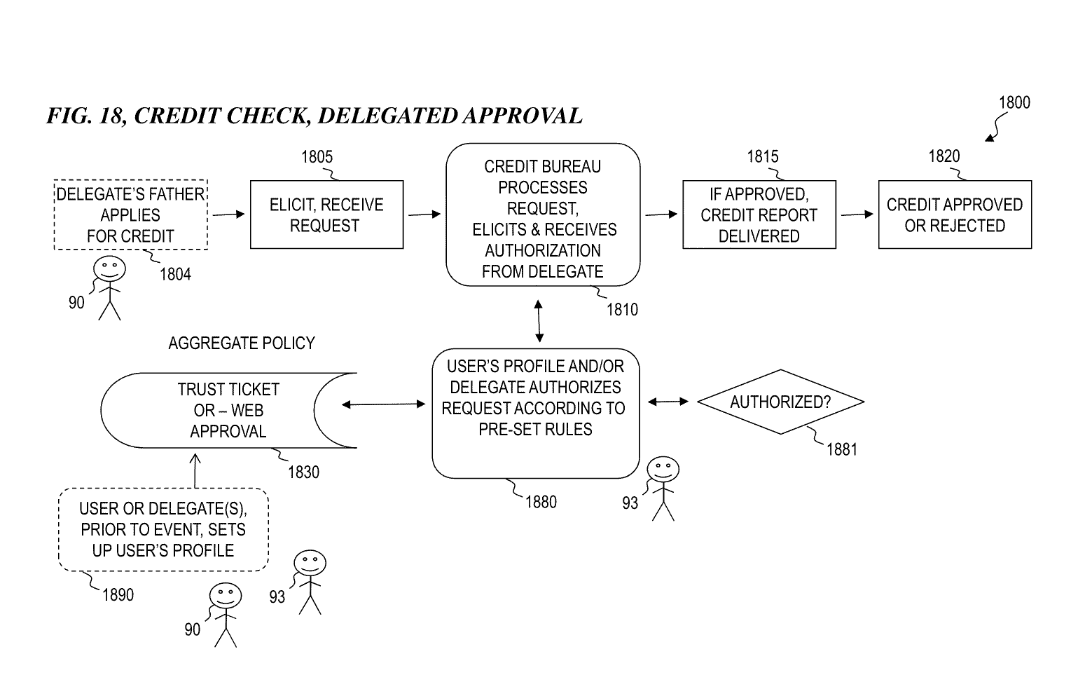

FIG. 18 is a block diagram of an improved credit-check process 1800 for a person 90 who has delegated responsibility for the authorization interaction to an agent 93, which shows a credit check with a delegated approval, according to some embodiments of the present invention. In this example, a user's elderly father 90 does not want to deal with this new fangled technology and has delegated the responsibility to his daughter 93 and authorized 1890 the authorization-policy process 302 (see FIG. 3B) to have his daughter 93 approve requests on his behalf. In this example, when the father 90 applies 1804 for credit in response to the system eliciting and receiving 1805 the request, the system will process the request and elicit and receive authorization from the users delegate 93, and he (the user 90) will have to either enter 1890 a pre-defined trust ticket 1830 or ask the daughter 93 to approve it 1880 via an authorization 1881 within the authorization service 120 (see FIG. 1A).

In some embodiments, the daughter 93 will optionally create a policy 1830 that is as low-touch (easy-to-use) as possible so for activities such as payment-card purchases, she (delegate 93) may want to set purchase (dollar-amount) limits and the geographical area (e.g., within one or more states of the United States) in which he (user 90) will be doing business. This will allow the father to continue to function as he has previously, while not worrying about being taken advantage of. She may also want to provide him with a specialized GPS device 115 (see FIG. 1) that he just needs to keep with him.

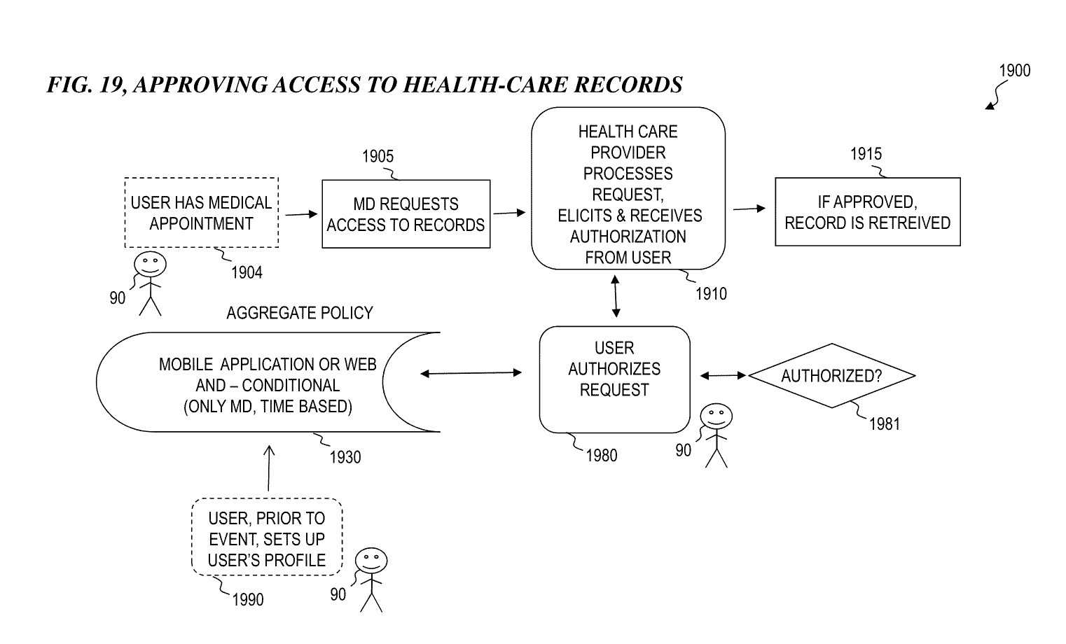

FIG. 19 is a block diagram of a software process 1900 for approving access to health-care records for a user 90 who has a medical appointment, according to some embodiments of the present invention. In some embodiments, the medical doctor requests access (in response to eliciting and receiving 1905 by the computer system) to medical records. The healthcare provider processes 1910 the request and sends an authorization request to the authorization-service process 302 (see FIG. 3B) of the present invention (via process 1910 eliciting and receiving the authorization or denial thereof). The user 90 has decided to require (via setting up 1990 the user's policy 1930) approval within a mobile application or directly on the authorization website. The user 90 approves 1980 the request and additionally specifies 1981 that the record should only be access by the M.D. (or other authorized health professional) and only for a specific period of time.

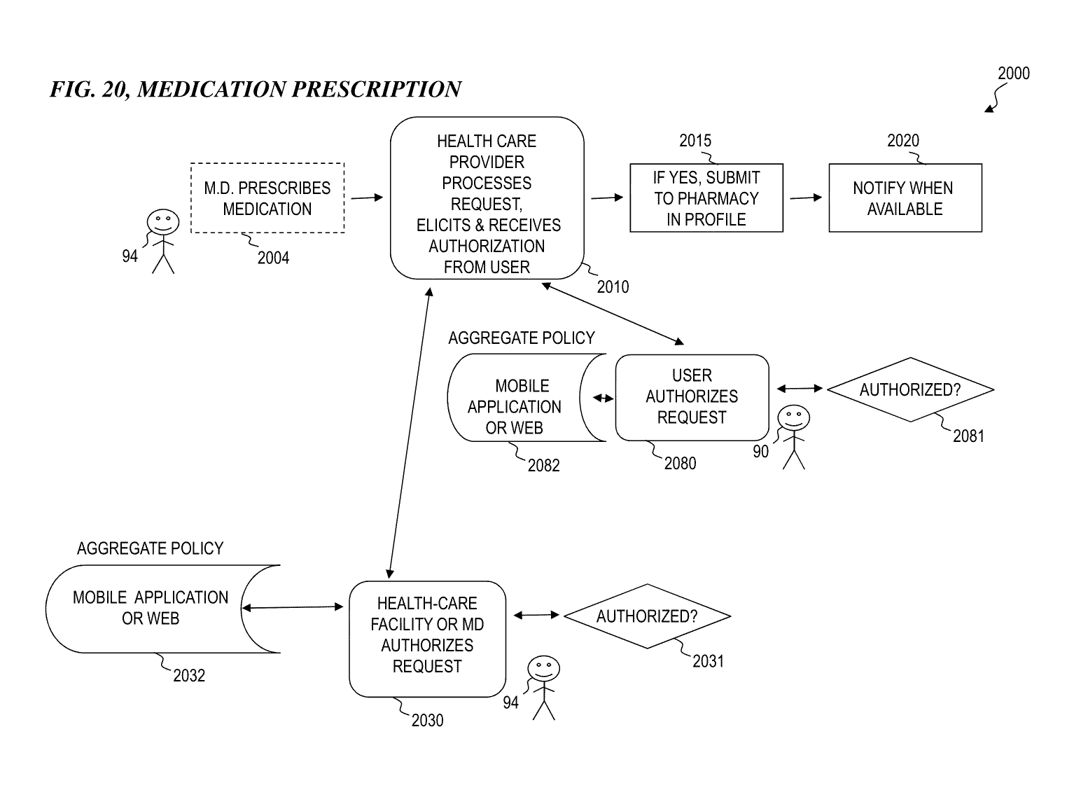

FIG. 20 is a block diagram of an improved prescription-medication-access process 2000, according to some embodiments of the present invention, which demonstrates a prescription 2004 given to the user 90. The health care provider 94 prescribes 2004 and forwards the approval request to the authorization-service process 2010 (such as service 120—see FIG. 1A and FIG. 3B) of the present invention. In some embodiments, authorization-service process 2010 elicits and receives authorization both from process 2030 (which obtains authorization 2031 from the provider 94 and/or from a preauthorized policy 2032), and from process 2080 (which obtains authorization 2081 from the user 90 and/or from a preauthorized policy 2082). The user 90 either uses his mobile application or website to approve 2081 the request. The user 90 has indicated his preferred pharmacy in the account profile 2082 and the prescription is automatically sent 2015 to the pharmacy when ready, and the system notifies 2020 the user 90 when the prescription is ready.

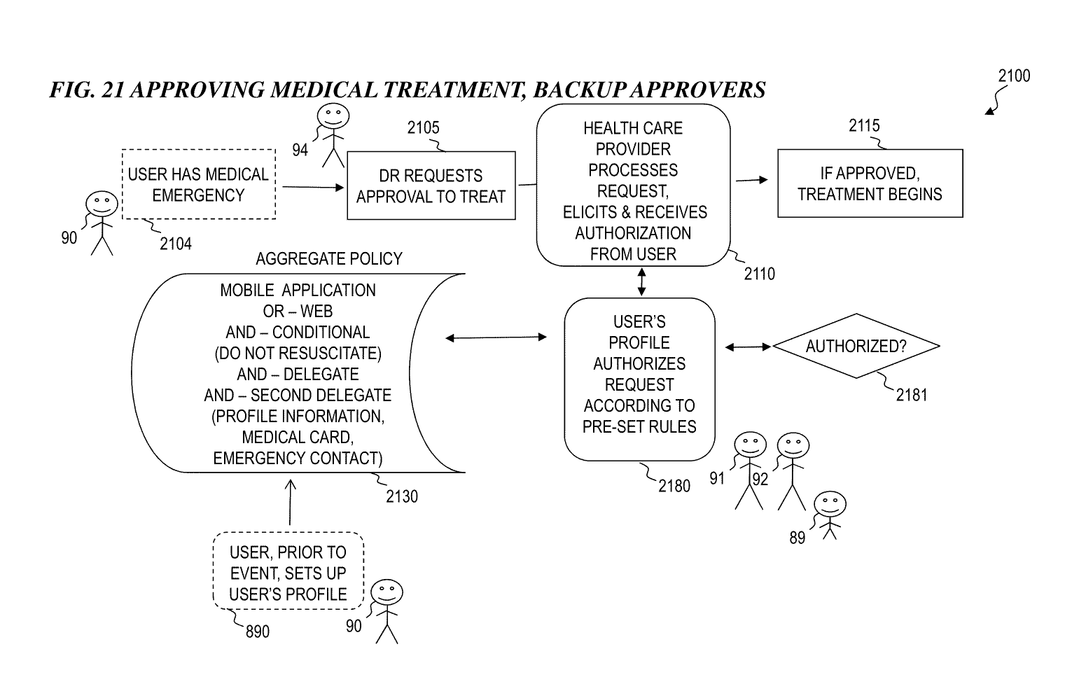

FIG. 21 is a block diagram of an improved health-care-advanced-directive process 2100, according to some embodiments of the present invention, which demonstrates the system handling a user 90 who is having 2104 a medical emergency. The doctor 94 requests 2105 approval from system process 2110 to perform the life-saving treatment 2115. The user 90 has previously decided to use their mobile application or website to approve, and has set up 890 their profile 2130. The user 90 has added a condition that indicates they would not like to be resuscitated. In addition, the user 90 has added a second approver 91 and third approver 92 that can approve in the event the user 90 is incapacitated. This user's profile 2130 provides a quick and easy way for the healthcare provider 94 to get in touch via process 2180 with the family 91, 92, and 89 for an authorization 2181. This specific integration (in policy 2130) could include feedback of emergency contact numbers. In some embodiments, the present invention is also used to store a medical card (or equivalent dataset in policy 2130) containing information about any allergies the user 90 may have or organ-donor directives.

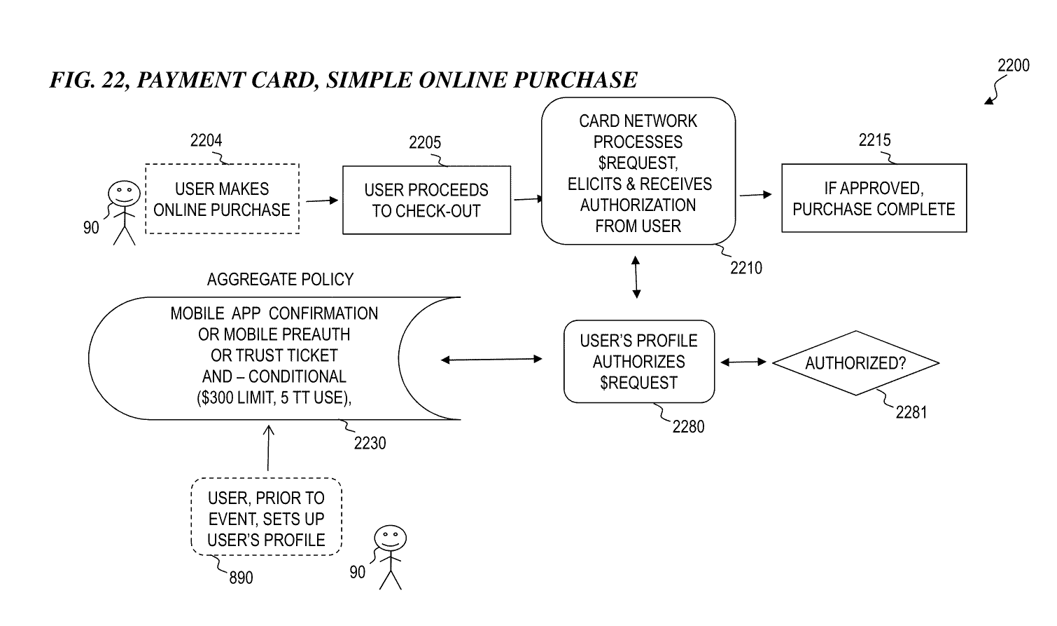

FIG. 22 is a block diagram of an improved payment-card-purchase process 2200, according to some embodiments of the present invention, which demonstrates a user making a simple online purchase. The user 90 is making 2204 an online purchase from a website that has elicited and received 2205 the order for goods and proceeded to checkout. Process 2210 processes the order and elicits and received 2210 an authorization 2281 from user 90 (via an app 2280 on a device 110 of user 90) in order to complete 2215 the purchase. In this example, the user 90 has set up 890 their profile 2230 to require mobile-app confirmation (via process 2280 providing an elicited and received response 2281 on a device 110 of user 90), or mobile preauthorization or a trust ticket. The user 90 has also added a condition to profile 2230 for online transactions that they should never exceed $300. The provider 150 approached for this particular transaction has previously decided and placed into profile 2230 that trust tickets used in this manner can only be used five (5) times since the trust tickets are only semi-private.

The user 90 could decide to simply open his app and preauthorize via policy 2230. The user 90 could enter a manual or dynamic trust ticket at check out. The user 90 could also simply have his app ready for mobile confirmation. In order for mobile app confirmations to be supported, time-outs may need to be adjusted in profile 2230.

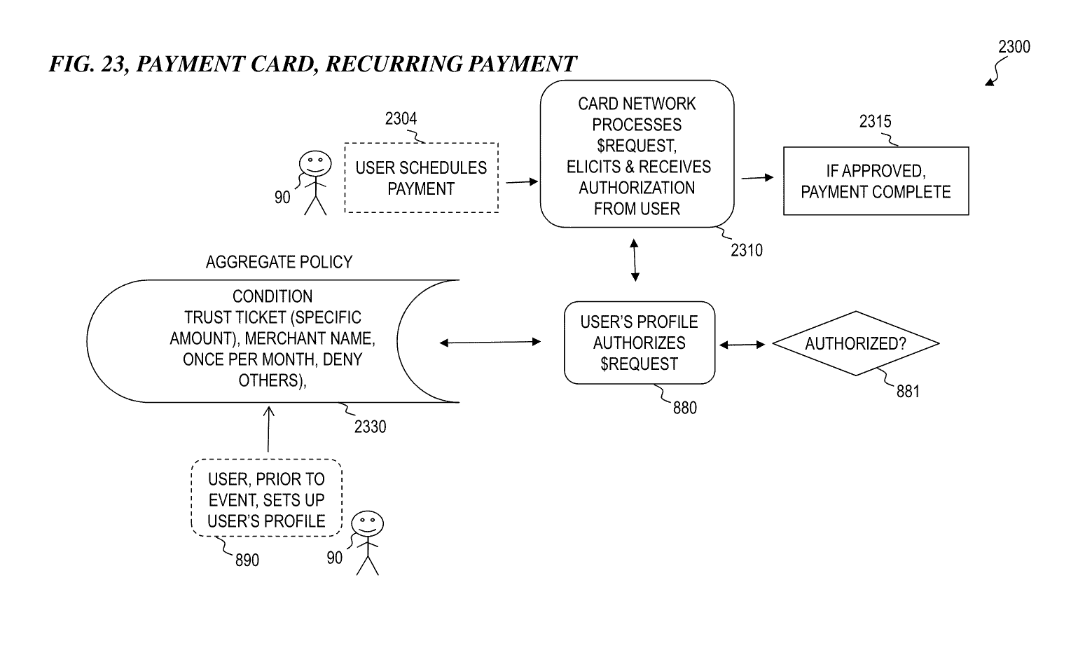

FIG. 23 is a block diagram of an improved payment-card-recurring-purchase process 2300, according to some embodiments of the present invention, which demonstrates a recurring payment using a credit card. The user 90 schedules 2304 a payment that is processed 2310 once per month. The user 90 previously created 890 a trust ticket in policy 2330 with the specific amount of the transaction. The user 90 also enters in the merchant's name as a condition and indicates that this merchant can transact the payment 2315 once per month. The merchant will not be approved for other transactions.

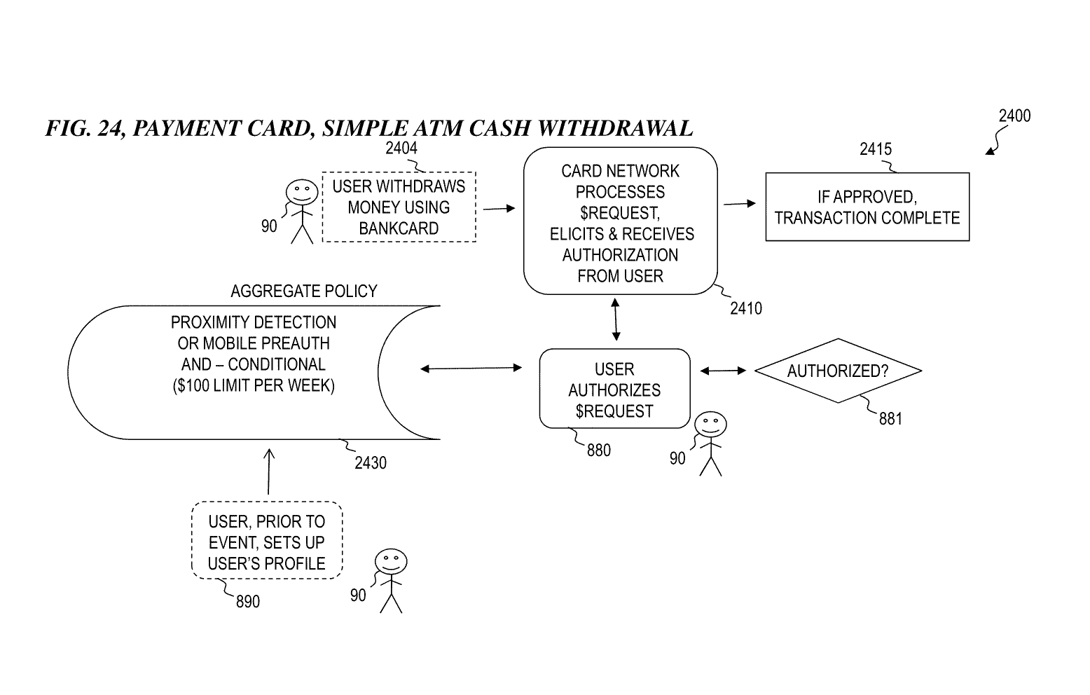

FIG. 24 is a block diagram of an improved payment-card-ATM-access process 2400, according to some embodiments of the present invention, which demonstrates a simple ATM withdrawal. The user 90 has decided that they would like to use mobile preauthorization or proximity detection and previously entered 890 this condition into policy 2430. Since, in some embodiments, the system of the present invention is tracking ATM locations along with user locations, the system 2410 is able to determine that the user 90 is next to the particular ATM when he/she (or some fraudster) attempts to withdraw money. The authorized user 90 will enter his/her PIN like normal. This allows the bank to participate without modifying their application. The bank will report ATM coordinates to the authorization-service process 2410 (e.g., such as authorization service 120 (see FIG. 1A and FIG. 3B) of the present invention and the authorization-service process 2410 will verify the proximity of user 90 to the particular ATM unit. Alternatively, the user 90 will access his/her mobile app and preauthorize while he/she is walking to the ATM. The system, once the user 90 or the previously set up policy 2430 has provided the required authorization 881, will complete 2415 the transaction.

In order to compromise this account, the fraudster would need to gain access to the user's mobile phone as well as their cash card and PIN. The user has limited withdrawals to $100 USD per week, so a compromise can only result in a maximum of $100 per week being improperly withdrawn.

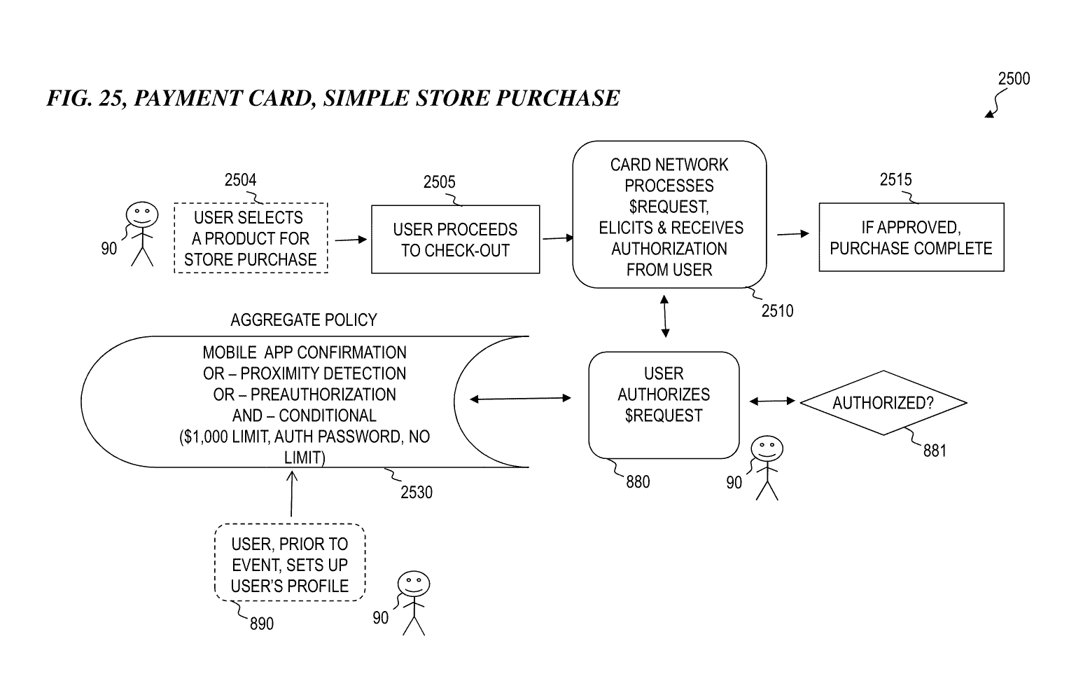

FIG. 25 is a block diagram of an improved payment-card-simple-purchase process 2500, according to some embodiments of the present invention, which demonstrates a simple store purchase. The user 90 selects 2504 a product and proceeds to the check-out line and initiates 2504 the purchase of the product. The card network processes 2510 the request and uses the authorization-service process 120 (see FIG. 1A and FIG. 3B) of the present invention. The user 90 has set up 890 the policy 2530 to require proximity detection, mobile-app confirmation or preauthorization. The user 90 has also set a $1,000 limit on these types of transactions into policy 2530. With an authorization password, the transaction amount can go to the maximum allowed by the issuing bank. In some embodiments, the user 90 has the option of using a manual proximity option along with the preauthorization. As an example, assume the user 90 does not want tracking on permanently. When the user 90 is in the store, they could open their app, allow it to use their location and let the app determine the merchant. They could then allow process 880 to provide a preauthorization 881 from that merchant to complete 2515 the transaction.

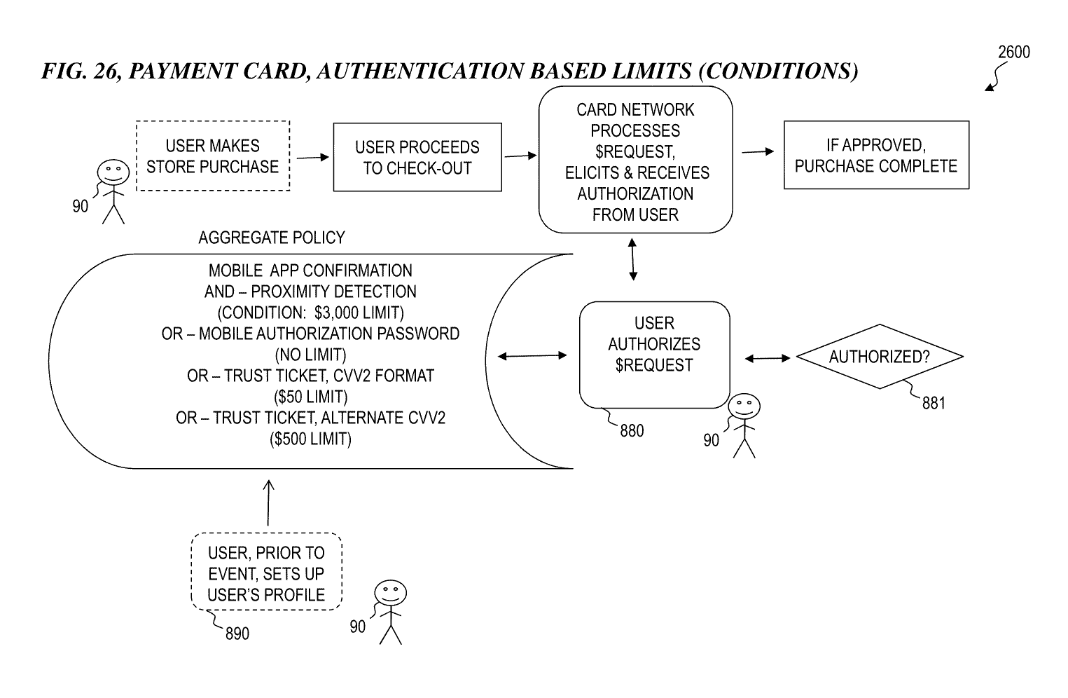

FIG. 26 is a block diagram of an improved payment-card-purchase-limits process 2600, according to some embodiments of the present invention, which demonstrates a payment card transaction with authentication factor based limits. This user has decided that if they are near the store and confirm the transaction with their mobile phone, their purchase limit is $3,000. If they authorize the transaction by using their authorization password, there is no limit. In the event that they do not have their mobile device, they have decided to honor the existing CVV2 on the back of the card and limit that transaction to $50. They have also created a second CVV2 like value that has a $500 limit. This will allow current systems to process the CVV2 code like they do today but instead of verifying at the issuing bank, it will be verified at the user's authorization account. The values may also be replicated or cached at the card holder network for verification. In the near future, CVV2 or CSCs will not be necessary. In this example, the store would have to require the entry of CSC on the front-end. In the event that the store does not require CSC, some embodiments include a feedback mechanism for the card network to inform the merchant of the user's desire to enter in the CSC code.

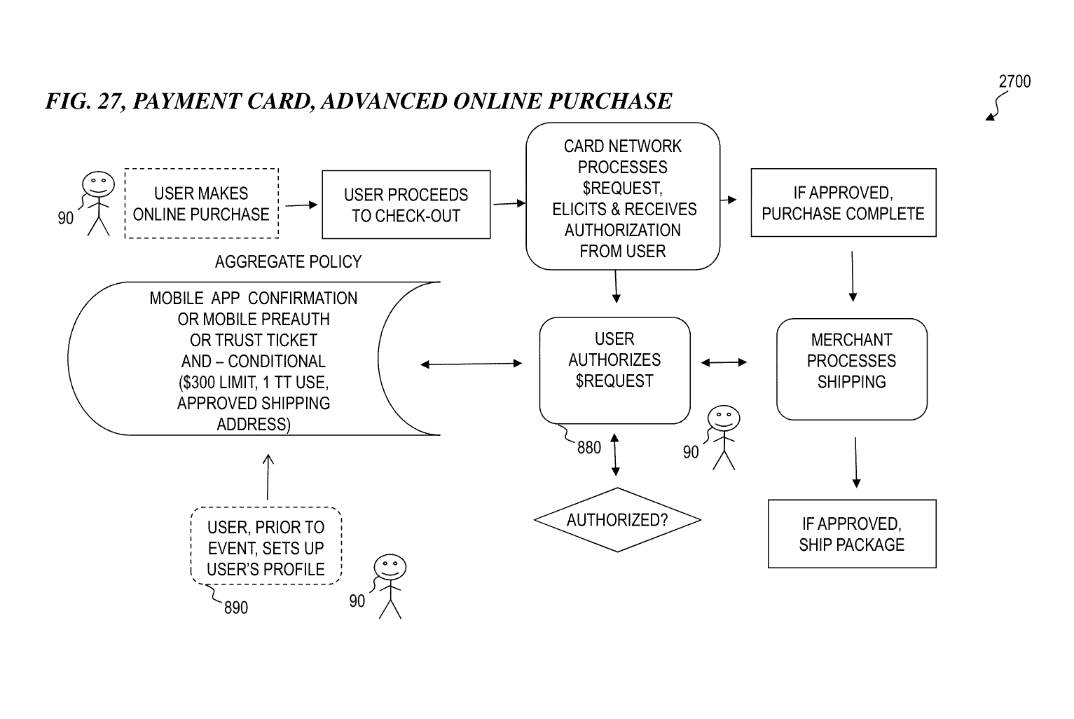

FIG. 27 is a block diagram of an improved payment-card-advanced-online-purchase process 2700, according to some embodiments of the present invention, which shows an advanced online purchase. The user initiates an online purchase and proceeds to check-out. The card network requests authorization. In this example, the user requires mobile app confirmation, mobile preauthorization or a trust ticket. The user is only allowing one trust ticket use. The user has also set a limit of $300 for online purchases. The trust ticket is in the form of the purchase amount and will be automatically deleted when used.

In the advanced example, the merchant has done a simple integration to verify shipping address. The merchant sends a request to the authorization account using the name and last four of the credit card. The user has specified a certified shipping address and any other authorized shipping addresses in his or her authorization account profile. The user has authorized merchants to request validation of certified shipping addresses. This ensures that a participating online merchant will never send the user's package to the wrong address. This functionality could also be built in to the payment card network as opposed to a merchant integration if necessary or desired.

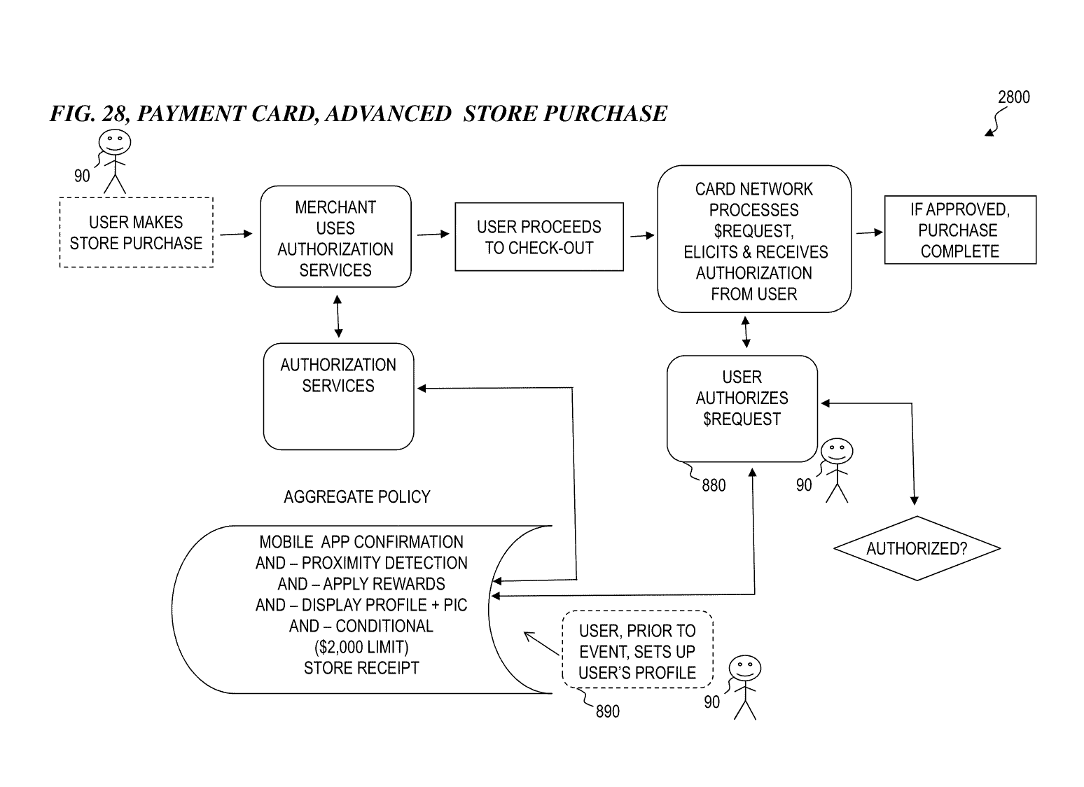

FIG. 28 is a block diagram of an improved payment-card-advanced-store-purchase process 2800, according to some embodiments of the present invention, which demonstrates an advanced store purchase using a payment card. The user initiates an in-store purchase. The merchant reports any static terminal and store locations. The merchant also periodically reports the location of mobile terminals. The merchant integrates with authorization-service process 120 (see FIG. 1A and FIG. 3B) of the present invention to receive location information from users who are reporting they are in the store.

The user proceeds to checkout and the merchant knows that the user is near a register. The user has decided to apply a loyalty card to their profile and that information along with a profile thumbnail that pops on the nearest registers. The employee sees the profile pic (picture) and selects it. The user has saved payment information previously on the merchant's network using the loyalty card. The employee asks if it is OK for them to submit for payment. The user confirms payment on their mobile device.

The user had a limit of $2,000 on their profile for in-store purchases. The merchant stored the receipt automatically in the authorization account.

This transaction happened without even touching a credit-card terminal. As one can probably also see, if the user approved, the merchant could also use the rewards integration along with proximity detection to push advertisements or discounts to the user.

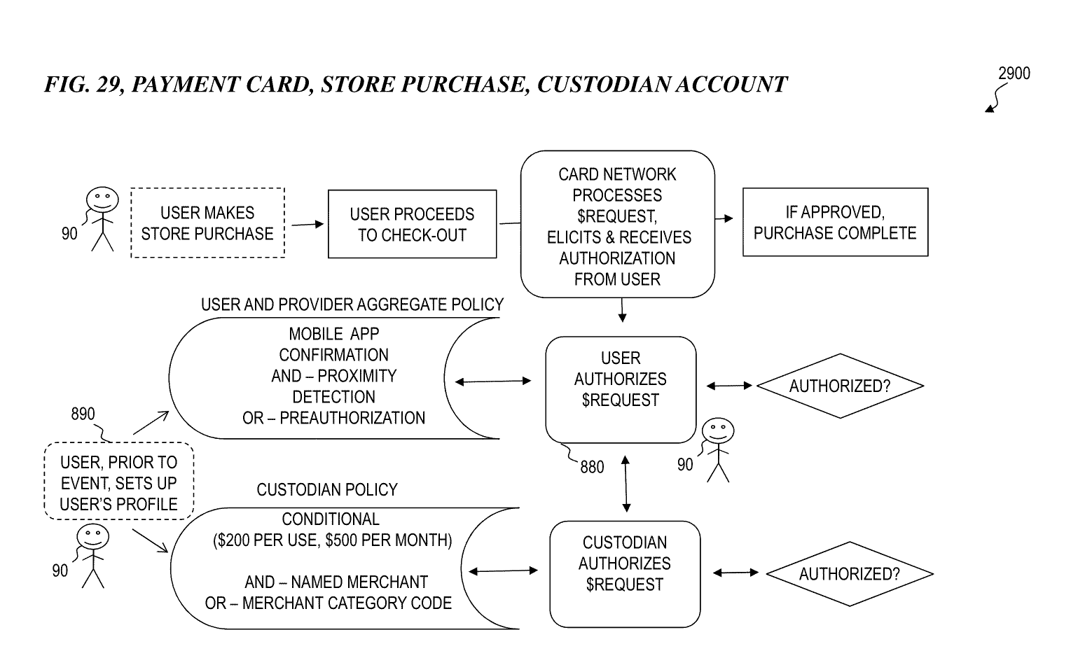

FIG. 29 is a block diagram of an improved payment-card-store-purchase-custodian-account process 2900, according to some embodiments of the present invention, which demonstrates a payment card transaction that is authorized by a custodian. In this example, the custodian purchased a prepaid card or co-signed for a credit card. The user is responsible for authorizing purchases as usual, however, the custodian is able to monitor purchases and set conditions. In this example, the custodian sets a per-use limit of $200 and no more than $500 per month. The custodian also names a few authorized merchants like the school bookstore and the merchant category code (MCC) of 5499 for MISC food.

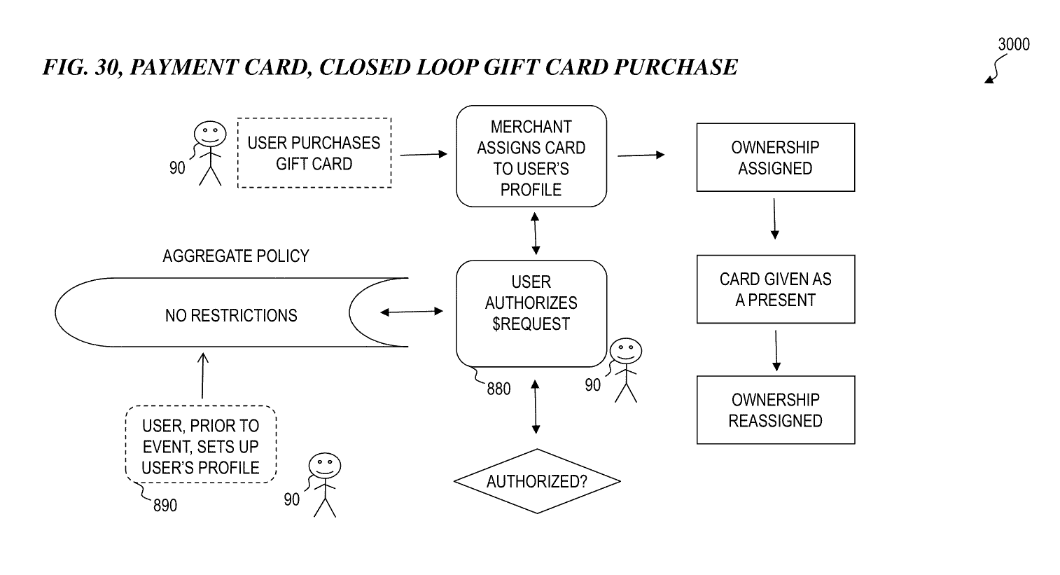

FIG. 30 is a block diagram of an improved gift-card-purchase process 3000, according to some embodiments of the present invention, which demonstrates a purchase of a closed loop gift card. The user purchases the gift card and provides their authorization account number to assign ownership. The user gives the card as a gift and reassigns ownership to the individual within their authorization account. The user could also make the change immediately and specify a date and time the account should be moved so they do not spoil the gift.

The merchant will use the authorization-service process 120 (see FIG. 1A and FIG. 3B) of the present invention to approve purchases and the gift card can only be used with the account owner or other authorized users. It will not be possible to steal the card.

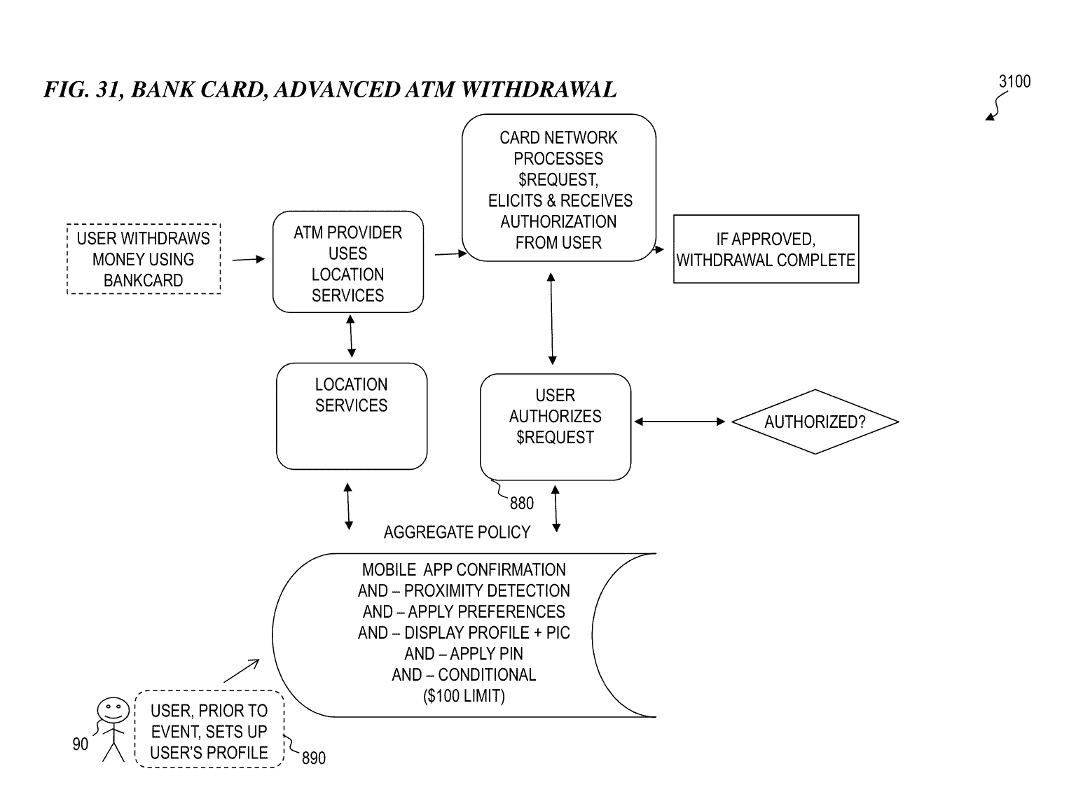

FIG. 31 is a block diagram of an improved bank-card-ATM-withdrawal process 3100, according to some embodiments of the present invention, which demonstrates an advanced ATM withdrawal. The ATM provider is integrated with authorization-service process 120 (see FIG. 1A and FIG. 3B) of the present invention and utilizes proximity services to determine when a user who intends to transact is close to an ATM. In this case, the user has proximity detection on their mobile phone. The user always withdraws $50 so the authorization-service process 120 saves that as a preference. The user opens her mobile application and clicks on the $50 withdrawal. When she is close to the ATM, it pops up a thumbnail picture of her (assuming it is not in use). The user touches the picture and confirms the transaction on the ATM. The user then confirms the transaction on her mobile phone and collects the $50. Of course, the user could use proximity services along with a simple integration with a map application to take her to the nearest ATM. This transaction was completed without the need to swipe a card at the ATM.

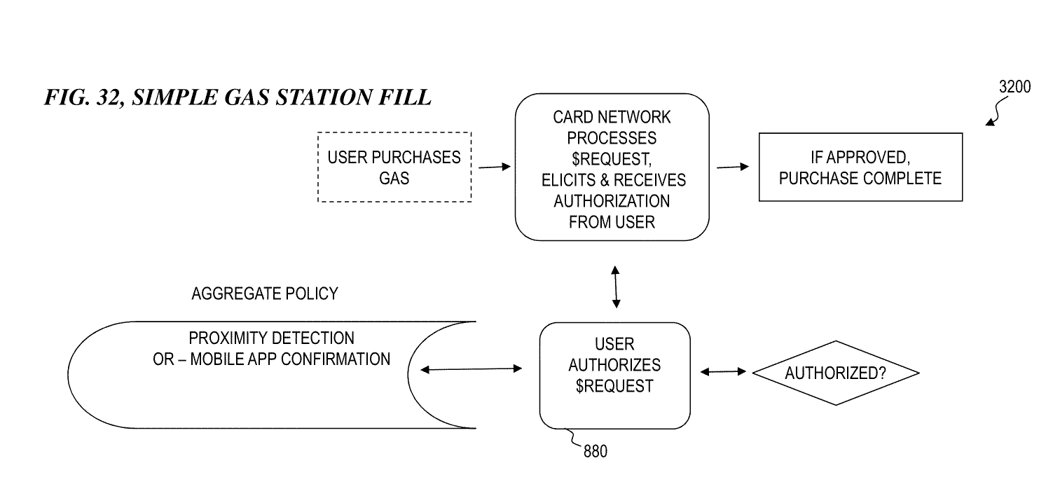

FIG. 32 is a block diagram of an improved payment-card-simple-gasoline-purchase process 3200, according to some embodiments of the present invention, which demonstrates a simple gas station fill. The user purchases gas. The card network processes the request and the authorization-service process 120 (see FIG. 1A and FIG. 3B) of the present invention detects the proximity between the user's mobile phone's GPS location, or their car's GPS location and the location of the pump. If proximity services were not available, the user has decided to have their account allow mobile application confirmation. Often times, gas stations require that the user enter the user's home zip code in at the pump. This security feature is very weak at best. It will also be unnecessary in the future when using the present invention. In this example, the user purchases gas in the normal manner. When the user is confirmed to be near the pump, the transaction is allowed. If the location service cannot determine location or proximity to the pump, the user must confirm the transaction within their mobile application that has access to their authorization account, or by one or more other additional authentication methods.

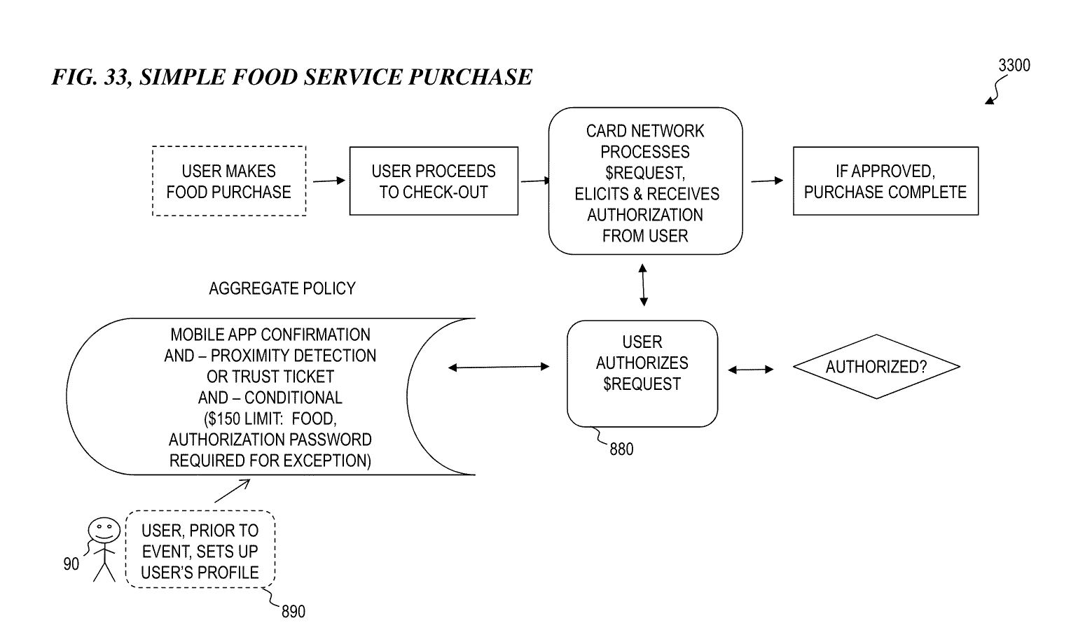

FIG. 33 is a block diagram of an improved payment-card-simple-food-purchase process 3300, according to some embodiments of the present invention, which demonstrates a simple food service purchase. The user makes a purchase and has enabled proximity detection and mobile app confirmation. The user also has configured a limit of $150 for all food purchases. Any food purchase over $150 requires entering the authorization password for approval. In this example, if the user's mobile device is in a different location, the transaction will require entry of a trust ticket. The user has pre-defined a trust ticket of “5Ac” in his profile for this type of situation. The trust ticket will allow for transaction to continue. In some embodiments, during an unsuccessful transaction, the card network will notify the merchant of the failure via its computer system. The card network will use a code that indicates a trust ticket should be entered to confirm identity. The terminal will then ask for the trust ticket and the user can continue his transaction. In this example, the terminal will need to accept an alpha-numeric string but since a trust ticket can be any value, it can also be a numeric value in order to support a terminal that is not capable of an alpha-numeric entry.

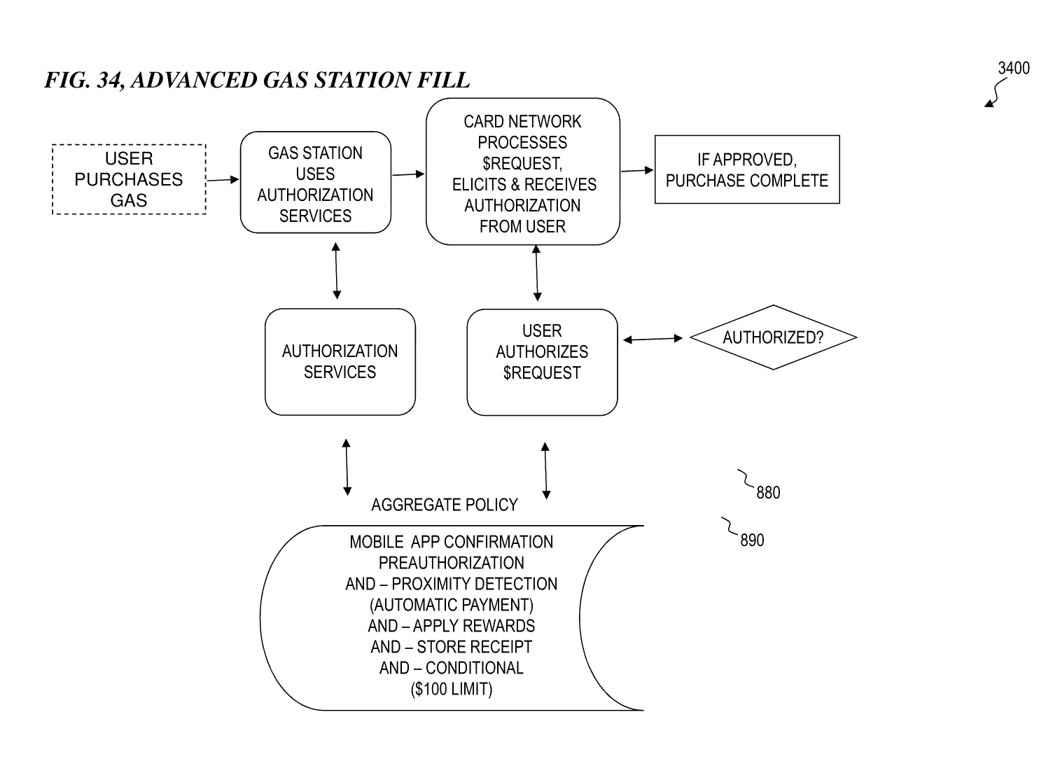

FIG. 34 is a block diagram of an improved payment-card-advanced-gasoline-purchase process 3400, according to some embodiments of the present invention, which demonstrates an advanced gas station fill. The user drives to the gas station. The gas station is using proximity services. The user has a loyalty card with the merchant that is pre-populated with the card information. The user parks his car and opens his app. Proximity services detect the car's location and populate the gas station for a pre-authorization. The user selects the grade and fills the tank. The user then gets back in his vehicle and confirms the final amount via the mobile application. The receipt is stored directly in the authorization account. In this example, the user did not have to swipe a card. In some embodiments, the authorization service will allow the gas station to query the authorization service for users who have entered their property. In some embodiments, the authorization service will provide the gas station with a loyalty or rewards card number that can be used to pre-populate customer information and apply discounts automatically. In some embodiments, the user will have a profile that includes credit-card information filled out at the gas station's website that will include payment information. In some embodiments, the payment information can be used to complete a transaction without the need to swipe a credit card. This will also allow the present invention the ability to not have to directly store the credit-card number, only enough needed to identify the unique owner (e.g., last four (4) digits along with name). That way, a compromise of the authorization service will not result in a breach of credit-card numbers.

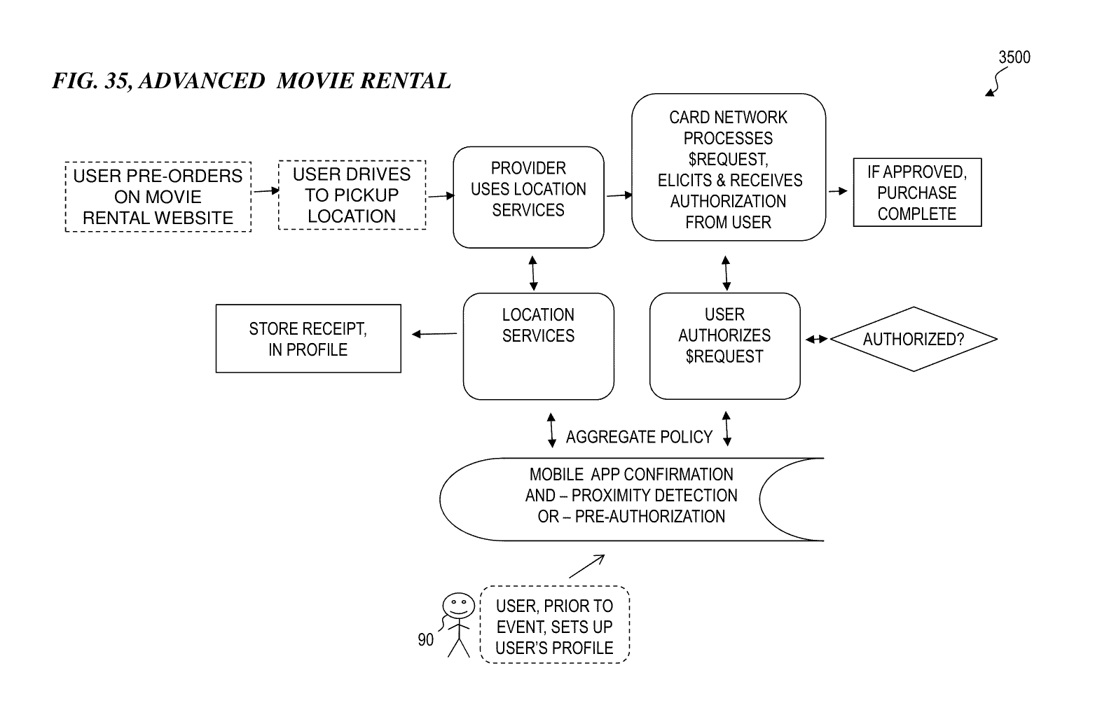

FIG. 35 is a block diagram of an improved payment-card-advanced-movie-rental process 3500, according to some embodiments of the present invention, which demonstrates an advanced Movie Rental. The user preorders a movie using the rental company's online site. The rental company integrates with location services. As the user gets close to the location, the terminal screen populates with a customer record including their first name and last initial. The user simply touches the record and confirms the purchase on their mobile phone. The movie is then dispensed without the need to swipe a card. In some embodiments, the authorization service will allow the movie rental company's computer system to query the authorization service for users who are near their rental machine or facility. In some embodiments, the authorization service will only provide the movie rental company with location information of users who have reserved a movie using their website. In this case, the movie rental company would have to inform the authorization service of users who have reserved movies. In some embodiments, user may allow location to be used manually when they arrive at the location. In some embodiments, a user may not allow proximity detection. In this case, the movie rental site will inform the authorization service that a movie has been reserved. A user will then approve the rental with their authorization account using their mobile device or website while they are standing next to the rental machine or facility. The user will then touch the screen and confirm the rental and confirm on their mobile device before the movie is dispensed. In this case, the movie-rental company knows the location that the user is going to and can still display a link that the user can click on once they have announced that they are in front of the machine or at the facility.

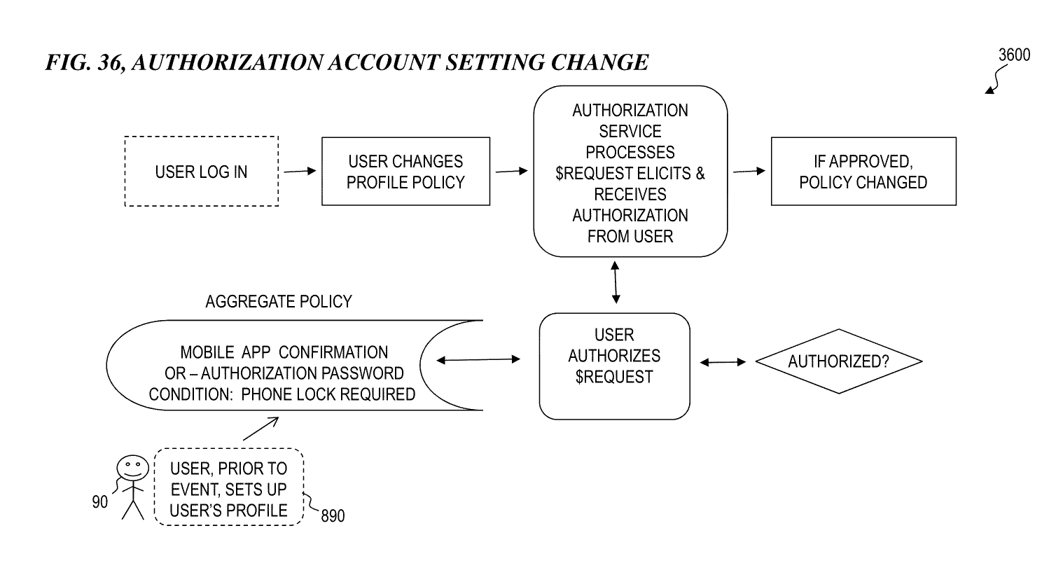

FIG. 36 is a block diagram of an improved authorization-account-setting-change process 3600, according to some embodiments of the present invention, which demonstrates a setting change within a user's authorization account. The user attempts to add a new trust ticket. The user has set the policy that this type of change requires an out-of-band authentication factor such as mobile confirmation entry using an authorization password. The user must use a mobile device that has previously been registered to the service to confirm the profile change. Alternatively, the user may enter an authorization password. In this example, an attacker who has compromised the account password cannot make any changes that will allow the attacker to approve requests. In some embodiments, trust tickets may not be viewable when logged in to the account. In some embodiments, they may only be accessible through a mobile device or when a second form of authentication is entered using the website.

In this example, one can see that it would be very difficult for a person with malicious intent to authorize a request. The individual would have to steal PII, crack the account password and crack the authorization password or gain access to the mobile phone.

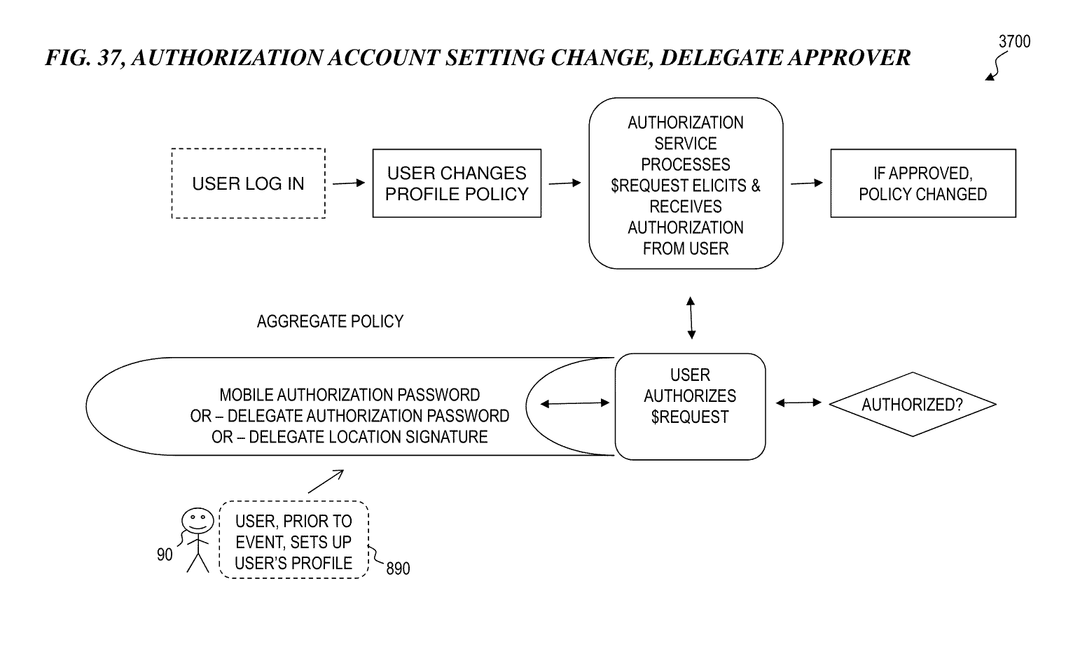

FIG. 37 is a block diagram of an improved authorization-account-setting-change-for-delegate-approver process 3700, according to some embodiments of the present invention, which demonstrates an account setting change with a delegated approver. In this example a user requires a authorization password that is entered on a registered mobile device. Alternatively, the user has delegated another approver like a spouse to make the change. The spouse must enter a mobile authorization password or record the correct location signature. In this example, an attacker would have to obtain the user's PII, compromise his account, his personal mobile phone (i.e., the device itself; not just its telephone number), his wife's account and her personal mobile phone in order to authorize a request on his behalf.

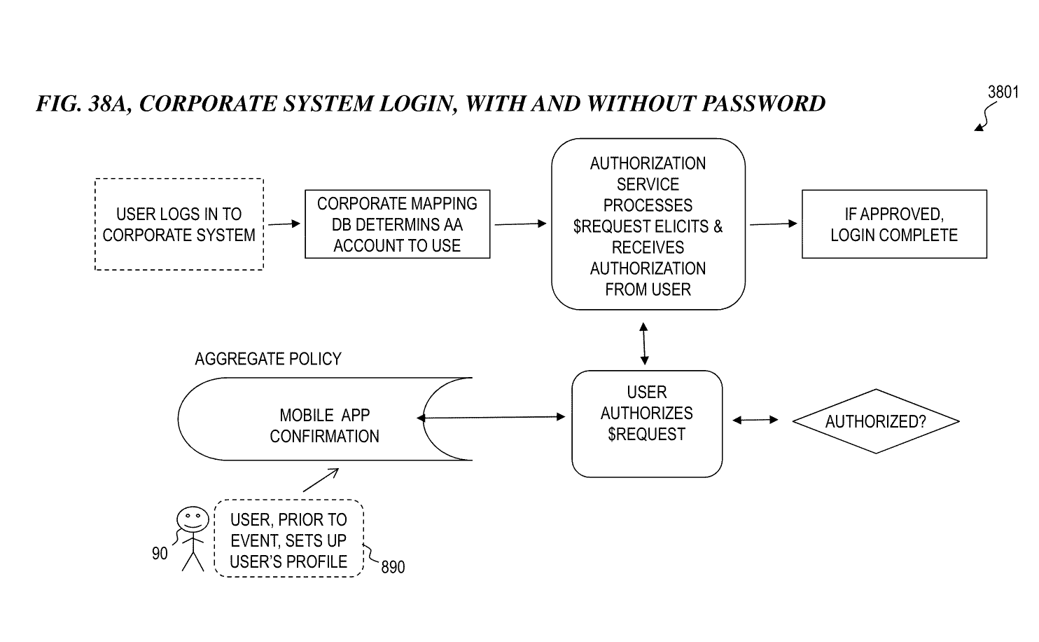

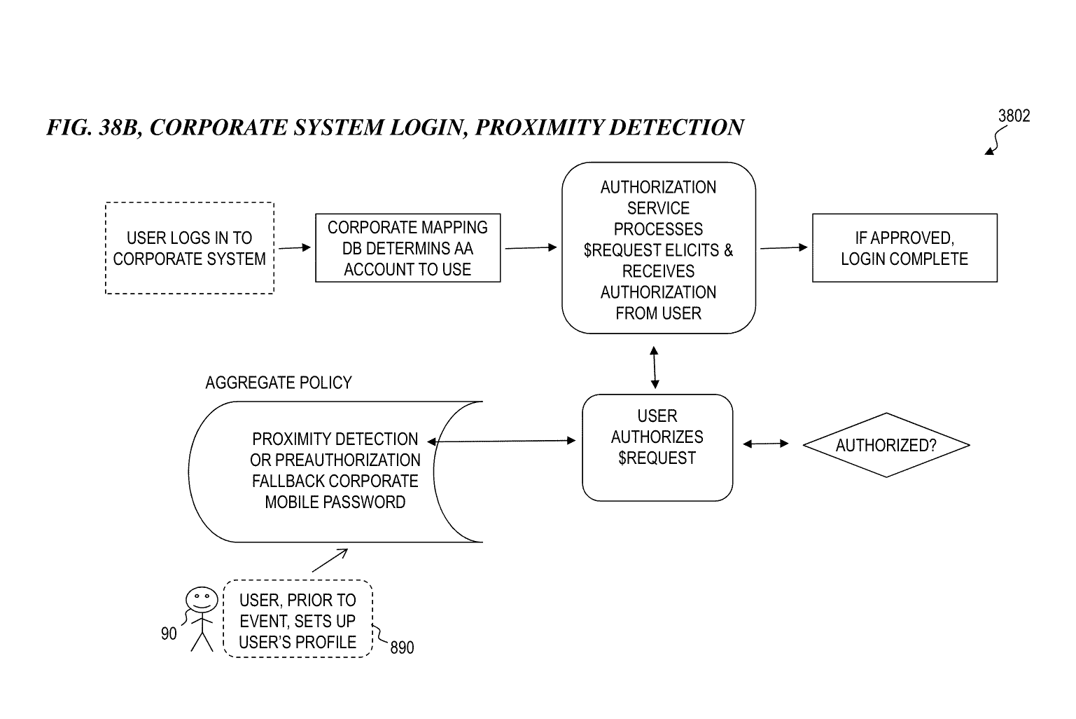

FIG. 38A is a block diagram of an improved corporate-computer-login process 3801, according to some embodiments of the present invention, which demonstrates a corporate system login with and without a password. The corporation uses a mapping database to map their local userid to an authorization account number or a user's PII. In some embodiments, this authorization-service process 120 (see FIG. 1A and FIG. 3B) of the present invention is implemented either as a private implementation or as public service, or both. The user enters his or her user ID and enters the corporate password. The corporation sends an authorization request for the account and the user must confirm the request out-of-band with his mobile phone registered to the service. In this example, the corporation can decide if they require a password locally. They could set a provider policy that required a mobile authorization password or another authentication factor and not require a local password at all. In this example, a corporation whose authentication directory has been compromised will not necessarily result in unauthorized access to systems. A corporation may require the use of the authorization service for all users, users who have elevated access to systems, or critical resources that have access to trade secrets or intellectual property.

FIG. 38B is a block diagram of an improved corporate-computer-login-proximity-detection process 3802, according to some embodiments of the present invention, which demonstrates an improved corporate system login using proximity detection. In this example, the corporation uses a mapping database to map their local userid to an authorization account number or a user's PII. In some embodiments, this authorization-service process 120 (see FIG. 1A and FIG. 3B) of the present invention is implemented is used as a hybrid implementation with both a public and private service (see FIG. 1B). In this example, the corporation is allowing their users to authorize requests using the public authorization service of their choice. The corporation also deployed a private version of the authorization service that includes mapping, logging and alerting services along with service gateways that can be used to connect to the public services and accept direct communication from applications the corporation deploys.

In this example, corporation has programmed in GPS coordinates of all their locations. The coordinates include the perimeter of the buildings and are maintained in their own location database. In some embodiments, the corporation may allow human resources to input the verified coordinates of user's home address within their own location database.

In addition to entering in their corporate password, users are required prove that they are physically in an authorized facility or to use their mobile device and toggle on the “authorize logins” button within their authorization app. The corporate service gateways are integrated with all public authorization services. Corporate users have added the corporation as an employer (provider) and any who have authorized sharing GPS coordinates will have their last known location replicated with the private location database. In some embodiments, the location data will be encrypted and only accessible by the application for the purpose of authentication. This will ensure the privacy of users and will increase adoption rates.

When the user logs in using username and password, the corporations infrastructure will check its own location database for a current location value. If a recent last known location value has been reported that is within allowed coordinates, the login will be finalized.

In some embodiments, corporations will require logins to only be sourced from devices owned by the user when using proximity detection. For example, the user logs in with his corporate laptop. The laptop is assigned to the user and utilizes 802.1X-type authentication and client certificates in order to connect to the network. The requirement to use a corporate asset (secured by digital certificates), GPS coordinates (reported from the secure mobile device) and the corporate login, creates a three-factor login process that is infinitely more secure with little or no change in effort on behalf of the user.

In some embodiments, corporations will require mobile confirmation in addition to GPS location when not using a corporate device.

If current GPS coordinates are not available (or do not match) within the corporation's location database, the corporation's mapping database will provide the public authorization service used by the user and make a request for authorization. The user will have to toggle on the “login authorized” button on within the authorization application during the login process. In some embodiments, the corporation will set a provider policy only allowing the button to be toggled on for five (5) minutes when being used to authorize access to its network.

If for some reason, the authorization service is unavailable, the corporation has deployed an application using their in-house Mobile Device Management (MDM) solution. The application securely communicates directly with their locally installed authorization service. In some embodiments, the public application can be configured with employer's authorization service DNS names or IP addresses and communicate directly.

If proximity detection or preauthorization is unavailable, the user will need to enter his password in his mobile application directly as a back-end authentication. The user will enter his password in the front end, then need to click on the application and enter the password in on his mobile device.

In this example, the corporation may be able to approve the request using their own authorization service or forward it off to the public authorization service, depending on the deployment, policy and conditions selected.

In this example, the corporate network has deployed an authentication methodology using the authentication service that is nearly impossible to compromise while providing little to no change in how employees operate (users almost always carry their mobile phone with them).

Although in this example, the word corporation was used, in some embodiments, the same methodology can be used for all businesses and entities.

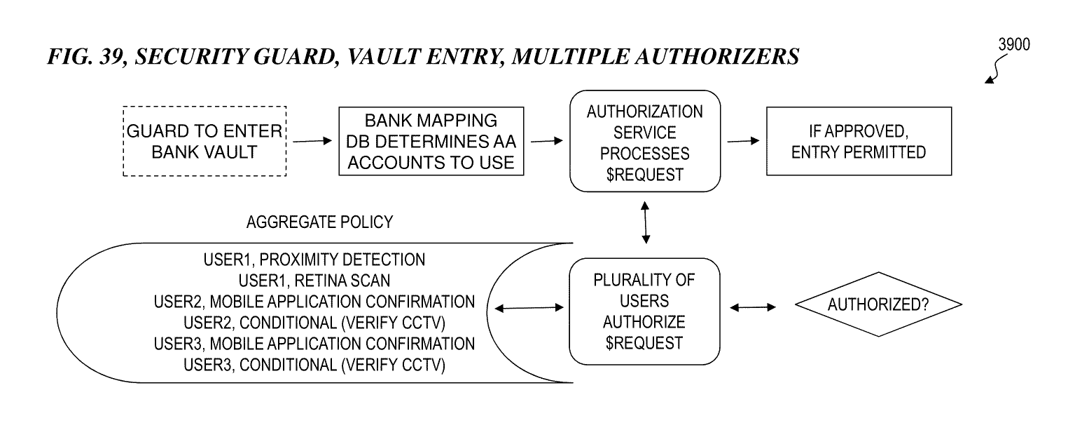

FIG. 39 is a block diagram of an improved bank-vault-entry process 3900, according to some embodiments of the present invention, which demonstrates a security guard entering a vault within a bank. In this example, the bank is using a mapping database and a security provider that is hosting the authorization-service process 120 (see FIG. 1A and FIG. 3B) of the present invention. The security guard is required to have a location device that reports he is near the vault. In addition, he must perform a retina scan at the vault.

The second and third security guards are asked to view CCTV and verify that the security guard is authorized to enter. The bank has a man-trap that ensures no one else can enter behind the guard. If the guard is accompanied with others, he is trained to display a certain visual queue when he has been compromised. In this example, the security guard cannot make the decision to enter by himself, as it requires a multi-party approval. As an added security measure, the second and third security guards could be randomly chosen from a pool of security guards in order to help ensure that there is no cooperation between the three individuals to compromise the facility.

The service could also be configured to require the authentication from a physical station (not a user).

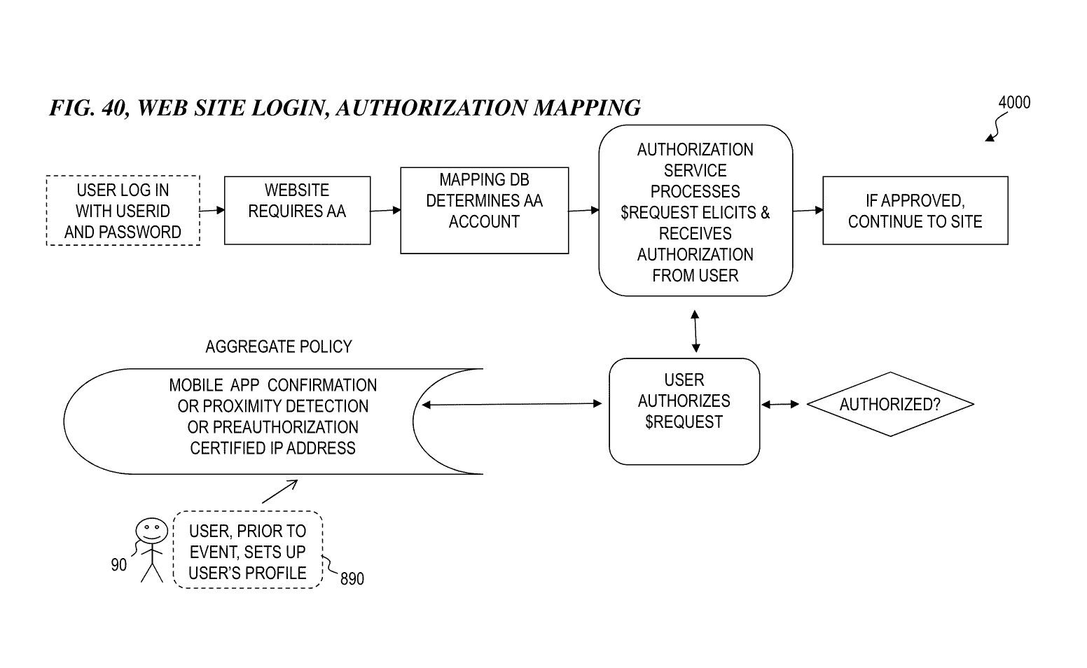

FIG. 40 is a block diagram of an improved website-login process 4000, according to some embodiments of the present invention, which demonstrates a website login that is protected by authorization-service process 120 (see FIG. 1A and FIG. 3B) of the present invention. The user logs in to the website. The website is integrated with authorization-service process 120 of the present invention and the user has configured its account number directly in his website profile. When he attempts to log in, he must confirm via his mobile application his intent to log in.

As one can see, this can very easily replace services like knowledge-based authentication (KBA), which is an authentication scheme where the user is asked to answer at least one “secret” question during an online registration process). In some embodiments, process 4000 is used to register a computer once, or the user can choose to have process 4000 required on every access. In some embodiments, a user may choose to preauthorize by clicking on an app that must simply be open and in the foreground during the login process of any website. In some embodiments, a user may choose to use proximity detection to prove that his or her registered mobile device is next to the computer being used to access the website. In some embodiments, the mobile device will periodically report its location to the authorization service. The computer used to access the website may allow the website to use location information that can be derived by its own GPS or other suitable technology, such as a WIFI positioning system. In some embodiments, the website is allowed to query the authorization service and provide the coordinates that it received from the client computer system. The authorization service will match the coordinates to the coordinates of the registered device. If they are within an allowed tolerance, login will be allowed. In some embodiments, this process will occur after the initial username and password are entered.

In some embodiments, the client computer system used to access the website will be registered directly to the authorization service and provide its own coordinates that can be validated. In some embodiments, the client computer (that is registered to the service) may communicate to the authorization service so the authorization service can determine the IP address that the computer system is using on the internet. The websites computers can then inform the authorization service of the IP address being used by the client computer accessing the system. If the authorization service is aware of the IP address, it can confirm that the client is authorized. In this example, if the website is using SNAT (Source Network Address Translation) on their web servers or load-balancers, they may need to use technologies such as x-forwarded-for http headers to maintain source IP address information that can be used to authenticate the client computer.

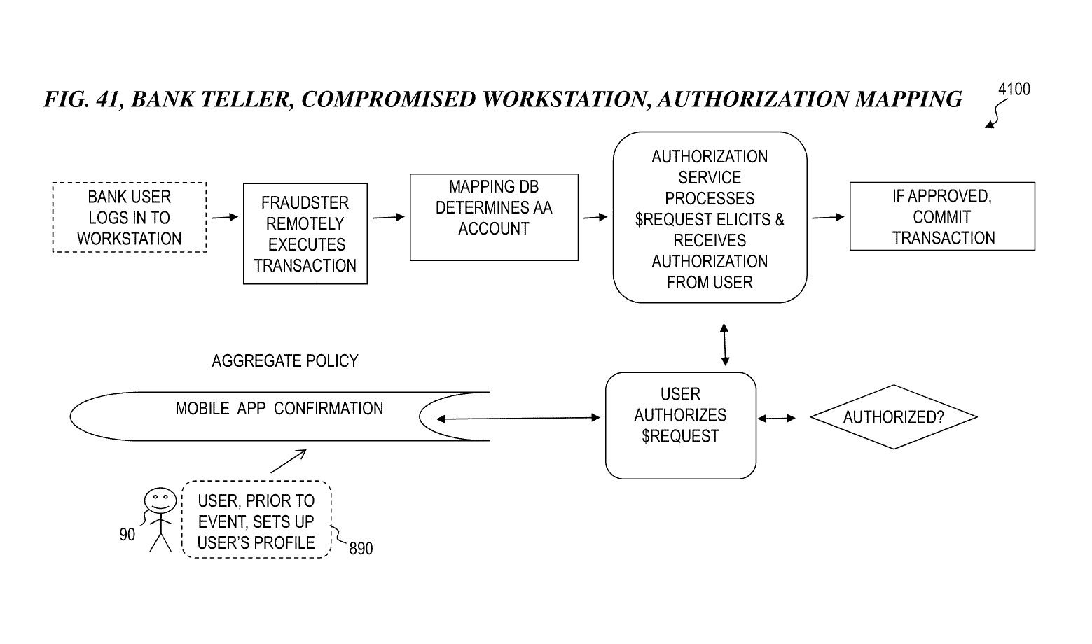

FIG. 41 is a block diagram of an improved bank-teller-compromised-workstation process 4100, according to some embodiments of the present invention, which demonstrates a bank workstation that has been compromised. The user logs in to the workstation using a username and password provided and protected by the bank's computer systems. The fraudster has already compromised the workstation and installed a remote control application. The application is not detected by the banks security software. The attacker attempts to process a fraudulent transaction. The bank requires mobile confirmation on all transactions and the teller must touch a tablet screen next to her workstation to confirm. The teller realizes right away and, instead of confirming, presses the button informing the bank that it is fraud. The bank immediately shuts down the tellers POS to investigate the problem. In this example, the bank is using a mapping database that maps the local userid to an account reference or the user's PII used to find the authorization account. The bank is using the public authorization service that certifies the individual's identity. In some embodiments, the bank may use an authorization service installed and operated by itself. In some embodiments, it may use a service operated by a managed security services provider (MSSP). The Bank is allowed to use the authorization service for the purpose of authorizing its own transactions. The authorization service requires the bank (as a provider) to utilize client side certificates and digital signatures for non-repudiation. That way, the service knows that it is truly the bank that is asking the question, “do you approve?”

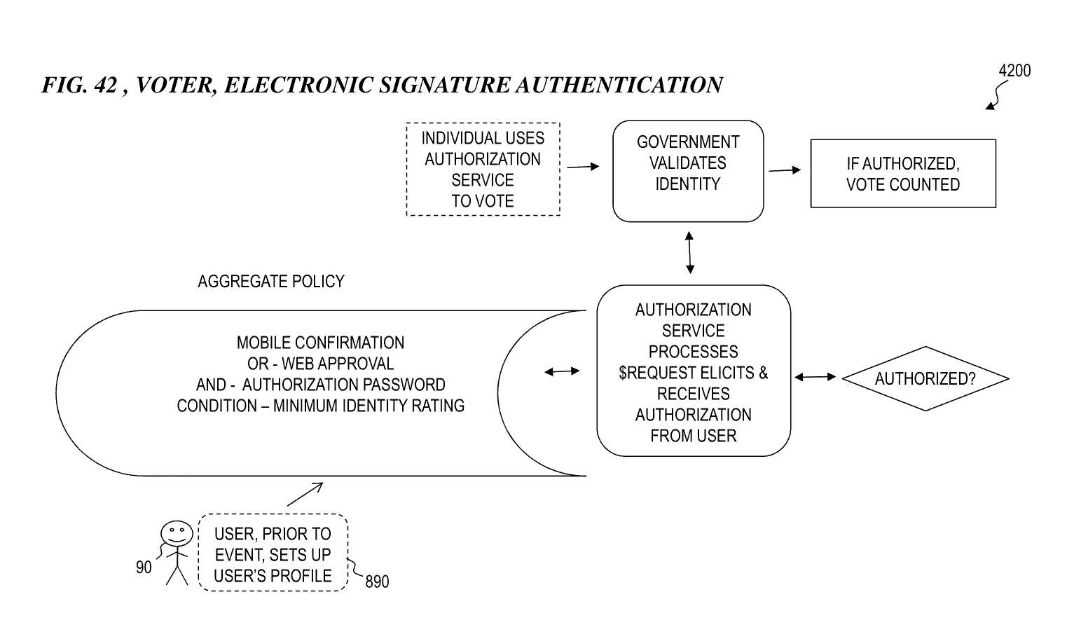

FIG. 42 is a block diagram of an improved voter-electronic-signature-authentication process 4200, according to some embodiments of the present invention. In process 4200, the authorization-service process 120 (see FIG. 1A and FIG. 3B) of the present invention is used to verify the identity of individuals and to receive their vote in an upcoming presidential election.

Some embodiments of the present invention will include the use of an identity rating. An identity rating is the likelihood that you are the individual owning the PII. An identity rating can be used to approve participation in events that require a high level of security. Identity ratings can be used by providers to gauge likelihood that an individual is who they say they are. For example, a user may certify their identity upon account creation by providing multiple forms of PII and using a registration code that was mailed to their home address. After the account is created, a user may use the account to approve requests related to many forms of PII such as multiple credit card numbers, drivers license, email addresses, passports, National IDs, social security numbers etc. By having control over multiple sensitive numbers, actively authorizing requests and properly securing access to an account, a user can prove they are the proper owner of the PII and the authorization account. This is because a fraudulent user would not be able to control access to all accounts for very long without going unnoticed.

Identity ratings can be used by providers as conditions. For example, the US government may decide to allow the authorization service to be used in an upcoming election. The government may require a minimum identity rating in order to use your authorization account to vote. A user that has multiple forms of ID such as a drivers license number, an SSN, etc. and is also regularly approving credit card transactions will have a high identity rating. A user that also requires multiple forms of authentication in order to approve account changes will receive a high identity rating.

The government, as a provider, can set a condition of a minimum identity rating in order to vote using the authorization service. The government can also set other conditions such as requiring multiple authentication factors as a provider to ensure the user is the PII owner.

When the minimum rating is reached, a user could use the present invention as an electronic signature for the purpose of voting. In the future, the present invention can be used for all voting and provide a much more secure and accurate option over current methods.

In some embodiments, identity ratings may used by a provider to determine conditions. As an example, a provider may choose not to impose any conditions on a user with a very high identity rating who has demonstrated secure use of their PII.

In this example, a user would like to vote for an upcoming election. The user adds the required provider to his profile to indicate his desire to vote. Once all registration information is completed, the authorization service notifies the provider of the user's intention to vote using the authorization service along with the identity rating. The provider confirms that the user may vote electronically using the authorization service. The provider sends a series of votes as requests. The user may use a mobile application or log in to the website to approve the requests. For this user, the government is requiring an authorization password to be entered once all votes are made. The user may indicate his desire to vote this way in upcoming elections.

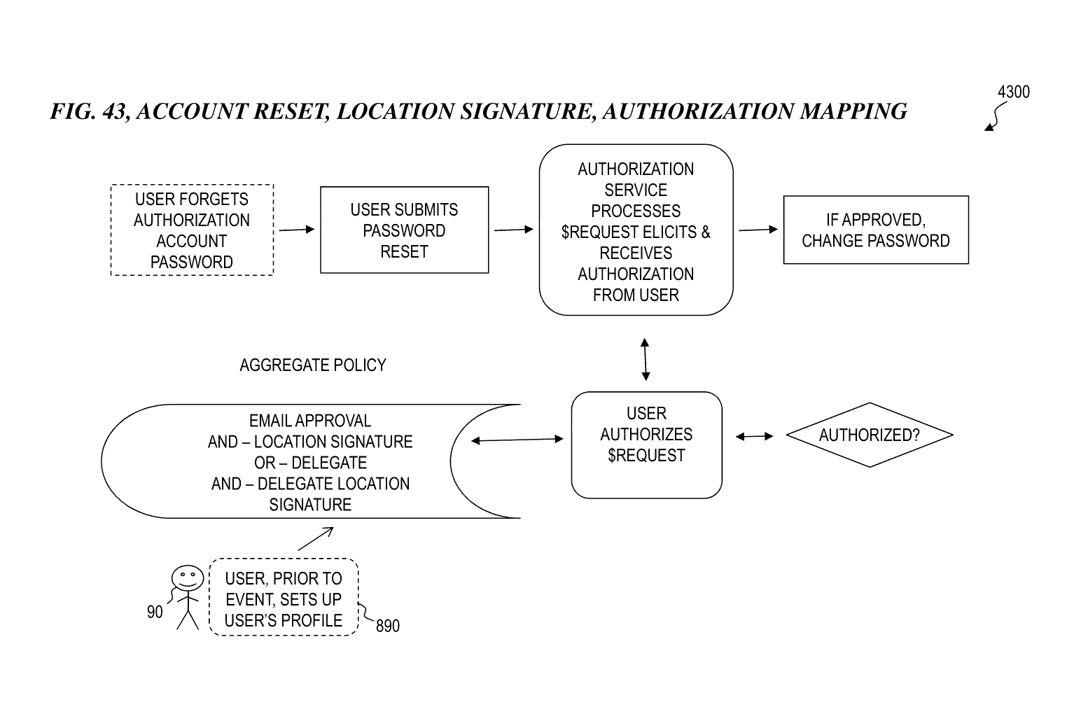

FIG. 43 is a block diagram of an improved website-account-password-reset process 4300, according to some embodiments of the present invention, which demonstrates an account reset using a location signature. The user forgets his password and attempts to reset. The user has previously indicated that he would like to approve via e-mail and submit a location signature. He will need to click on an approval link in e-mail and follow a predetermined path that he recorded himself as a location signature. Alternatively, his wife can approve the request using her e-mail and location signature. That way, he has multiple ways to regain access to his account. If his wife approves, the final reset link will be sent to his e-mail. In this example, the user is able to securely reset his password even if he or she forgets multiple authentication factors that he or she created. He or she is also able to set a directive stating that his or her spouse has the authority to reset his or her password in the event that he or she cannot. After resetting his password, the user may receive an e-mail with a link to click on in order to complete the process. In this example, the user is acting as a provider while their spouse is a second user. The user will have the ability to set provider policy, if desired, for their spouse to be able to reset the policy such as using specific types of authentication factors. The user could also set multiple approvers. As an example, the user may want both their spouse and their mother to be required to approve an account reset in the event the user does not remember their required authentication factors.

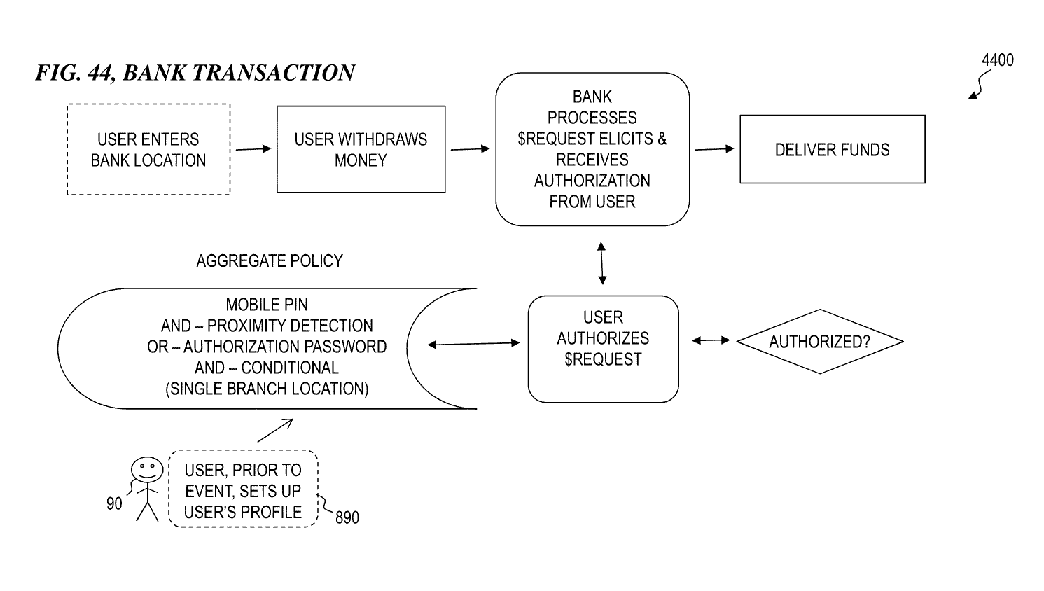

FIG. 44 is a block diagram of an improved in-bank-transaction process 4400, according to some embodiments of the present invention, which demonstrates a user that would like to withdraw money from a bank. The bank has integrated with the authorization-service process 120 (see FIG. 1A and FIG. 3B) of the present invention. The user requires proximity detection, mobile PIN and only authorizes doing business at one specific branch location. The user withdraws money and enters a PIN on his mobile device. In this example, the user does not have to use the local terminal. The user must have their mobile device with them that successfully reports the last known location as being in the bank. Alternatively, the user's vehicle may report location (in the parking lot) via a service provider integration with the company responsible for his cars GPS. If the user has misplaced his GPS, he must authenticate by using his authorization password instead of his PIN and proximity. Additionally, he may only transact at the single branch as configured within the account profile.

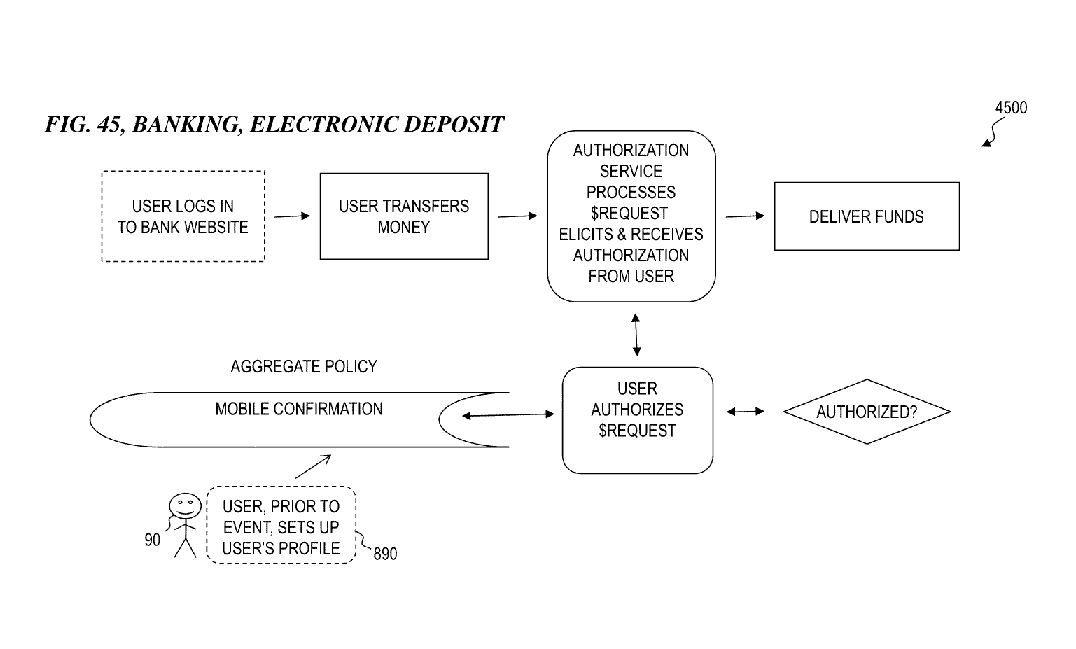

FIG. 45 is a block diagram of an improved bank-electronic-deposit process 4500, according to some embodiments of the present invention, which demonstrates a user that would like to transfer funds from one bank account to another. The user logs in to their banking website and initiates a transfer. The bank authorizes the request. The user has decided to require mobile confirmation and confirms the request on her registered mobile phone. This will help prevent fraudulent users from transferring funds to another account. In addition, many banks do not allow transfers to take place between accounts that have different names, in an effort to reduce fraud. The present invention will make it possible to securely transfer funds between different users.

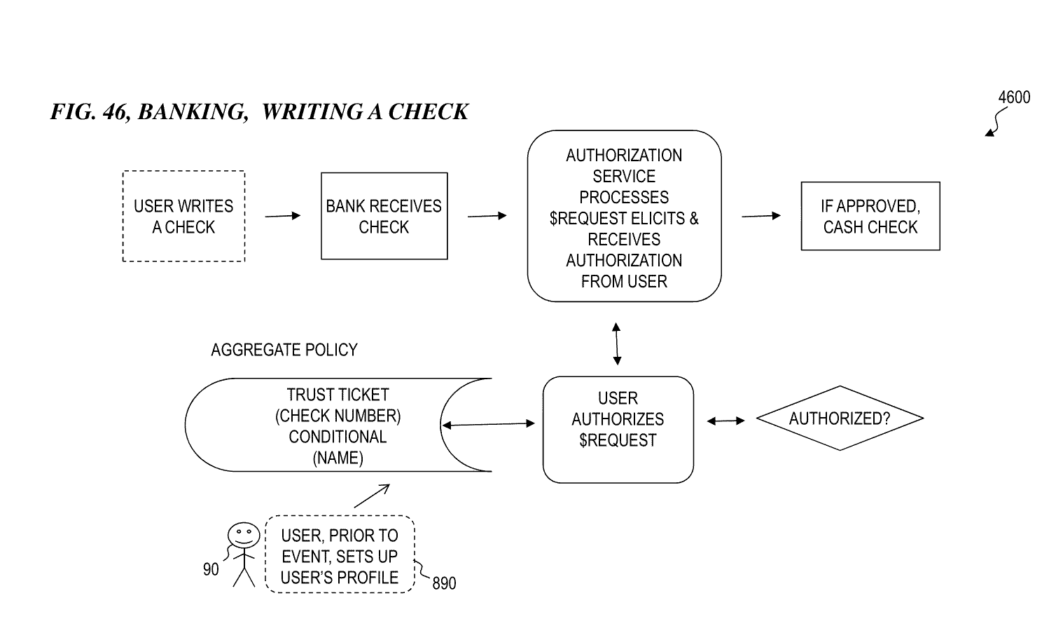

FIG. 46 is a block diagram of an improved bank-check-clearing process 4600, according to some embodiments of the present invention, which demonstrates a user that writes a check. The user has protected their checking account with the authorization-service process 120 (see FIG. 1A and FIG. 3B) of the present invention. The user has required that the check number and the name on the check must be entered in their authorization account. An individual attempts to cash a check at their bank. Their bank sends a request to the authorization-service process 120 to verify. In this example, it is a fraudulent check that is denied. In this example, it will no longer be possible to write fraudulent checks just by stealing ones checks or duplicating the checks when in possession of the account information.

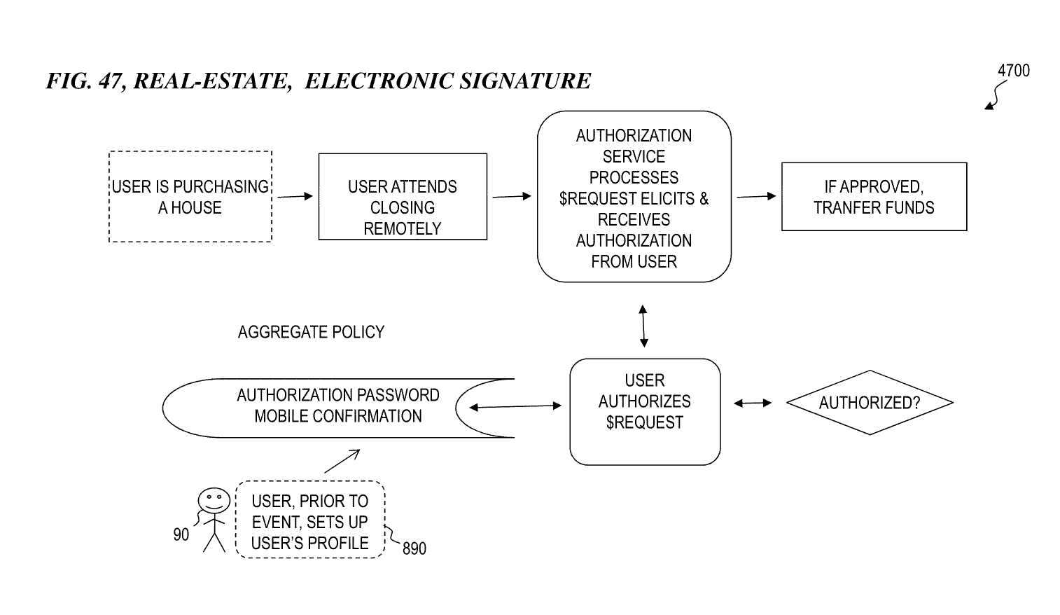

FIG. 47 is a block diagram of a real-estate purchase completed by using an electronic signature verified by the authorization service 4700, according to some embodiments of the present invention. In this situation, a user is purchasing a home. The closing company sends the closing documents to the user and reviews them over a remote presentation service. Once the homeowner is comfortable, the closing company asks for an electronic signature from the authorization-service process 120 (see FIG. 1A and FIG. 3B) of the present invention. The user must enter his authorization service password and confirm that he has read and understands what he signed. In some embodiments, the present invention may also be used to authorize the transfer of funds between the user and the title company. The user may authorize the transfer with the specific directive that it can only be used to purchase the home. The title company will have to use its entity authorization account to accept the directive (electronic signature) that the funds can only be used to apply towards the home being purchased by the user.

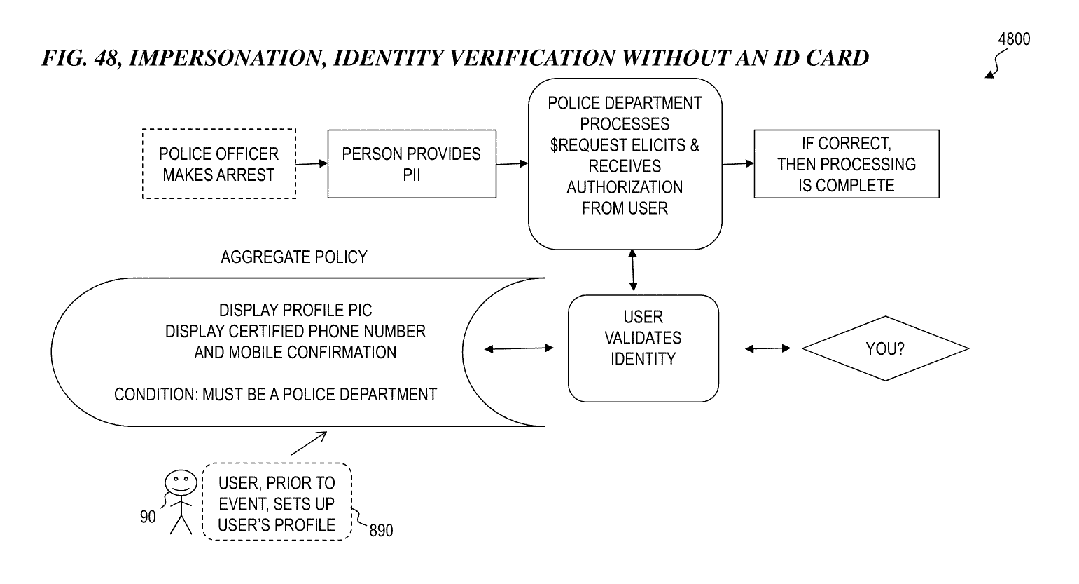

FIG. 48 is a block diagram of an improved impersonation-prevention-identity-verification process 4800, according to some embodiments of the present invention. In some embodiments, the process 4800 of FIG. 48 is useful when a police officer makes an arrest. The individual provides personally identifiable information but does not have a physical ID. The police department verifies his identity. The user has allowed an up-to-date profile picture to be displayed along with a certified telephone number to call. The user has also indicated that they would like a mobile pop-up message and e-mail to be delivered. The police department is the only agency that can make the inquiry. In this example, a fraudulent individual who impersonates another person will not be able to directly verify their false identity. Only the actual person who owns the identity and secured account proving their identity will be able to confirm identity. This example also gives the police department a mechanism to immediately call the correct individual and significantly cut down on time it takes to investigate the identity of the fraudulent individual. This may also prevent the incorrect individual being arrested at a future date for a crime they did not commit.

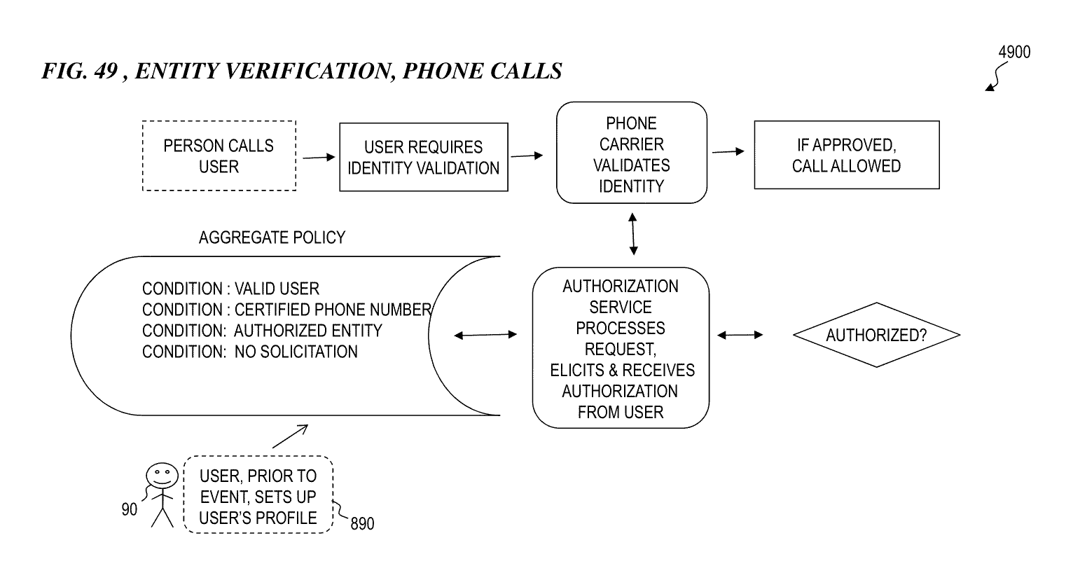

FIG. 49 is a block diagram of an improved entity-verification-for-telephone-calls process 4900, according to some embodiments of the present invention, which demonstrates a person making a telephone call. In this example, the voice carrier has integrated with the authorization-service process 120 (see FIG. 1A and FIG. 3B) of the present invention. The service is use to authorize telephone calls. The user has set a policy that the caller must be a valid individual and that the call must come from a certified telephone number. If the call comes from an entity, it must not be a solicitation. Since, in some embodiments, the system of the present invention is requiring individuals and entities to have a digital identity, it can use them to verify calls. In some embodiments, the system of the present invention requires the telephone companies to verify identities and assign telephone numbers or DID (direct-inward-dial) telephone-number ranges to individuals or entities. In some embodiments, the system of the present invention then sets rules for the telephone companies. In some embodiments, the system of the present invention also monitors call volume and make certain that individuals are flagged if they place too many calls. In some embodiments, the system of the present invention creates a special identity for an individual at a corporation. In some embodiments, the individuals specific DID number is added directly to the user's personal authorization account and approved by the employer. That way, those individuals can continue to make personal calls in the event a user denies calls from entities. In some embodiments, corporate call centers will be required to use an entity identity.

In some embodiments, the user will have to claim a phone number in the user's authorization account profile. The user's provider will have to confirm that the phone number is owned by the user.

In some embodiments, the user is able to set policy within their authorization account by integrating with the authorization service

In some embodiments, the first-hop phone carrier (provider) will create a unique reference number that ties the out-bound call to an entity. In some embodiments, the receiving phone carrier or user's device will check their authorization service account for a matching entry destined for their phone number. This will allow the user to truly know who the caller is. In some embodiments, the present invention can be used to significantly reduce or eliminate voice phishing (vishing) because each caller's identity will be known with the correct user policy shown to the user receiving the call.

In some embodiments, an entity may be required to classify outbound calls based on the automatic number identification (ANI, caller-id). The classification should be stored within their entity authorization account and can be used by users to screen incoming calls. For instance, a user may choose to allow non-profit entities to call and other companies to make customer contact calls while disallowing solicitations and calls that are not sourced from a validated entity.

Since users of the present invention are following a process that certifies the identity of the user in order to create the authorization account, they can use the account to prove ownership of an e-mail address. The e-mail address will need to be added as an owned e-mail address by the account owner. Once the address has been added, the authorization service will verify that the user has physical possession of the e-mail before certifying the ownership. The user can have multiple e-mail addresses within their account and businesses may also choose to allow their employees to identify corporate e-mail addresses as being owned by them. Alternatively, employers may decide to require that accounts be registered to their business identity account or an individual account under the business identity.

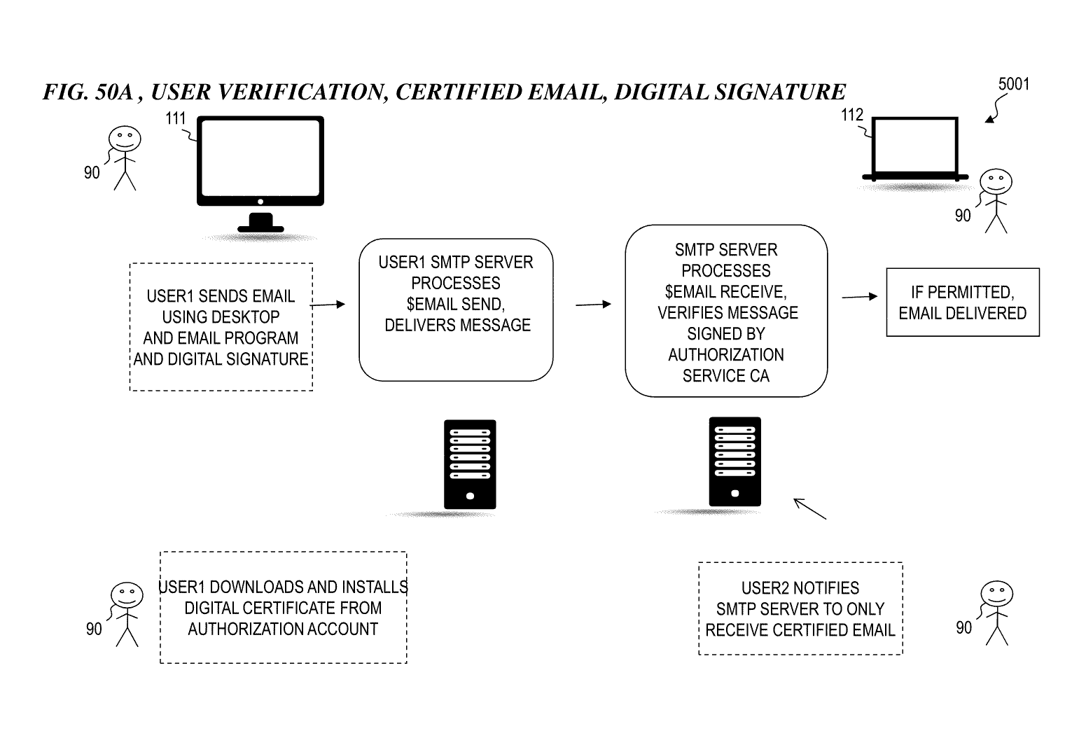

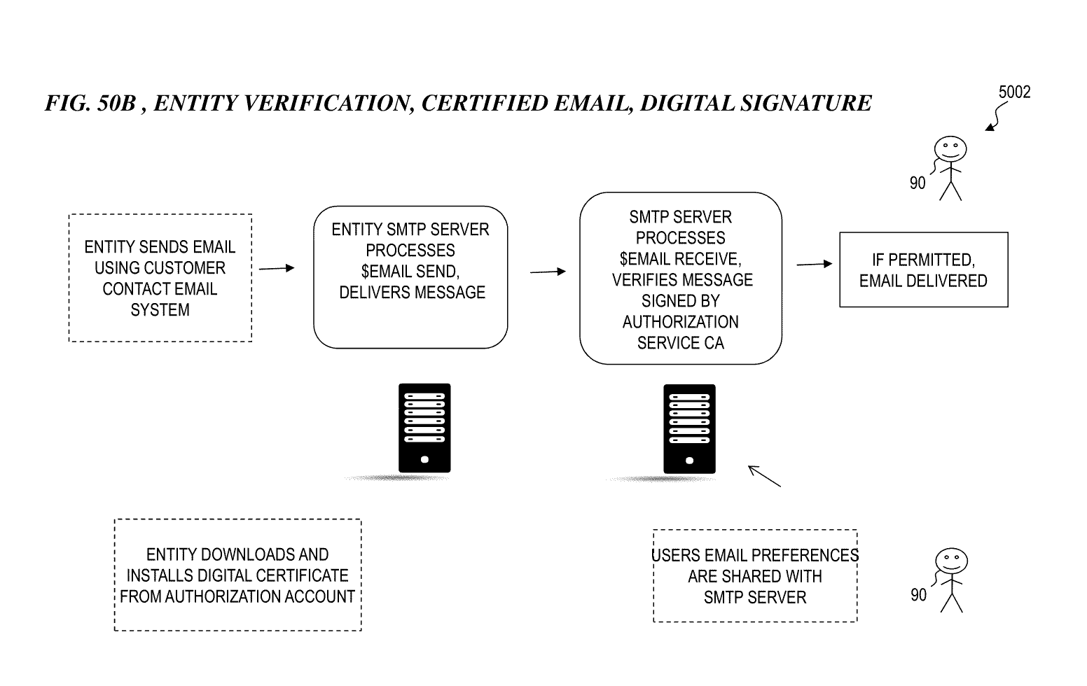

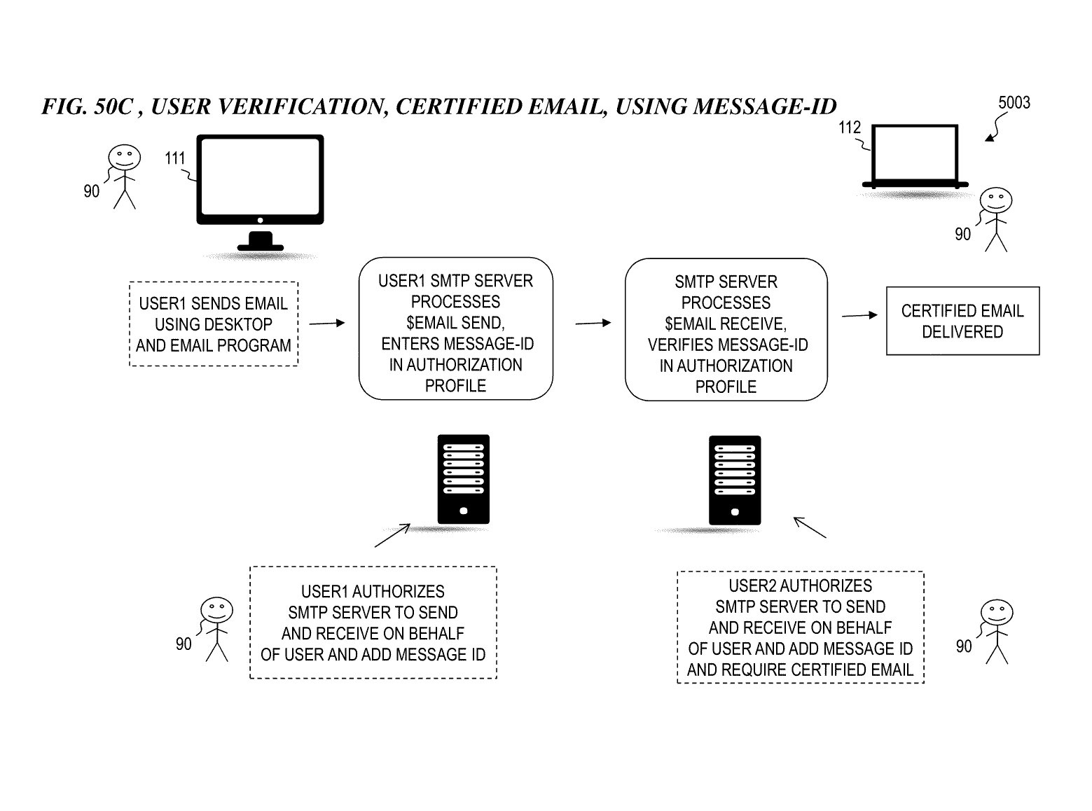

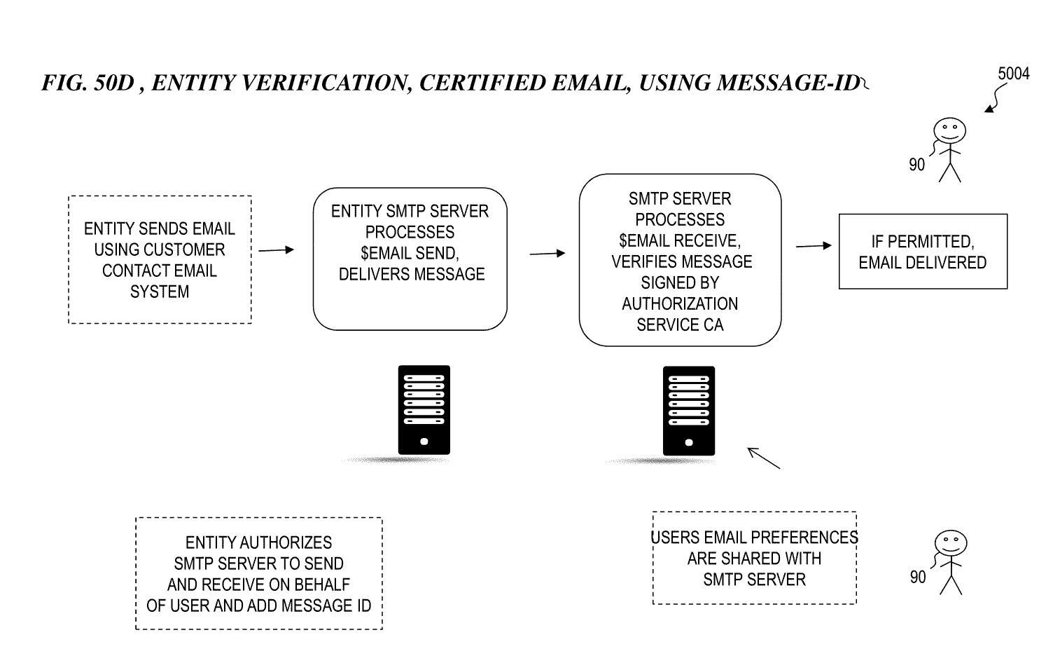

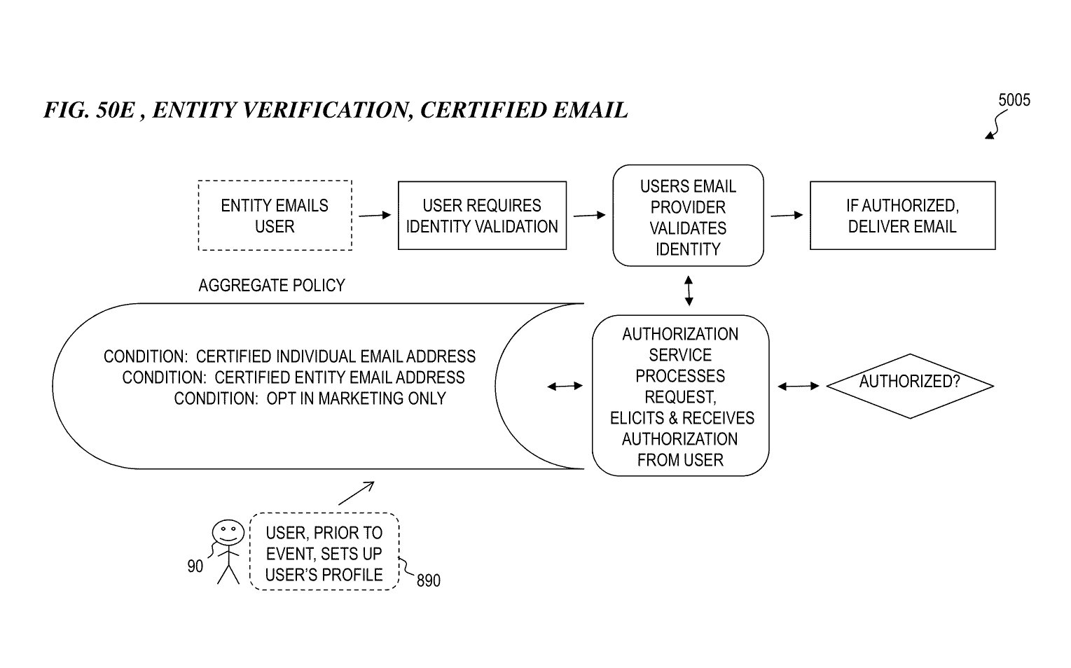

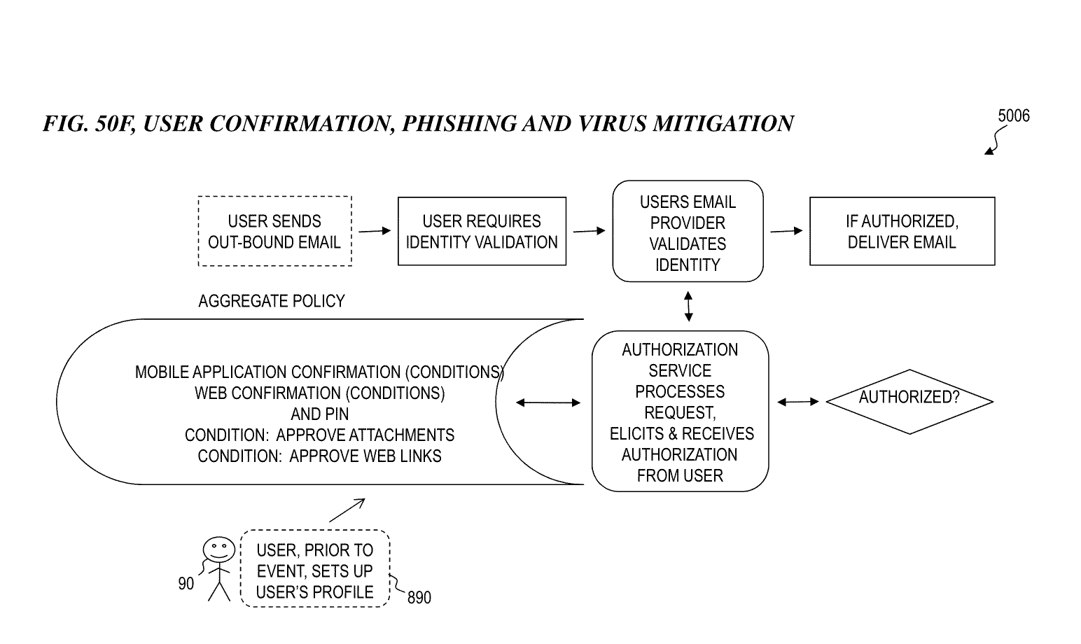

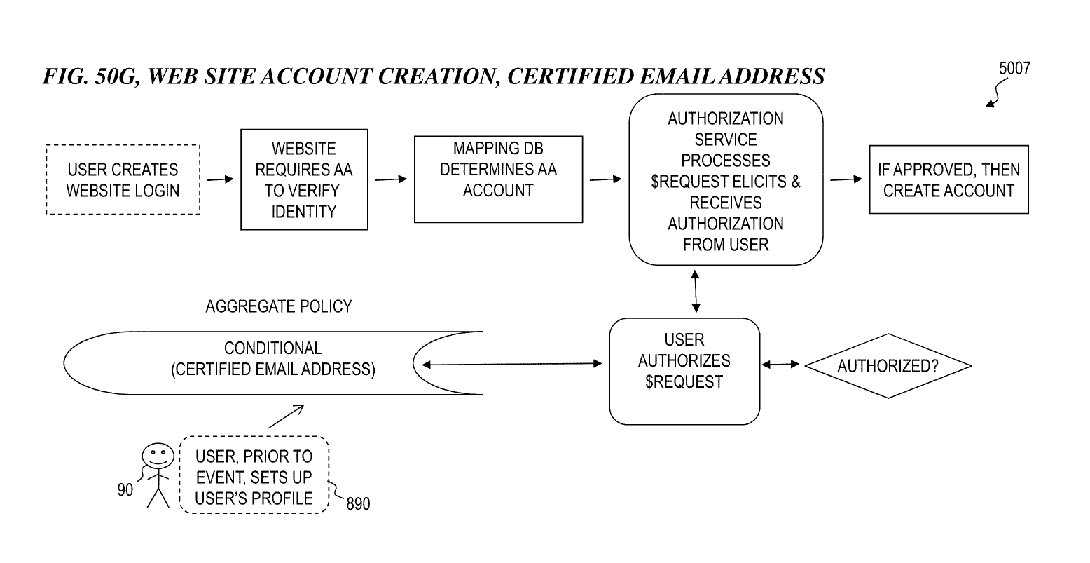

Once an e-mail address has been certified, the user can use it to prove identity. For websites that integrate with the service, it can make it very difficult if not impossible to create fraudulent accounts. As an example, if a website requires a certified e-mail before creating an account, they can ask for the e-mail address as a part of the account creation process (See FIG. 50G). The website can then query the authorization service using PII of the individual such as name, DOB and last 4 of the social security number. Once the account is mapped to the individual, the website can provide the e-mail and ask if it is registered to the user. Once confirmed, the websites computer systems will then send an e-mail to the owner to activate the account. This will ensure that the individual owning the PII is the only one who can create an account. All it takes is a user that has an authorization account and a website that checks it. Creating an account using stolen PII and an e-mail address owned by the fraudster will no longer be possible.

The certified e-mail address can also be used to eliminate SPAM and Phishing without the need for complex SPAM-filter gateways. This is called certified e-mail delivery. A user can choose to only receive e-mails only from certified e-mail addresses. This can be accomplished in a couple of ways. The first is to modify e-mail gateways or the SMTP protocol to check the authorization service for valid users during mail delivery. Users can indicate on an e-mail client or webmail service that they only wish to receive certified e-mails for this e-mail account. The mail client will notify the user's SMTP server of that request. Alternatively, the authorization service can notify SMTP servers of that preference for the e-mail address configured with that option in the authorization service. The SMTP e-mail servers, knowing the preference, will check the authorization service for in-bound e-mails and validate that the sender is using a certified e-mail source. The e-mail sender will need to use an e-mail provider who integrates with the authorization service on out-bound messages.

When an e-mail is delivered from a specific address, the receiving e-mail gateway can look at the sending e-mail address and check the authorization service to see if it is registered to a verified identity.

In some embodiments, the present invention provides certified e-mail delivery (See FIGS. 50A-50F). Current email services used on the internet rely on reactive analytics (Email Filters) to determine the authenticity of an email. These solutions use complex logic to determine if the content within the message is legitimate or not. The reason why we have to use these techniques is because there is currently no way to certify identity when sending mail using the SMTP protocol between individuals or entities using disparate systems. The present invention can be layered on top of existing email delivery systems to provide certified email delivery. This can be accomplished with minimal changes to the SMTP protocol and or mail clients.

In some embodiments, the e-mail sender has an authorization account that certifies his identity. The authorization account is configured with the user's e-mail address as a certified e-mail address. The user indicates in the profile that he or she would like to register an authorized mail delivery gateway (SMTP server) so their e-mail service provider can notify the authorization service when it has or will deliver an e-mail message on behalf of the user. The user will make a configuration change on their mail client to indicate that it would like to use certified e-mail delivery. In some embodiments, this requires a modification to the e-mail client. In some embodiments, e-mail clients will either notify the SMTP gateway of that preference or when the user attempts to send out an e-mail, the client will inform the SMTP server of the preference. The SMTP server will attempt to communicate with the authorization service on behalf of the sending user. The user will have to authorize the e-mail provider's SMTP server to notify the authorization service of sent e-mail. Once approved, the SMTP server will communicate with the authorization service when the user sends e-mails. In some embodiments, once the SMTP server is authorized to send and receive messages on behalf of the user, the SMTP server may query the user's authorization account for email preferences. In some embodiments, this communication is secured with client authentication using digital certificates installed on the SMTP gateway to ensure a high level of security. The digital certificates will need to be issued from a reputable provider and certify the identity of the email provider. In some embodiments, the best practice is for the email provider to use a digital certificate issued from the entity's own authorization account in order to properly certify identity.

In some embodiments, the SMTP server will insert a unique ID in the e-mail delivery profile (See FIG. 50B) of the user's authorization account. This ID can be a custom value or could be the message-id that is already generated in the current SMTP protocol during message delivery.

The receiving SMTP server would be aware of its user's preference to only receive certified e-mail. The receiving SMTP server would also be authorized by the receiving user to look up message identifiers on the receiving user's behalf. Once authorized, the SMTP server will make a query upon receipt of the message. The SMTP server will provide the sending and receiving e-mail address in the inquiry. The authorization server will check the profile of the sending user for a matching message identifier or SMTP message-id. If the entry is there, the e-mail is certified and delivered to the user. If not, the message is dropped. This would allow certified message delivery with minimal changes to the e-mail clients and SMTP protocol. It would also allow existing e-mail services and accounts to be supported without major design changes.

In addition to eliminating the e-mail from an unverified source, some embodiments include creating a certified entity e-mail address. Businesses and entities would be required to use an entity e-mail address as opposed to an individual e-mail address. That way, if a user chooses, they can decline to receive marketing e-mails from entities that are not individuals. Some embodiments may include limiting the number of messages that can be sent from an individual. Some embodiments may include the ability to specifically permit marketing e-mails from authorized businesses while declining others.

In some embodiments, users that leverage a corporate owned e-mail address may simply add their corporate e-mail address to their authorization account profile and allow their company's SMTP server gateways to send e-mail on the user's behalf for that e-mail address.

Some embodiments provide a special business or entity individual e-mail address designation to be managed under the business's or entity's authorization account.

When checking that the e-mail address is valid, the owner may indicate who their e-mail provider is along with their certified e-mail address; that way, the receiving SMTP server can authenticate the sending e-mail gateway and make sure that it is the correct provider for the domain.

The second way some embodiments of the present invention validate e-mail between parties is by digitally signing requests (See FIG. 50A). Since the user's identity has been validated during account creation, the present invention can provide the user with a digital certificate that can be used to sign e-mail messages. The root certificate and chain used by the certificate authority leveraged by the authorization account will only issue digital certificates to accounts that have properly certified identities. As a result, a certificate issued by the service can be viewed as a source of truth as to who delivered the message.

In some embodiments, the authorization account has the ability to generate a certificate for the user who owns it. Some embodiments include the mobile or desktop applications having this capability. The certificate generated will truly validate the identity of the individual owning it. It can simply be downloaded and installed on the client devices. In some embodiments, the e-mail program is configured to use the digital certificate to sign the message with the provided private key. Most e-mail programs already have the ability to sign messages by using a digital certificate. The receiving SMTP gateway or e-mail client, when informed to only allow certified e-mail will validate the signature and check that the certificate chain is one used by the authorization service. This will be enough to prove the authenticity and ownership of the message.

The certificate will need to be loaded on the user's device or within their e-mail program. When sending e-mails, in some embodiments, the e-mail or webmail program will digitally sign the message using the user's digital certificate (See FIG. 50A). The receiving e-mail gateway or client can check for the public key and verify the identity of the sender via the digital signature. In some embodiments, the client sends the public key with the e-mail or the receiving gateway, while in other embodiments, the e-mail client checks the authorization service to download the public key and verify the signature.

Some embodiments include the receiving user's SMTP gateway or e-mail client checking (when approved) the authorization service for e-mail delivery preferences. As an example, the user may set delivery policies directly in the authorization account profile. Businesses will need to sign their e-mails using a certificate that validates their identity as a business or entity. The subject or other information within the certificate will indicate this. Users can choose to only allow e-mail from individuals or certified businesses. Additionally, users may choose to allow marketing e-mail only from authorized businesses or entities. Finally, a business may choose to allow an individual to use their own authorization account and digital certificate on the corporate devices for the purpose of signing their e-mail messages. In some embodiments, a corporation may ask for a special individual certificate that they can assign to their users so they will not be prevented from sending individual e-mails.

In some embodiments, users may choose to only allow attachments from certified email addresses while still allowing anonymous email to be delivered. This will help reduce the amount of viruses being spread through the use of attachments and anonymous email. In some embodiments, users will need to actively approve sending attachments with their SMTP email gateway. The purpose of this is to eliminate the transmission of viruses through email. If a user's workstation is compromised and sends emails out that contain viruses, they may go undetected. Since they are often times transmitted through email attachments, a user may decide to require active approval of any attachments being sent from one's email account (See FIG. 50C). In some embodiments, users may also need to actively approve any out-bound emails being sent that include website links (see FIG. 50C). This will prevent a compromised system from sending out Phishing emails from a certified email account. In order to protect a user from sending out email that may compromise a workstation via the use of Phishing or malicious attachments, the user's registered SMTP server (provider) may check preferences within the authorization account indicating the user's desire to approve sent emails with attachments and web links. In some embodiments, the email service provider may set a condition within their provider policy indicating the requirement to actively approve out-bound email messages that include web links or attachments.

FIG. 50A is a block diagram of an improved user-verification-certified-e-mail-digital-signature process 5001, according to some embodiments of the present invention. In process 5001, the authorization service 120 (see FIG. 1A and FIG. 3B) of the present invention is used to verify e-mail delivery. This user has downloaded and installed a digital certificate from their authorization account. In some embodiments, the digital signature is installed from within an application used to access the user's authorization account. The application may be installed on devices such as desktops, laptops, mobile phones, tablets or the like.

In some embodiments, the digital certificate is generated by the authorization services certificate authority or an alternate certificate authority. The certificate authority and path responsible for generating the digital certificate will only generate certificates for individuals who have authorization accounts and have properly validated their identities. In some embodiments, a user will be able to revoke a previous certificate or generate a new one to be installed. In this case, the service may use features such as Online Certificate Status Protocol (OCSP) or Certificate Revocation Lists (CRLs)

The digital certificate along with the authorization service will validate identity as well as ownership of the email address. In some embodiments, the email address can only be owned by one individual.

Once the digital certificate is downloaded and installed, the email client or web client will be configured to use it in order to digitally sign email messages using the private key. In the case of webmail, the digital certificate will need to be uploaded to the webmail client and the webmail client will need to be configured to sign messages with the private key.

When the user (USER1) sends an email, it will be digitally signed using the private key. In some embodiments, the email program will attach or include the public key within the email. In some embodiments, the public key will be stored in the user's authorization account and available for download only for SMTP servers that are authorized as a provider in a receiving user's profile.

The sending user's SMTP server will transmit the email message to the receiving SMTP server. The receiving SMTP server, authorized as a provider for the receiving user, will retrieve message receipt preferences on behalf of the receiving user. If the user will only allow email from sources who have properly validated identities, the SMTP server will validate the signature by using the public key provided with the message or from the authorization service. If the message is signed by a certificate chain known to be used by the authorization service (or another certificate authority deemed to be acceptable), The SMTP server can confirm its authenticity and deliver the email to the user. In some embodiments, the mail clients can be modified in order to validate the digital signatures as opposed to or in addition to the SMTP servers.

FIG. 50B is a block diagram of an improved entity-verification-certified-e-mail-digital-signature process 5002, according to some embodiments of the present invention. In process 5002, the authorization service 120 (see FIG. 1A and FIG. 3B) of the present invention is used to verify e-mail delivery.

In some embodiments, the entity's email server or email provider will be an authorized provider within the entity's authorization account. In some embodiments, out-bound messages will be digitally signed by the entity's email servers. The digital certificate will contain information about the type of entity and can be used to make email delivery decisions. In addition, the digital certificate will include the sending email address. The digital certificate will be generated using a certificate authority owned or approved by the authorization service. In some embodiments, out-bound email messages will be sent by any application used by the entity to send emails on its behalf.

The entity will authorize SMTP servers owned by the entity or by an email provider on their behalf to send and receive emails. Just like a user, the entity may set preferences that can be downloaded by the entity's authorized email servers and can be used to set in-bound email delivery preferences.

For out-bound emails, the entity's authorized email servers will digitally sign messages (or require said messages to already have been signed). The SMTP server will send the message to the receiving SMTP server based on the sending email address. In some embodiments, the sending server will include the public key as an attachment or in the message body. In some embodiments, the public key may be downloaded by the receiving server from the authorization service. The receiving SMTP server, authorized as a provider for the receiving user, will retrieve message receipt preferences on behalf of the receiving user. If emails are permitted from the entity, they will make the emails available to the user's client. If not, they will discard the message. The SMTP server, in some embodiments, will need to verify the digital signature before forwarding on the message.

In some embodiments, the entity's email system or their email service providers system will be responsible for accurately classifying messages during delivery based on the content. This can be a simple modification to any software handling emails on behalf of an entity. In some embodiments, email classification will be applied to the entity's authorization profile along with a message-id that can be verified by the receiving SMTP server (See FIG. 50D). In some embodiments, entities that fail to accurately classify out-bound email messages will be denied from continuing to use the authorization account for email delivery. This may result in an inability to deliver email messages.

In some embodiments, entities may include certified IP addresses within their authorization account that can be queried by receiving and sending SMTP servers in order to approve IP addresses that can be used to deliver emails to or receive emails from authorized SMTP servers. In some embodiments, current less secure methods such as DNS SPF or TXT records may still be used to verify authorized IP addresses for email delivery to and from domains.

FIG. 50C is a block diagram of an improved user-verification-certified-e-mail-using-message-id process 5003, according to some embodiments of the present invention. In process 5003, the authorization service 120 (see FIG. 1A and FIG. 3B) of the present invention is used to verify e-mail delivery.

This user has added her email services provider as a provider within her authorization account, authorizing it to send and receive email on her behalf. In some embodiments, the SMTP or email gateways are utilizing digital certificates generated by an acceptable certificate authority in order to securely communicate with the authorization service.

The user sends an out-bound email using an email or webmail program. The email gateway or SMTP server responsible for delivering messages on the behalf of the user will inform the authorization service of the message-id created during the process. In some embodiments, the message-id is the ID message-id currently generated by the SMTP protocol. In some embodiments, the message-id is a new identifier generated by the mail client or email gateway.

The SMTP server delivers the message to the receiving SMTP server. The receiving SMTP server preserves the message-id. The receiving SMTP server is authorized as a provider to send and receive email on behalf of the receiving user. The receiving SMTP server securely communicates to the authorization service. The receiving SMTP server validates the included message-id via the authorization service. Since the SMTP server is authorized to receive emails for the user, it is allowed to query the authorization service for a message-id associated with the senders email. If the message-id is validated as being stored by the sending user, the email is certified and delivered to the receiving user.

In some embodiments, the message-id will be stored for a defined amount of time to ensure users are not able to guess message-id values. In some embodiments, email verification may include validating both message-ids and digital signatures. In some embodiments, the functionality described within the email gateways may be implemented within email clients and web clients instead.

FIG. 50D is a block diagram of an improved entity-verification-certified-e-mail-using-message-id process 5004, according to some embodiments of the present invention. In process 5004, the authorization service 120 (see FIG. 1A and FIG. 3B) of the present invention is used to verify e-mail delivery.

In some embodiments, the entity will authorize SMTP servers owned by the entity or by an email provider on their behalf to send and receive emails. Just like a user, the entity may set preferences that can be downloaded by the entity's authorized email servers and can be used to set in-bound email delivery preferences.

For outbound messages, the entity's email gateway will insert a message-id. This can be the message-id that is currently a part of the SMTP protocol or may be a new unique ID assigned. In some embodiments, the message id will also include a e-mail type field that is used to classify the email. This can include, but is not limited to, customer notifications, marketing, mailing list inquiry etc. The receiving user or entity then may deny requests to deliver specific email types.

In some embodiments, the entity's email system or their email service providers system will be responsible for accurately classifying messages during delivery based on the content. This can be a simple modification to any software handling emails on behalf of an entity. Entities that fail to accurately classify out-bound email messages may be denied from continuing to use the authorization account for email delivery. This may result in an inability to deliver email messages for any users requiring certified email delivery.

The entity's authorized email gateway will deliver the message to the receivers authorized email gateway. In some embodiments, the senders SMTP gateway may use client authentication using digital certificates to connect to the receivers SMTP gateway. In some embodiments, the senders SMTP gateway will encrypt transport connectivity using normally accepted best practices such as using TLS encryption.

Once delivered, the receiving SMTP server will deliver based on authorization account preferences of the receiving email user. In some embodiments, entities will use both message-id and digital signatures outlined in diagrams 50B and 50D.

FIG. 50E is a block diagram of an improved entity-verification-certified-e-mail process 5005, according to some embodiments of the present invention. In process 5005, the authorization service 120 (see FIG. 1A and FIG. 3B) of the present invention is used to verify e-mail delivery.

In this example, an entity attempts to email a user. The user requires certified email delivery for both individual and entity emails. The entity has classified the message as a marketing email and has included the classification in a value stored in the entity's authorization account. The receiving SMTP server authorized to send and receive email messages on the receivers behalf communicates securely with the authorization service and is allowed to verify the received message-id. The message-id is correct, but the message-type created as a SMTP tag an also stored in the authorization account indicates that the message is marketing.

The receiving SMTP server drops the message based on preferences in the receiving user's SMTP profile. The user has decided to only allow certified email and OPT-IN marketing. The user has not authorized the entity to send emails to the user. In some embodiments, the SMTP server will cache preferences for users that it delivers email to and periodically refresh settings. In some embodiments, the SMTP server can discard the message based on preferences and the classification without connecting to the authorization service.

In some embodiments, email providers may set preferences in their authorization account to only receive email from certified entities as a general rule. In some embodiments, SMTP servers will periodically download certified IP addresses from the authorization service to get a list of SMTP servers who certify their identities.

In some embodiments, SMTP servers will only receive email from servers who connect using mutual authentication and digital certificates issued by the authorization service or a approved vendor who uses a certificate chain only for certified entities meeting the services standards.

FIG. 50F is a block diagram of an improved user-confirmation-phishing-and-virus-mitigation-e-mail process 5006, according to some embodiments of the present invention. In process 5006, the authorization service 120 (see FIG. 1A and FIG. 3B) of the present invention is used to verify e-mail delivery.

In this example, a user or email service provider has required that the user confirm any outbound messages that are sent including web links or attachments. When user's email accounts or personal devices are compromised, they are often times configured to send out malicious email. This can facilitate the spread of viruses and allow attackers a platform to launch phishing campaigns.

In some embodiments, the present invention is used to disable the ability to send out emails that include attachments or website links. In this example, the user (or a fraudulent user) has sent an outbound email. The user's email provider who is authorized to send email on the user's behalf and securely communicate with the authorization service requests approval from the user to send the message which contains web links or attachments. The user must confirm that the email including a web link or attachment should be sent within an allotted period of time. The user must also enter in a PIN number to confirm the delivery. If the timeout is reached, the user's SMTP server will discard the message.

In some embodiments, one confirmation will be sufficient to deliver an email addressed to multiple parties.

In this embodiment, the user will be aware that their email account or device has been compromised and that they should take action changing email passwords and cleaning any viruses from an infected system.

In some embodiments, this can be enforced with a provider or user policy. Entities will be more inclined to require approval from all of their employees to send attachments and web links. This will ensure that they are not the source of the spread of malicious emails.

In some embodiments, a similar process as outlined in FIGS. 50A-F can be followed to create certified text message delivery. In addition, it can be used to prevent Short Message Service (SMS) Phishing (also called Text Phishing or SMSishing). A similar integration will need to be followed with SMS providers.

FIG. 50G is a block diagram of an improved website-account-creation-certified-email-address process 5007, according to some embodiments of the present invention, which demonstrates a user who creates an account using a name and social security number. In this example, the user is creating an account using his PII that gives access to a banking website. The website uses the authorization-service process 120 (see FIG. 1A and FIG. 3B) of the present invention to prove identity. The banking website is authorized to make queries to the authorization service for the purpose of verifying certified email addresses. The website makes a secure connection to the authorization service. The name, social security number provided during the account creation (or a last four of the SSN) and e-mail address are passed to the authorization-service process 120. The mapping service finds the correct account based on the PII provided and lets the website know if the account has a certified e-mail address. If the provided email matches the certified email (or additional authorized email) in the user's profile, the registration email is sent to the address. The user will log in to his email and click on a link to complete the process. In this example, a fraudulent user would not be able to create a website account using PII of the user since the website is requiring certified email addresses for registration.

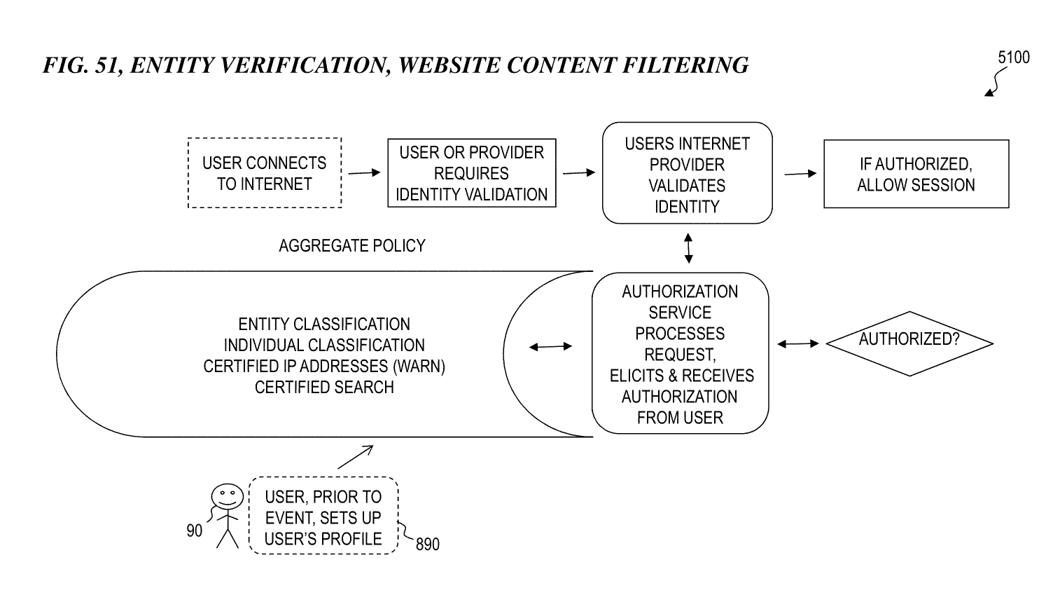

FIG. 51 is a block diagram of an improved entity-verification-for-certified-websites process 5100, according to some embodiments of the present invention. In process 5100, the authorization-service process 120 (see FIG. 1A and FIG. 3B) of the present invention is being used to classify website content and enforce certified browsing sessions.

Current content filtering solutions rely on content classification in order to set policy and make decisions around whether sites are safe to connect to. Content filtering is used very heavily within businesses and other entities to ensure users do not unsuspectingly go to malicious and inappropriate sites while at work. Unfortunately, content classification is normally accomplished in a reactive manner by teams of people who manually classify or analytical software that attempts to automatically classify. Again, a reactive measure.

In some embodiments of the present invention, entities will be required to enter their certified IP addresses, domain names and website names within their entity authorization account. Entities will then be required to classify their websites within their entity authorization accounts. In some embodiments, a governing body should be implemented and certified entities that do not properly classify their websites will run the risk of having their account disabled or face penalties.

Current technologies used to control access to the internet such as software firewalls, hardware based firewalls, next generation firewalls (GNAW) and content filtering appliances can integrate with the authorization service and download content classifications and categories from the service. In some embodiments, the classifications can be retrieved when a user attempts to connect to a website. In some embodiments, classifications may be cached or stored within the content filtering technology for a period of time. In some embodiments, content categories for regularly visited sites may be downloaded on a recurring bases. In some embodiments, private authorization service implementations may cache content categories.

In this example, the user connects to the internet. The users content filtering solution makes a DNS query for name resolution to IP address mapping. The user is requiring certified IP addresses to ensure they can only connect to individuals or entities who have certified their identity. The user or internet provider has created content policies that are appropriate for the entity or user. Content filtering solutions will allow connections based on content classification and only to appropriate sites based on their content policy. In this example, a user or entity is protected from connecting to any site that is brought online with malicious intent. Sites that are malicious and also use a certified entity or user will be easy to track and investigate. In some embodiments of the present invention, entities that provide Internet search services may provide certified search and only return results that have been properly validated.

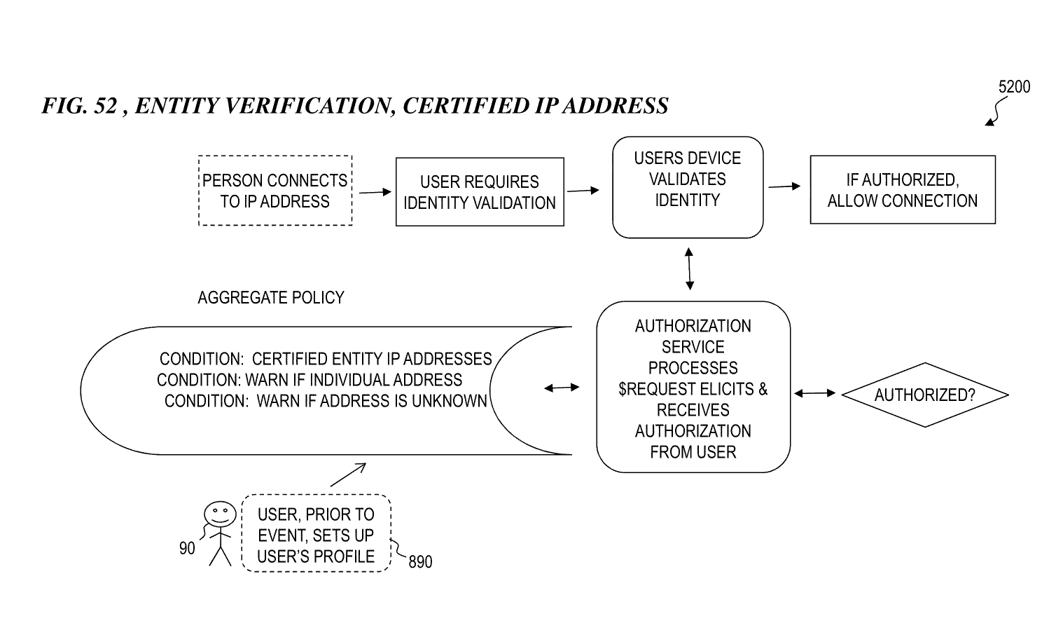

FIG. 52 is a block diagram of an improved entity-verification-for-certified-internet-address process 5200, according to some embodiments of the present invention. In process 5200, the authorization-service process 120 (see FIG. 1A and FIG. 3B) of the present invention is being used to verify IP addresses to which the user's device is trying to connect. Servers will register their IP address. This can be either a manual or automatic processes. For instance, an ISP who is responsible for assigning IP addresses may be required to do verify the company or individual they assigned the IP addresses to. The company or individual may claim ownership of the IP addresses in their entity authorization account profile. In some embodiments, the entity's firewalls, load-balancers, routers, Dynamic Host Configuration Protocol (DHCP) servers and other applicable devices or systems will be authorized to notify their authorization account of IP addresses being used for servers and websites.

In some embodiments, client devices and firewalls are configured to warn of, or block, connections made to or from or to an unverified source. Organizations responsible for assigning IPV4 and IPV6 IP addresses such as the American Registry for Internet Numbers (ARIN) and the corresponding RIPE (“Reseaux IP Europeens”) may also report ownership to the service, in some embodiments.

In this example, the client has authorized their computer's firewall to access the authorization service for the specific purpose of validating IP addresses and determining a connectivity policy. The entity has allowed other certified individual or entity accounts to ask if a particular IP address is theirs. In some embodiments, the answer may be cached by the client or other entity's device in order to reduce inquiry traffic. The user has indicated that they would like to be warned when connecting to any server on the Internet that is unknown or an individual identity. This will increase visibility when the user is connecting to websites or servers on the internet.

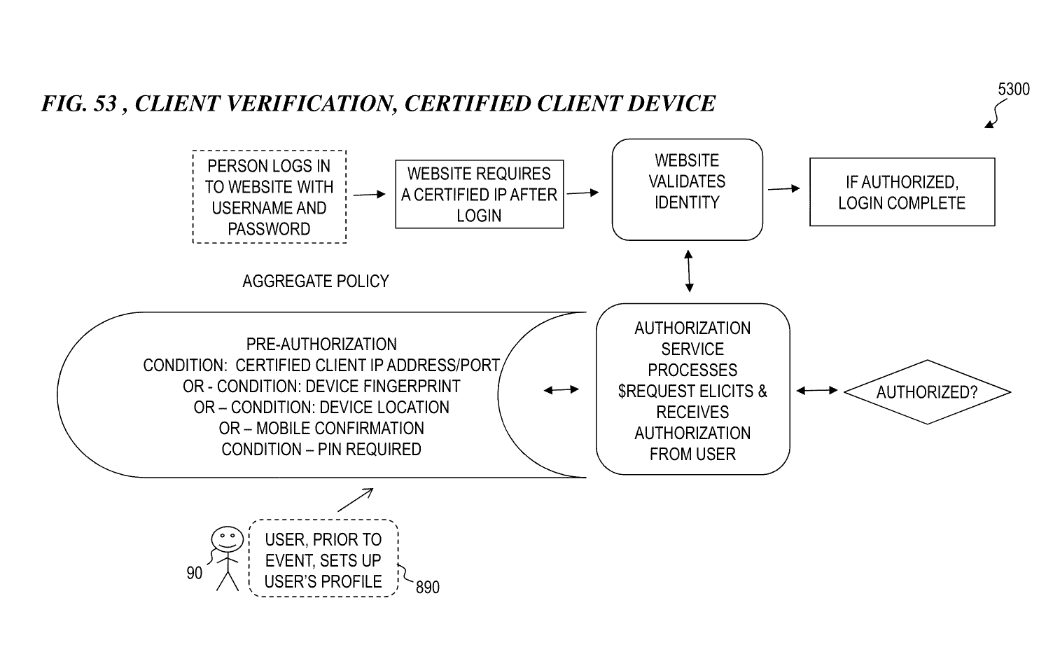

FIG. 53 is a block diagram of an improved client-verification-for-certified-client-device process 5300, according to some embodiments of the present invention. In process 5300, the authorization-service process 120 (see FIG. 1A and FIG. 3B) of the present invention is being used to verify IP addresses to which the user's device is using while connecting to a website.

In this example, the client uses an application on their desktop that is able to connect to the user's authorization service. The desktop application in this example can be used to approve or reject requests and provide information to the authorization service regarding the user's registered desktop. The application's access to the authorization service can be secured with multiple factors, including, but not limited to, account password, authorization password, PIN and digital certificate.

The application, owned and secured by the user, has been configured to periodically report GPS coordinates using an integrated GPS device or WIFI tracking to the user's authorization service. The application also generates a fingerprint generated from information unique to the device and stores it within the user's authorization account. Access to the account from the application is sourced by the active IP address being used by the client. The authorization service stores the IP address when connections are successful and authenticated. In some embodiments, the authorization service may also store the source IP and port combination in order to identify a client when it is connecting to the internet using a private network that uses Source Network Address Translation (SNAT) in order to share one public IP address with multiple clients. In some embodiments, the authorization service will use x-forwarded-for http headers to preserve source IP address information in the event that SNAT is being used within the authorization service network.

The user has previously indicated within his website profile that he would like to enable multi-factor authentication by using his authorization account in addition to the username and password maintained by the website. In some embodiments of the present invention, a password would not be required to log in to the website.

In this example, the user connects to a website and proceeds to log in using a username and password maintained by the website. The website securely connects to the authorization service as a provider. The website account was created using PII such as name, DOB, last four of a SSN, etc. The website queries the authorization service using PII of the individual and once the authorization service matches the PII to the appropriate user, it passes back a reference such as an account number that the website can use for subsequent lookups.

The website may choose to generate a device fingerprint using a similar process that the local application uses, alternatively, it may ask to receive GPS coordinates from the device. Finally, it may record the client source IP address and port combination being used to access the website. In some embodiments, the website may need to use an x-forwarded-for header in order to preserve source IP information when using SNAT within the websites network.

When the website queries the authorization network, it will provide the source IP address and port combination, device fingerprint or device GPS coordinates it obtained from the client. The authorization service will match the information received with what has been stored in the service. If there is a match or the GPS coordinates are within allowed tolerance, the user will be allowed to continue logging in.

Based on the user's profile, he may also use a mobile confirmation with a PIN on order to complete the log in. Some embodiments may also include the ability to simply toggle “authorize website login” on the desktop or mobile device authorization application. Once authenticated, the user would toggle off the login.

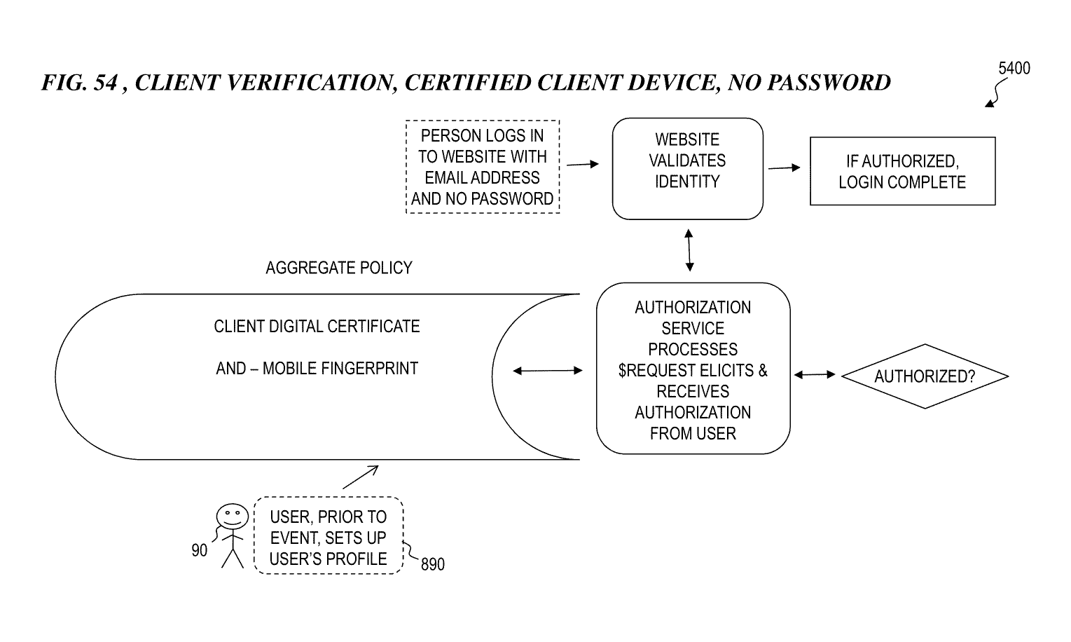

FIG. 54 is a block diagram of an improved client-verification-for-certified-client-device-no-password process 5400, according to some embodiments of the present invention. In process 5400, the authorization-service process 120 (see FIG. 1A and FIG. 3B) of the present invention is being used to verify user's device while connecting to a website.

In this example, the user is using a laptop that has installed a non-exportable client-side-certificate generated from the authorization account. Some embodiments may require the user to download and install the digital certificate from the authorization website. Some may require the user to install the digital certificate from the authorization application that may be installed on the laptop. The certificate was signed by a certificate authority that is used by the authorization service. The certificate chain used only signs certificates for users owning an authorization account and who have had their identities properly verified.

In this example, the website only requires the user to enter an e-mail address or username to log in to the website. The website only allows connections from users who have valid digital certificates installed that are signed by a certificate authority used by the authorization service. Other users will not even see the login page of the site. Once at the login page, the user enters her e-mail address and attempts to log in. The website connects to the authorization service as a provider and has set the provider policy of “mobile fingerprint required”. The provider has also set a condition that the user must apply the fingerprint on a different device then the one used to connect to the website. The user opens up the authorization application on her mobile phone and proceeds to verify the fingerprint.

Once complete, the user is allowed to log in to the website. In this example, the website is protected from application-based distributed-denial-of-service attacks (DDOS) since a user cannot connect without a digital certificate signed by a certificate authority used by the authorization service.

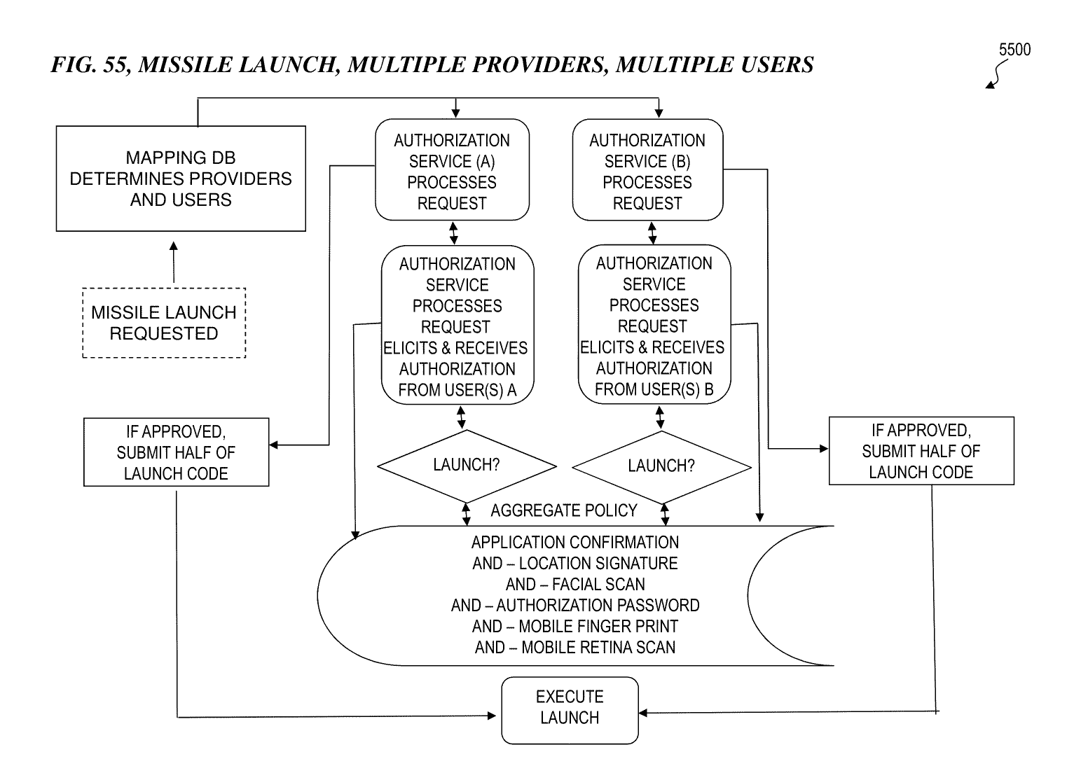

FIG. 55 is a block diagram of an improved missile-launch-authentication process 5500, according to some embodiments of the present invention. In process 5500, the authorization-service process 120 (see FIG. 1A and FIG. 3B) of the present invention is used to verify the authority of particular individuals to perform actions when the government would like to launch a missile. Since this is a very sensitive event, the government has decided to use to security contractors. One that is responsible for holding half of the launch code and hosting an authorization service. The second has the other half and also hosts an authorization service. Also, in this example, the services are private and the mobile devices require client-side authentication along with virtual private network (VPN) connection from the mobile device.

In some embodiments, the missile launch requires approval from 50% of the four-star generals and any five-star generals in existence. It also requires approval from the president of the United States. The generals and the president have a device registered with each authorization account and are required to provide application confirmation in both. They are also required to submit a location signature and facial scan to one of the services. They are required to submit an authorization password, mobile finger print and mobile retina scan using a specialized device in the second service.

Once all approvals are obtained, the launch code is delivered and the missile can be fired by physically having someone press the button. This is an example of a very thorough and complex approval process using the present invention. It involves multiple providers, multiple authorization accounts and multiple authentication factors.

In order to attack this system, an attacker would have to compromise one or more defense contractors' networks and the physical launch site. Alternatively, they would have to compromise the physical launch site and enough of the approvers to confirm the launch. The users would also need to be persuaded to submit to the numerous authentication factors required for approval.

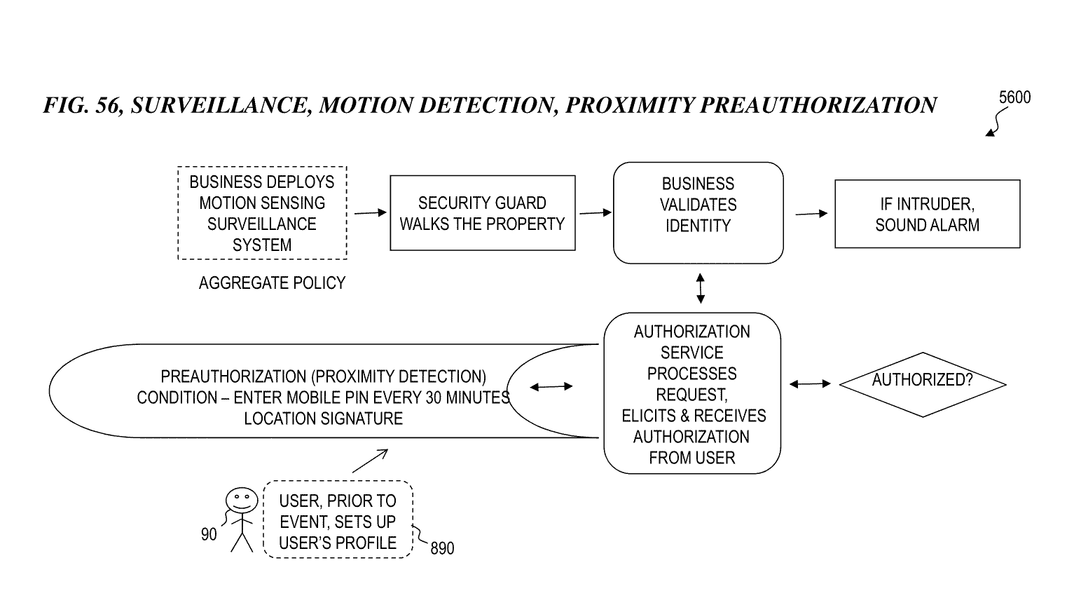

FIG. 56 is a block diagram of an improved surveillance-motion-detection-proximity-preauthorization process 5600, according to some embodiments of the present invention. In process 5600, the authorization-service process 120 (see FIG. 1A and FIG. 3B) of the present invention is used to bypass motion detection by using proximity detection. Any suitable technology capable of motion detection may be used for proximity detection. In some embodiments, an infrared motion sensor is used. In some embodiments, a CCTV motion detection is used. In some embodiments, motion detection using thermal imaging cameras is used.

In this example, the organization has a private authorization service implementation (See FIGS. 1B and 1C). The private authorization service is using the local location database to track location of authorized users with its own wireless implementation. Access points installed within the facility are able to accurately triangulate the position of users and report them to the location service. The user's mobile device has an increased polling-interval to ensure up-to-date location. The surveillance cameras and motion sensors are able to invoke alarms based on motion that automatically send alerts to the alarm monitoring company.

The system 5600 is configured with a tolerance based on the polling-interval of both the wireless access-points and the client check-in rate. The surveillance system predicts the direction the user is walking and suppresses any alarms for the specific user. In this example, the user must enter his PIN within every 30 minutes to ensure that a mobile device was not misplaced and used to gain access.

In some embodiments, a user may be required to play back a location signature in order to maintain the alarm suppression. An example use of this would be a security guard that has to walk a specific path at a particular time and within a certain amount of time. If the signature is played back incorrectly, the guard is considered compromised.

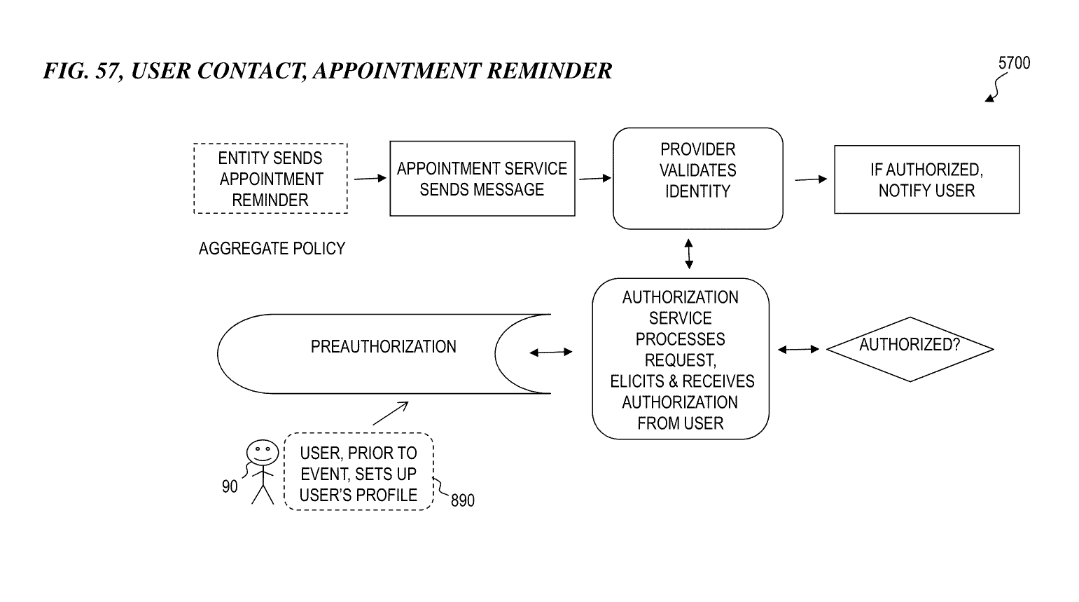

FIG. 57 is a block diagram of an improved user-contact-appointment-reminder process 5700, according to some embodiments of the present invention. In process 5700, the authorization-service process 120 (see FIG. 1A and FIG. 3B) of the present invention is used to inform a user of an upcoming appointment.

In some embodiments, a business that specializes in customer contact may function as a provider for the appointment reminder. In some embodiments, entities themselves will be able to directly message the user from their entity authorization account.

In this example, the user must preauthorize any providers that they would like to allow communication regarding upcoming appointments. The user adds the provider and indicates that the provider is authorized to send reminders for the user and the user's dependants. The user creates a user policy that states the type of alerts that will be used. In this example, the user chooses an email alert and application pop-up.

The provider can see the users they are authorized to notify within their authorization account and are able to send the reminder message with conditions such as time.

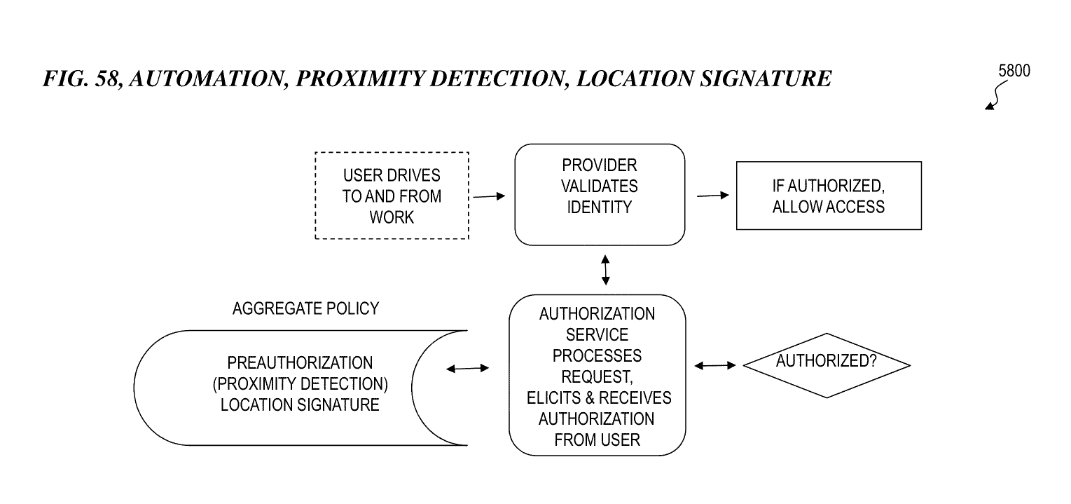

FIG. 58 is a block diagram of an improved automation-proximity-detection-location-signature process 5800, according to some embodiments of the present invention. In process 5800, the authorization-service process 120 (see FIG. 1A and FIG. 3B) of the present invention is used to inform a user of an upcoming appointment.

In this example, the authorization service has integrated with OnStar™ and the user's mobile phone is also providing coordinates. The car manufacturer has released an ECU upgrade that takes advantage of the technology as well.

The user leaves for work and once her vehicle and mobile phone are out of the driveway, her home automation system is configured to lock all doors and close the garage door. In some embodiments, the car will not start without the mobile phone reporting that it is in the same location (within defined tolerance) of the car. This ensures that the car cannot be stolen without access to the mobile phone. If the mobile phone is forgotten, the car manufacturer has included a special integration where the user's PIN number is synchronized and stored locally within the vehicle's EEPROM (electrically erasable and programmable read-only memory). The PIN can be used, along with the key, to start the car in the event proximity cannot be detected.

When the user drives home, the OnStar™ integration plays back a previously recorded location signature that is configured to open up the user's garage door, unlock the garage entry door and turn on the lights.

In some embodiments, database 215 (see FIG. 2A) is the base of the system. In some embodiments, database 215 includes a plurality of secured accounts, each one of which is owned solely by an individual user 90, and contains the Social Security Number (SSN), Employer Identification Number (EIN), bank account information, payment card information, gift card information, charge card information, checking account information, healthcare account information and the like.

FIG. 2B depicts a trust loop 202, a key component of some embodiments of the present invention. The trust loop is the process of taking action and then confirming that action. If another individual takes action, the user's secure account is checked for approval and, because one or more factors for authorization will not be satisfied, the transaction will be denied, logged and the user will be alerted. In some embodiments, requests are routed to the appropriate authorization account based on the PII. In some embodiments, the Provider Authorization Policy 325 (see FIG. 3A) allows providers to impose specific authorization-profile settings in order to use their service.

In some embodiments, the account owner's user authorization policy 320 (see FIG. 3A) allows each owner (user 90) to customize and/or enhance security by stacking as many factors as they would like.

In some embodiments, the present invention provides a computerized method for enhanced authentication. This method includes receiving, into a computer system, a request to perform an electronic transaction for an identified human user at a location remote from the computer system; accessing, by the computer system, a set of authentication criteria of the identified human user from a database that contains authentication criteria of the identified human user and a plurality of other users; retrieving, into the computer system, a plurality of real-time authentication parameters relevant to the human user and to the transaction; and comparing, by the computer system, the plurality of retrieved real-time authentication parameters to the accessed set of authentication criteria of the identified human user and based on the comparing of the real-time authentication parameters, either authorizing an action to complete the electronic transaction or withholding the authorization. Some embodiments further include eliciting and receiving, into a computer system, personal identification information of a human user and authentication criteria customization information from the human user; and customizing, in the database of the computer system, a user account (e.g., a policy that controls the PII and whether certain transactions are allowed (and the conditions for allowance) or restricted) for the human user that includes a set of authentication criteria of the identified human user based on the received authentication criteria customization information from the human user.

Some embodiments of this method further include retrieving, into the computer system, a plurality of previously stored authentication parameters relevant to the human user and to the transaction; and comparing, by the computer system, the plurality of retrieved previously stored authentication parameters to the accessed set of authentication criteria of the identified human user and based on the comparing of the previously stored authentication parameters, either authorizing an action to complete the electronic transaction or withholding the authorization.

Some embodiments of this method further include transmitting, to a first personal electronic device of the human user, a real-time alert of the request to perform the electronic transaction; displaying, on the first personal electronic device of the human user, an indication of the real-time alert of the request to perform the electronic transaction; and eliciting and receiving a real-time authorization indication from the human user using the first personal electronic device of the human user, wherein the retrieving of the plurality of real-time authentication parameters relevant to the human user and to the transaction includes retrieving the real-time authorization indication from the human user.

Some embodiments of this method further include communicating between a first personal electronic device of the human user and a second personal electronic device of the human user, and based on the communicating determining a proximity of the first personal electronic device to the second personal electronic device; and eliciting and receiving a real-time authorization indication from the human user using the personal electronic device of the human user.

Some embodiments of the present invention use a single account to verify and validate the user's identity and protect the user's identity, password, SSN or NIN. In some embodiments, this strips sensitivity from the number since the number is not useful by itself.

Some embodiments of the present invention use one account that connects and certifies a particular e-mail address as a legitimate source for incoming e-mail.

In some embodiments, the present invention provides a method to authenticate and authorize an electronic transaction. In some embodiments, the requested electronic transaction includes accessing an account number of the user. In some embodiments, the requested electronic transaction includes accessing a social security number of the user. In some embodiments, the requested electronic transaction includes accessing protect a national identification (ID) number of the user. In some embodiments, the requested electronic transaction includes hiding an individual identity of the user. In some embodiments, the retrieved authentication factors include multiple authentication factors that include an account number received from the user to authorize a request.

Some embodiments further include creating a digital identifier (ID) derived from combining the use of a single account and multiple authentication factors to protect and individual's identity. Some embodiments further include using the digital ID to verify a certified shipping address and authorized shipping addresses. Some embodiments further include using the digital ID to verify a certified e-mail address associated with the user. Some embodiments further include using the digital ID to verify a certified telephone number. Some embodiments further include using the Digital ID to perform a digital signature. Some embodiments further include using an entity digital ID to create a certified website. Some embodiments further include using an entity digital ID to create a certified entity e-mail address.

Some embodiments further include combining (also called stacking) multiple accounts (e.g., a child's account along with the child's parent's account) along with multiple authentication factors to authorize a request. Some embodiments further include combining (also called stacking) multiple providers in order to increase security.

Some embodiments further include setting transaction limits based on which authentication factor was used (i.e., if the user chooses to use a PIN, the system of the present invention allows the user to take out up to $500, while if the user chooses to use an authorization password, the system of the present invention allows the user to withdraw up to the maximum limit of money that can be withdrawn).

In some embodiments, the present invention provides replication of provider-specific information. Example, if a user 90 has set a specific policy or criteria for a credit-card transaction, the information specifying those criteria are replicated inside a computer system of particular selected providers 150. In some embodiments, the present invention provides setting of a user's location 80 using social media check-in integration.

In some embodiments, the present invention provides the ability to inform merchants of the user's desired security level. Thus, a particular user can customize their profile with authorization criteria that suits that user (e.g., the user can specify that all transactions must require Card Security Code (CSC, CVV2 or the like). In some embodiments, this is only needed for in-band authentication methods such as entering a PIN or CVV2. In some embodiments, out-of-band authentication methods, such as mobile confirmation, can be required without the need to input the CSC.

In some embodiments, a user can customize their profile to allow the user to use a single PIN for all transactions, not just a bank-card transaction. The user sets the PIN in their account and can then use it for all banks that user does business with. The user will no longer need to store their PIN.

In some embodiments, the present invention provides a computerized method for enhanced authentication. This method includes eliciting and receiving, into a computer system, personal identification information of an identified human user and authentication-criteria-customization information from the human user; customizing, in a database of the computer system, a user account for the human user, wherein the user account includes a set of authentication criteria of the identified human user for each one of a plurality of transaction types based on the received authentication-criteria-customization information from the human user; receiving, into the computer system, a request to perform an electronic transaction for the identified human user at a location remote from the computer system; accessing, by the computer system, the set of authentication criteria of the identified human user from the database based on a type of the transaction; retrieving, into the computer system, a plurality of real-time authentication parameters relevant to the human user and to the transaction; and comparing, by the computer system, the plurality of retrieved real-time authentication parameters to the accessed set of authentication criteria of the identified human user and based on the comparing of the real-time authentication parameters, either authorizing an action to complete the electronic transaction or withholding the authorization.

Some embodiments of this method further include transmitting, to a first personal electronic device of the human user, a real-time alert of the request to perform the electronic transaction; displaying, on the first personal electronic device of the human user, an indication of the real-time alert of the request to perform the electronic transaction; and eliciting and receiving a real-time authorization indication from the human user using the first personal electronic device of the human user, wherein the retrieving of the plurality of real-time authentication parameters relevant to the human user and to the transaction includes retrieving the real-time authorization indication from the first personal electronic device of the human user. Some embodiments of this method further include communicating between a first personal electronic device of the human user and a second personal electronic device of the human user, and based on the communicating determining a proximity of the first personal electronic device to the second personal electronic device, wherein the retrieving of the plurality of real-time authentication parameters includes retrieving the proximity indication.

In some embodiments of the method, the customizing of the user account further includes storing a plurality of parameters received from the human user that are associated with one or more particular types of transactions, and the method further includes retrieving, into the computer system, a plurality of previously stored authentication parameters relevant to the human user and to the transaction; and comparing, by the computer system, the plurality of retrieved previously stored authentication parameters to the accessed set of authentication criteria of the identified human user and based on the comparing of the previously stored authentication parameters, either authorizing an action to complete the electronic transaction or withholding the authorization. In some embodiments of the method, the set of authentication criteria include at least three criteria selected from the group consisting of: receiving from the user entry of a PIN, receiving fingerprint data of the user from a mobile personal electronic device, receiving authorization from the user who entered an indication of the authorization on their mobile personal electronic device, detection of a proximity of a plurality of the user's personal electronic devices, detection of a location of one or more of the user's personal electronic devices, reception of a trust ticket from the user, and reception of an e-mail approval from the user.

In some embodiments of the method, the customizing of the user account further includes storing a plurality of parameters received from a provider of services other than the user. In some embodiments of the method, the customizing of the user account further includes storing a plurality of parameters received from a custodian of the user other than the user.

In some embodiments, the present invention provides a computerized apparatus for enhanced authentication. This apparatus includes: an interface that elicits and receives, into a computer system, personal identification information of an identified human user and authentication-criteria-customization information from the human user; a user-account customization module that customizes, in a database of the computer system, a user account for the human user, wherein the user account includes a set of authentication criteria of the identified human user for each one of a plurality of transaction types based on the received authentication-criteria-customization information from the human user; a telecommunications interface operatively configured to receive, into the computer system, a request to perform an electronic transaction for the identified human user at a location remote from the computer system; an access interface in the computer system operatively configured to access the set of authentication criteria of the identified human user from the database based on a type of the transaction; a retriever unit in the computer system operatively configured to retrieve a plurality of real-time authentication parameters relevant to the human user and to the transaction; and a comparator in the computer system operatively configured to compare the plurality of retrieved real-time authentication parameters to the accessed set of authentication criteria of the identified human user and based on the comparison of the real-time authentication parameters, configured to either authorize an action to complete the electronic transaction or to withhold the authorization.

Some embodiments of this apparatus further include: a transmitter in the computer system operatively configured to transmit, to a first personal electronic device of the human user, a real-time alert of the request to perform the electronic transaction; and a display, on the first personal electronic device of the human user, that displays an indication of the real-time alert of the request to perform the electronic transaction, wherein the first personal electronic device of the human user is operatively configured to elicit and receive a real-time authorization indication from the human user to the first personal electronic device, wherein the retriever unit is operatively configured to retrieve the real-time authorization indication from the first personal electronic device of the human user.

In some embodiments of the apparatus, a first personal electronic device of the human user is configured to communicate with a second personal electronic device of the human user, and based on the communication, to determine a proximity of the first personal electronic device to the second personal electronic device, and the retriever unit is further configured to retrieve the proximity indication.

In some embodiments of the apparatus, the user-account customization module further stores a plurality of parameters received from the human user that are associated with one or more particular types of transactions, the retriever unit is further configured to retrieve a plurality of the stored authentication parameters relevant to the human user and to the transaction, and the comparator further compares the plurality of retrieved previously stored authentication parameters to the accessed set of authentication criteria of the identified human user and based on the comparison of the previously stored authentication parameters, either authorizes an action to complete the electronic transaction or withholds the authorization.

In some embodiments of the apparatus, the set of authentication criteria include at least three criteria selected from the group consisting of: receiving from the user entry of a PIN, receiving fingerprint data of the user from a mobile personal electronic device, receiving authorization from the user who entered an indication of the authorization on their mobile personal electronic device, detection of a proximity of a plurality of the user's personal electronic devices, detection of a location of one or more of the user's personal electronic devices, reception of a trust ticket from the user, and reception of an e-mail approval from the user.

In some embodiments of the apparatus, the user-account customization module that customizes the user account further stores a plurality of parameters received from a provider of services other than the user. In some embodiments of the apparatus, the user-account customization module that customizes the user account further stores a plurality of parameters received from a custodian of the user other than the user.

In some embodiments, the present invention provides a non-transitory computer-readable medium having stored thereon instructions that cause a suitably programmed computer system to perform a method that includes: eliciting and receiving, into a computer system, personal identification information of an identified human user and authentication-criteria-customization information from the human user; customizing, in a database of the computer system, a user account for the human user, wherein the user account includes a set of authentication criteria of the identified human user for each one of a plurality of transaction types based on the received authentication-criteria-customization information from the human user; receiving, into the computer system, a request to perform an electronic transaction for the identified human user at a location remote from the computer system; accessing, by the computer system, the set of authentication criteria of the identified human user from the database based on a type of the transaction; retrieving, into the computer system, a plurality of real-time authentication parameters relevant to the human user and to the transaction; and comparing, by the computer system, the plurality of retrieved real-time authentication parameters to the accessed set of authentication criteria of the identified human user and based on the comparing of the real-time authentication parameters, either authorizing an action to complete the electronic transaction or withholding the authorization.

In some embodiments of the computer-readable medium, the instructions stored thereon further cause the method to perform: transmitting, to a first personal electronic device of the human user, a real-time alert of the request to perform the electronic transaction; displaying, on the first personal electronic device of the human user, an indication of the real-time alert of the request to perform the electronic transaction; and eliciting and receiving a real-time authorization indication from the human user using the first personal electronic device of the human user, wherein the retrieving of the plurality of real-time authentication parameters relevant to the human user and to the transaction includes retrieving the real-time authorization indication from the first personal electronic device of the human user.

In some embodiments of the computer-readable medium, the instructions stored thereon further cause the method to perform: communicating between a first personal electronic device of the human user and a second personal electronic device of the human user, and based on the communicating determining a proximity of the first personal electronic device to the second personal electronic device, wherein the retrieving of the plurality of real-time authentication parameters includes retrieving the proximity indication.

In some embodiments of the computer-readable medium, the instructions stored thereon further cause the method to perform such that the customizing of the user account further includes storing a plurality of parameters received from the human user that are associated with one or more particular types of transactions, and to cause the method to further include: retrieving, into the computer system, a plurality of previously stored authentication parameters relevant to the human user and to the transaction; and comparing, by the computer system, the plurality of retrieved previously stored authentication parameters to the accessed set of authentication criteria of the identified human user and based on the comparing of the previously stored authentication parameters, either authorizing an action to complete the electronic transaction or withholding the authorization.

In some embodiments of the computer-readable medium, the set of authentication criteria include at least three criteria selected from the group consisting of: receiving from the user entry of a PIN, receiving fingerprint data of the user from a mobile personal electronic device, receiving authorization from the user who entered an indication of the authorization on their mobile personal electronic device, detection of a proximity of a plurality of the user's personal electronic devices, detection of a location of one or more of the user's personal electronic devices, reception of a trust ticket from the user, and reception of an e-mail approval from the user.

In some embodiments of the computer-readable medium, the customizing of the user account further includes storing a plurality of parameters received from a provider of services other than the user.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. A computerized method for enhanced authentication, the method comprising:
eliciting and receiving, into a computer system, personal identification information of a plurality of identified human users including a first identified human user and authentication-criteria-customization information from each one of the plurality of identified human users, wherein the personal identification information of the first identified human user includes an authorized shipping address for the first identified human user;
customizing, in a database of the computer system, a user account for the first identified human user, wherein the user account includes a different set of authentication criteria of the first identified human user for each one of a first plurality of different electronic purchase transaction types based on the received authentication-criteria-customization information from the first identified human user, wherein a first set of criteria for a first type of the first plurality of different electronic purchase transaction types includes at least a verification of a real-time location of a first personal electronic device of the first identified human user relative to a location of a brick-and-mortar store where the first type of electronic purchase transaction occurs, and wherein a second set of criteria for a second type of the first plurality of different electronic purchase transaction types includes at least a verification of the authorized shipping address of the first identified human user during an online electronic purchase transaction;
receiving, into the computer system, a request to perform an electronic purchase transaction by the first identified human user at a location remote from the computer system;
accessing, by the computer system, at least one of the sets of authentication criteria of the first identified human user from the database based on a type of the electronic purchase transaction;
retrieving, into the computer system, at least one real-time authentication parameter relevant to the first identified human user and to the electronic purchase transaction, wherein the retrieving of the at least one real-time authentication parameter includes retrieving the real-time location of the first personal electronic device of the first identified human user for the first type of electronic purchase transaction, and retrieving the authorized shipping address for the second type of electronic purchase transaction; and
comparing, by the computer system, the plurality of retrieved real-time authentication parameters to the accessed set of authentication criteria of the first identified human user and based on the comparing of the real-time authentication parameters, either authorizing an action to complete the electronic purchase transaction or withholding the authorization.

2. The method of claim 1, further comprising:
transmitting, to the first personal electronic device of the first identified human user, a real-time alert of the request to perform the electronic purchase transaction;
displaying, on the first personal electronic device of the first identified human user, an indication of the real-time alert of the request to perform the electronic purchase transaction; and
eliciting and receiving a real-time authorization indication from the first identified human user using the first personal electronic device of the first identified human user, wherein the retrieving of the plurality of real-time authentication parameters relevant to the first identified human user and to the electronic purchase transaction includes retrieving the real-time authorization indication from the first personal electronic device of the first identified human user.

3. The method of claim 1, further comprising:
communicating between the first personal electronic device of the first identified human user and a second personal electronic device of the first identified human user, and based on the communicating determining a proximity of the first personal electronic device to the second personal electronic device, wherein the retrieving of the plurality of real-time authentication parameters includes retrieving the proximity indication.

4. The method of claim 1, wherein the customizing of the user account further includes storing a plurality of authentication parameters received from the first identified human user that are associated with each one of the first plurality of different transaction types, the method further comprising:
retrieving, into the computer system, a plurality of previously stored authentication parameters relevant to the first identified human user and to the electronic purchase transaction; and
comparing, by the computer system, the plurality of retrieved previously stored authentication parameters to the accessed set of authentication criteria of the first identified human user and based on the comparing of the previously stored authentication parameters, either authorizing an action to complete the electronic purchase transaction or withholding the authorization.

5.-7. (canceled)

8. A computerized apparatus for enhanced authentication, the apparatus comprising:
an interface that elicits and receives, into a computer system, personal identification information of a plurality of identified human users including a first identified human user and authentication-criteria-customization information from the first identified human user wherein the personal identification information of the first identified human user includes an authorized shipping address for the first identified human user;
a user-account customization module that customizes, in a database of the computer system, a user account for the first identified human user, wherein the user account includes a different set of authentication criteria of the first identified human user for each one of a first plurality of different transaction types based on the received authentication-criteria-customization information from the first identified human user, wherein a first set of criteria for a first type of the first plurality of different electronic purchase transaction types includes at least a verification of a real-time location of a first personal electronic device of the first identified human user relative to a location of a brick-and-mortar store where the first type of electronic purchase transaction occurs, and wherein a second set of criteria for a second type of the first plurality of different electronic purchase transaction types includes at least a verification of an authorized shipping address of the first identified human user during an online electronic purchase transaction;
a telecommunications interface operatively configured to receive, into the computer system, a request to perform an electronic purchase transaction by the first identified human user at a location remote from the computer system;
an access interface in the computer system operatively configured to access at least one of the sets of authentication criteria of the first identified human user from the database based on a type of the electronic purchase transaction;
a retriever unit in the computer system operatively configured to retrieve at least one real-time authentication parameter relevant to the first identified human user and to the electronic purchase transaction, wherein the retrieval of the at least one real-time authentication parameter includes retrieval of the real-time location of the first personal electronic device of the first identified human user for the first type of electronic purchase transaction, and retrieval of the authorized shipping address of the first identified human user for the second type of electronic purchase transaction; and
a comparator in the computer system operatively configured to compare the plurality of retrieved real-time authentication parameters to the accessed set of authentication criteria of the first identified human user and based on the comparison of the real-time authentication parameters, configured to either authorize an action to complete the electronic purchase transaction or to withhold the authorization.

9. The apparatus of claim 8, further comprising:
a transmitter in the computer system operatively configured to transmit, to the first personal electronic device of the first identified human user, a real-time alert of the request to perform the electronic purchase transaction; and
a display, on the first personal electronic device of the first identified human user, that displays an indication of the real-time alert of the request to perform the electronic purchase transaction, wherein the first personal electronic device of the first identified human user is operatively configured to elicit and receive a real-time authorization indication from the first identified human user to the first personal electronic device, wherein the retriever unit is operatively configured to retrieve the real-time authorization indication from the first personal electronic device of the first identified human user.

10. The apparatus of claim 8, wherein the first personal electronic device of the first identified human user is configured to communicate with a second personal electronic device of the first identified human user, and based on the communication, to determine a proximity of the first personal electronic device to the second personal electronic device, and wherein the retriever unit is further configured to retrieve the proximity indication.

11. The apparatus of claim 8,
wherein the user-account customization module further stores a plurality of authentication parameters received from the first identified human user that are associated with each one of the first plurality of different types of transactions,
wherein the retriever unit is further configured to retrieve a plurality of the stored authentication parameters relevant to the first identified human user and to the electronic purchase transaction, and
wherein the comparator further compares the plurality of retrieved previously stored authentication parameters to the accessed set of authentication criteria of the first identified human user and based on the comparison of the previously stored authentication parameters, either authorizes an action to complete the electronic purchase transaction or withholds the authorization.

12. (canceled)

13. The apparatus of claim 8, wherein the user-account customization module that customizes the user account further stores a plurality of parameters received from a provider of services other than the first identified human user, and wherein the retriever unit that is configured to retrieve the plurality of previously stored authentication parameters relevant to the first identified human user and to the electronic purchase transaction is configured to retrieve at least one of the plurality of parameters received from a provider of services other than the first identified human user.

14. (canceled)

15. A non-transitory computer-readable medium having stored thereon instructions that cause a suitably programmed computer system to perform a method, the method comprising:
eliciting and receiving, into a computer system, personal identification information of a plurality of identified human users including a first identified human user and authentication-criteria-customization information from the first identified human user, wherein the personal identification information of the first identified human user includes an authorized shipping address for the first identified human user;
customizing, in a database of the computer system, a user account for the first identified human user, wherein the user account includes a different set of authentication criteria of the first identified human user for each one of a first plurality of different transaction types based on the received authentication-criteria-customization information from the first identified human user wherein a first set of criteria for a first type of the first plurality of different electronic purchase transaction types includes at least a verification of a real-time location of a first personal electronic device of the first identified human user relative to a location of a brick-and-mortar store where the first type of electronic purchase transaction occurs, and wherein a second set of criteria for a second type of the first plurality of different electronic purchase transaction types includes at least a verification of the authorized shipping address of the first identified human user during an online electronic purchase transaction;
receiving, into the computer system, a request to perform an electronic purchase transaction by the first identified human user at a location remote from the computer system;
accessing, by the computer system, at least one of the sets of authentication criteria of the first identified human user from the database based on a type of the electronic purchase transaction;
retrieving, into the computer system, a plurality of real-time authentication parameters relevant to the first identified human user and to the electronic purchase transaction, wherein the retrieving of the at least one real-time authentication parameter includes retrieving the real-time location of the first personal electronic device of the first identified human user for the first type of electronic purchase transaction, and retrieving the authorized shipping address for the second type of electronic purchase transaction; and
comparing, by the computer system, the plurality of retrieved real-time authentication parameters to the accessed set of authentication criteria of the first identified human user and based on the comparing of the real-time authentication parameters, either authorizing an action to complete the electronic purchase transaction or withholding the authorization.

16. The computer-readable medium of claim 15, wherein the instructions stored thereon further cause the method to perform:
transmitting, to the first personal electronic device of the first identified human user, a real-time alert of the request to perform the electronic purchase transaction;
displaying, on the first personal electronic device of the first identified human user, an indication of the real-time alert of the request to perform the electronic purchase transaction; and
eliciting and receiving a real-time authorization indication from the first identified human user using the first personal electronic device of the first identified human user, wherein the retrieving of the plurality of real-time authentication parameters relevant to the first identified human user and to the electronic purchase transaction includes retrieving the real-time authorization indication from the first personal electronic device of the first identified human user.

17. The computer-readable medium of claim 15, wherein the instructions stored thereon further cause the method to perform:
communicating between the first personal electronic device of the first identified human user and a second personal electronic device of the first identified human user, and based on the communicating determining a proximity of the first personal electronic device to the second personal electronic device, wherein the retrieving of the plurality of real-time authentication parameters includes retrieving the proximity indication.

18. The computer-readable medium of claim 15, wherein the instructions stored thereon further cause the method to perform such that the customizing of the user account further includes storing a plurality of authentication parameters received from the first identified human user that are associated with each one of the plurality of different types of transactions, the method further comprising:
retrieving, into the computer system, a plurality of previously stored authentication parameters relevant to the first identified human user and to the electronic purchase transaction; and
comparing, by the computer system, the plurality of retrieved previously stored authentication parameters to the accessed set of authentication criteria of the first identified human user and based on the comparing of the previously stored authentication parameters, either authorizing an action to complete the electronic purchase transaction or withholding the authorization.

19. The computer-readable medium of claim 18, wherein a third set of authentication criteria for a third type of the first plurality of different electronic purchase transaction types includes at least three criteria selected from the group consisting of: receiving from the user entry of a PIN, receiving fingerprint data of the first identified human user from a mobile personal electronic device, receiving authorization from the first identified human user who entered an indication of the authorization on their mobile personal electronic device, detection of a proximity of a plurality of the first identified human user's personal electronic devices, detection of a location of one or more of the first identified human user's personal electronic devices, reception of a trust ticket from the first identified human user, and reception of an e-mail approval from the first identified human user.

20. The computer-readable medium of claim 18, wherein the customizing of the user account further includes storing a plurality of parameters received from a provider of services other than the first identified human user, and wherein the retrieving of the plurality of previously stored authentication parameters relevant to the first identified human user and to the electronic purchase transaction includes retrieving at least one of the plurality of parameters received from a provider of services other than the first identified human user.

21. The method of claim 4, wherein the plurality of previously stored authentication parameters relevant to the first identified human user and to the electronic purchase transaction includes data used to create a digital identifier of the first identified human user to protect the first identified human user's identity.

22. The method of claim 4, wherein the request to perform the electronic purchase transaction includes a request to certify an e-mail address as being owned by the first identified human user.

23. (canceled)

24. The method of claim 4, wherein the request to perform the electronic purchase transaction includes a request to certify an identity of a sender of email.

25. The method of claim 4, wherein the request to perform an electronic purchase transaction includes a request to certify a telephone number as being owned by the first identified human user.

26.-31. (canceled)

32. The method of claim 4, wherein a third set of authentication criteria for a third type of the first plurality of different electronic purchase transaction types includes a location signature that is determined by a path traveled by the human user.
